(19) United States
(12) Patent Application Publication
(10) Pub. No.: US 2005/0202356 A1
(43) Pub. Date: Sep. 15, 2005

(54) Black-and-white photothermographic material

(75) Inventor: Kouta Fukui, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/072,531

(22) Filed: Mar. 7, 2005

(30) Foreign Application Priority Data
Mar. 10, 2004 (JP) 2004-67693

(51) Int. Cl. G03C 1/00

(52) U.S. Cl. 430/619

(57) ABSTRACT

The invention provids a black-and-white photothermographic material comprising a support and an image-forming layer containing a photosensitive silver halide, a non-photosensitive organic silver salt, a reducing agent for silver ions, and a binder on one side of the support, wherein a hydrophilic binder constitutes 50 mass % or more of the binder. The non-photosensitive organic silver salt contains at least one kind selected from the group consisting of a silver salt of a nitrogen-containing heterocyclic compound and a silver salt of a mercapto compound. The photothermographic material comprises a fluorine compound having a fluorinated alkyl group with at least 2 carbon atoms and at most 12 fluorine atoms.

### CROSS-REFERENCE TO RELATED APPLICATION

This application claims priority under 35USC 119 from Japanese Patent Application No. 2004-67693, the disclosure of which is incorporated by reference herein.

### BACKGROUND OF THE INVENTION

1. Field of the Invention

The present invention relates to a black-and-white photothermographic material, in particular a black-and-white photothermographic material which has a high development property, excellent image graininess, and low adhesion between sensitive materials.

2. Description of the Related Art

Recently, it has been strongly desired to reduce the amount of image developing liquids to be discarded after use in consideration of environmental protection and reduction of space occupied by the image developing liquids used in the medical field. For this reason, there is desired a technology for providing a photothermographic material for use in medical diagnosis and photographic applications, which is capable of efficient exposure with a laser image setter or a laser imager and also capable of forming a sharp black image with high resolution and a high degree of sharpness. Such photothermographic material can eliminate the use of solvent-based processing chemicals and provide users with a thermal development system which is simpler and does not contaminate the environment.

Although similar requirements also exist in the field of general image forming materials, an image for medical imaging requires a particularly high image quality excellent in sharpness and granularity because a delicate image representation is necessitated. Further, an image of blue-black tone is preferred in the field of medical imaging in consideration of easy diagnosis. Currently various hard copy systems utilizing pigments or dyes, such as ink jet printers and electrophotographic systems, are available as general image forming systems, but they are not satisfactory as output systems for medical images.

A thermal image forming system utilizing a non-photosensitive organic silver salt is already known. This system comprises an image-forming layer which is obtained by dispersing a reducible silver salt, (e.g., a non-photosensitive organic silver salt), photosensitive silver halide, and if necessary, a color toner controlling the color tone of silver in the matrix of a binder.

The photothermographic material is heated to a higher temperature (for example 80° C. or higher) after image-wise exposure, whereby a black silver image is formed through a redox reaction between the silver halide or the reducible silver salt (acting as an oxidizing agent) and the reducing agent. The redox reaction is accelerated by the catalytic effect of a silver halide latent image, which is formed by the exposure to light. Thereby, a black silver image is formed on an exposed area. Photothermographic materials are disclosed in much literature, and the Fuji Medical Dry Laser Imager FM-DPL is commercially available as a medical image forming system.

The present inventors have searched for a means of obtaining high development properties for sensitive materials. Enhancing the development properties of a sensitive material is directly connected with a shortening of the treatment time required for the sensitive materials. Recently, a sensitive material having a high development property which is highly suitable for allowing a shortened treatment time and compactness of an exposure/developing system has been provided. In the research and development process, a novel non-photosensitive organic silver salt has recently been found. A silver salt of a nitrogen-containing heterocyclic compound or a silver salt of a mercapto compound can be effectively dispersed by means of a gelatin used as a hydrophilic binder, and thus dispersion is easier as compared with when dispersing a conventional silver salt of an aliphatic acid. Furthermore, it was found that in the case of using this non-photosensitive organic silver salt, to balance other properties with the development properties, a hydrophilic binder such as gelatin, which is the same as a dispersing agent, is most suitably used as a binder.

However, it was found that there is a problem in image graininess and adhesiveness between the sensitive materials, when a silver salt of a nitrogen-containing heterocyclic compound or a silver salt of a mercapto compound was used as a non-photosensitive organic silver salt. It is believed that this is caused by combining the non-photosensitive organic silver salt with the hydrophilic binder. In order to improve image graininess, it has been suggested that, for example, the conditions of drying air when applying a coating solution containing a matting agent be adjusted (refer to JP-A-2001-194749, for example). As for adhesiveness between sensitive materials, it is disclosed that adding a polymer latex to a binder is effective (refer to JP-A-2003-337392, for example).

Since various components are contained within the photothermographic material and all of the components remain even after development, it is necessary to obtain a proper balance between components and to utilize the advantages of each of the compositions. In order to improve image graininess and adhesiveness between sensitive materials with a conventional method, an optimal balance between all sensitive materials being used should be considered.

When a silver salt of a nitrogen-containing heterocyclic compound or a silver salt of a mercapto compound is used with a hydrophilic binder in the above mentioned conventional method, slight improvement is obtained, however, for practical applications, further improvement is still needed.

### SUMMARY OF THE INVENTION

The present invention provides a black-and-white photothermographic material which has a high development property, excellent image graininess and low adhesion between sensitive materials.

Specifically, the present invention provides a black-and-white photothermographic material comprising a support and an image-forming layer containing a photosensitive silver halide, a non-photosensitive organic silver salt, a reducing agent for silver ions, and a binder on one side of the support, wherein a hydrophilic binder constitutes 50 mass % or more of the binder, the non-photosensitive organic silver salt contains at least one kind selected from the group consisting of a silver salt of a nitrogen-containing heterocyclic compound and a silver salt of a mercapto compound; and the photothermographic material further comprises a fluorine compound having a fluorinated alkyl group with at least 2 carbon atoms and at most 12 fluorine atoms.

It has been determined that when a silver salt of a nitrogen-containing heterocyclic compound or a silver salt of a mercapto compound is used as a non-photosensitive organic silver salt with a hydrophilic binder, there is a problem in the image graininess and adhesiveness between sensitive materials. It is believed that by using the above-mentioned salts, all the sensitive materials become more hydrophilic. On the other hand, it has been difficult to modify the sensitive materials by changing their hydrophilic composition into the hydrophobic composition since the hydrophilicity provides more favorable development property.

By means of further research and development, it was found that in order to improve image graininess and suppress the adhesiveness between sensitive materials without decreasing development property, it is very effective to use a fluorine compound having a fluorinated alkyl group with at least 2 carbon atoms and at most 12 fluorinated alkyl groups. The fluorine compound functions as a surface active agent, and modifies the surface of the sensitive materials, but does not have any effect on the image-forming layer. In the sensitive materials obtained by combining a silver salt of a nitrogen-containing heterocyclic compound or a silver salt of a mercapto compound and a hydrophilic binder, the coating performance was deteriorated while the membrane surface exhibited a poor smoothness. However, it is supposed that when using the fluorine compound, the sensitive materials having excellent surface properties can be obtained and the light scattering can be suppressed upon exposure, thereby excellent image graininess can be obtained. In addition, by modifying the surface, the adhesion between sensitive materials can be also suppressed.

Specifically, as a result of such extensive studies, as compared to conventional photothermographic materials, a photothermographic material which has extremely high development property, excellent image graininess and low adhesion between sensitive materials could be obtained.

### DETAILED DESCRIPTION OF THE INVENTION

The photothermographic material of the present invention, which forms a black-and-white image by a silver image, comprises an image-forming layer containing a photosensitive silver halide, a non-photosensitive organic silver salt, a reducing agent for silver ions, and a binder. The present invention is characterized in that the non-photosensitive organic silver salt comprises at least one kind of the silver salts selected from a group consisting of a silver salt of a nitrogen-containing heterocyclic compound and a silver salt of a mercapto compound, that a hydrophilic binder constitutes 50 mass % or more of the binder of the image-forming layer, and that the sensitive materials comprise a fluorine compound having a fluorinated alkyl group containing at least 2 carbon atoms and at most 12 fluorine atoms.

In the following, the present invention will be explained in detail.

The photothermographic material of the present invention comprises an image-forming layer containing photosensitive silver halide, a non-photosensitive organic silver salt, a reducing agent and a binder on at least one side of a support. In addition, preferably it may comprise a surface protecting layer on the image-forming layer, or a back layer or a back face protective layer on the opposite side.

The photothermographic material of the present invention may be a one-sided type having an image-forming layer only on one side of the support, or a double-sided type having image-forming layers on both sides of the support.

In addition, the photothermographic material of the present invention can be used for either laser exposure or X-ray exposure. In the case of the sensitive materials being used for X-ray exposure as with medical diagnosis, an X-ray intensifying screen is used. The sensitive materials for X-ray exposure can be classified into (1) one-sided photothermographic material and (2) double-sided photothermographic material, each of which will be described below.

(1) One-Sided Photothermographic Material

The one-sided photothermographic material can be used as an X-ray sensitive material for mammography. It is important that the one-sided photothermographic material used for the purpose of the present invention, can have the contrast of an obtained image adjusted to fall within the appropriate ranges. As for preferred requirements for the constitution of the material as the X-ray sensitive material for mammography, reference can be made to the descriptions in JP-A-5-45807, JP-A-10-62881, JP-A-10-54900 and JP-A-11-109564.

In the case of the one-sided type, it is preferable to include a back layer on the side (hereinafter, referred to as the back side) opposite to the side having an image-forming layer on the support.

(2) Double-Sided Photothermographic Material

The double-sided photothermographic material can be preferably used in an image forming method involving recording of an X-ray image using an X-ray intensifying screen.

The constitution of each of the layers thereof and preferred components of the layers will be explained in detail.

Surfactant

The photothermal photosensitive material of the invention uses a fluorine-containing compound that has a fluoroalkyl group having at least 2 carbon atoms and at most 12 fluorine atoms (the fluorine-substituted alkyl group is hereinafter referred to as “Rf”) as a surfactant. The fluorine-containing compounds shall have at least one Rf, but may have two or more Rf's.

Specific examples of Rf are mentioned below, to which, however, the invention should not be limited. —C₂F₅, —C₃F₇, —C₄F₉, —C₅F₁₁, —CH₂—C₄F₉, —C₄F₈—H, —CH₄—C₄F₉, —C₄H₈—C₄F₉, —C₆H₁₂—C₄F₉, —C₈H₁₆—C₄F₉, —C₄H₈—C₂F₅, —C₄H₈—C₃F₇, —C₄H₈—C₅F₁₁, —C₈H₁₆—C₂F₅, —C₂H—C₄F₈—H, —C₄H₈—C₄F₈—H, —C₆H₁₂—C₄F₈—H, —C₆H₁₂—C₂F₄—H, —C₈H₁₆—C₂F₄—H, —C₆H₁₂—C₄F₈—CH₃, —C₂H₄—C₃F₇, —C₂H₄—C₅F₁₁, —C₄H₈—CH(CF₃)₂, —CH₂CF₃, —C₄H₈—CH(C₂F₅)₂, —C₄H₈—CH(CF₃)₂, —C₄H₈—C(CF₃)₃, —CH₂—C₄F₈—H, —CH₂—C₆F₁₂—H, —CH₂—C₆F₁₃, —C₂H₄—C₆F₁₃, —C₄H₈—C₆F₁₃, —C₆H₁₂—C₆F₁₃, —C₈H₁₆—C₆F₁₃.

Rf has at most 12 fluorine atoms, but preferably has from 3 to 11 fluorine atoms, and more preferably has from 5 to 9 fluorine atoms. It has at least 2 carbon atoms, but preferably from 4 to 16, more preferably from 5 to 12 carbon atoms.

Rf is not specifically defined in point of its structure so far as it has at least 2 carbon atoms and at most 12 fluorine atoms, but is preferably represented by the following Formula (A):
-Rc-Re—W Formula (A)

More preferably, the fluorine-containing compound has at least two fluoroalkyl groups of Formula (A).

In Formula (A), Rc represents an alkylene group having from 1 to 4 carbon atoms, but preferably from 1 to 3, more preferably 1 or 2 carbon atoms. The alkylene group for Rc may be linear or branched.

Re represents a perfluoroalkylene group having from 2 to 6 carbon atoms, preferably from 2 to 4 carbon atoms. The perfluoroalkylene group is meant to indicate an alkylene group where all hydrogen atoms are substituted with fluorine atoms. The perfluoroalkylene group may be linear or branched, or may have a cyclic structure.

W represents a hydrogen atom, a fluorine atom, or an alkyl group, but is preferably a hydrogen atom or a fluorine atom. More preferably, it is a fluorine atom.

The fluorine-containing compound may have a cationic hydrophilic group.

The cationic hydrophilic group is meant to indicate a group capable of being a cation when dissolved in water. Concretely, it includes quaternary ammoniums, alkylpyridiniums, alkylimidazoliniums, and primary to tertiary aliphatic amines.

Preferably, the cation is an organic cationic substituent, more preferably a nitrogen or phosphorus atom-containing organic cationic group. Even more preferably, it is a pyridinium cation or an ammonium cation.

The anion to form salts may be an inorganic anion or an organic anion. Preferred examples of the inorganic anion are an iodide ion, a bromide ion, and a chloride ion. Preferred examples of the organic anion are a p-toluenesulfonate ion, a benzenesulfonate ion, a methanesulfonate ion, and a trifluoromethanesulfonate ion.

Cationic fluorine-containing compounds that are represented the following Formula (1) are preferably used in the invention.

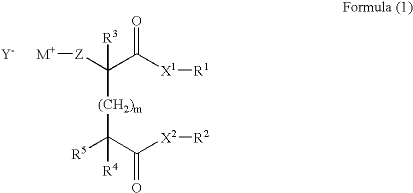

In Formula (1), R¹ and R² each independently represent a substituted or unsubstituted alkyl group, but at least one of R¹ and R² is the above-mentioned fluoroalkyl group (Rf). Preferably, both of R¹ and R² are Rf. R³, R⁴ and R⁵ each independently represent a hydrogen atom or a substituent; X¹, X² and Z each independently represent a divalent linking group or a single bond; and M⁺ represents a cationic substituent. Y represents a counter anion, but it may be absent when the charge of the molecule is 0. m is 0 or 1.

In Formula (1), when R¹ and R² each independently represent a substituted or unsubstituted alkyl group except Rf, then the alkyl group has at least one carbon atom and may be linear, branched or cyclic. The substituent includes, for example, a halogen atom, an alkenyl group, an aryl group, an alkoxy group, a halogen atom except fluorine, a carboxylate group, a carbonamido group, a carbamoyl group, an oxycarbonyl group, and a phosphate group.

When R¹ or R² is an alkyl group except Rf, or that is, an alkyl group not substituted with a fluorine atom, then the alkyl group may be a substituted or unsubstituted alkyl group having from 1 to 24 carbon atoms, preferably having from 6 to 24 carbon atoms. Preferred examples of the unsubstituted alkyl group having from 6 to 24 carbon atoms are n-hexyl, n-heptyl, n-octyl, tert-octyl, 2-ethylhexyl, n-nonyl, 1,1,3-trimethylhexyl, n-decyl, n-dodecyl, cetyl, hexadecyl, 2-hexyldecyl, octadecyl, eicosyl, 2-octyldodecyl, docosyl, tetracosyl, 2-decyltetradecyl, tricosyl and cyclohexyl, cycloheptyl groups. Preferred examples of the substituted alkyl group having from 6 to 24 carbon atoms in total are 2-hexenyl, oleyl, linoleyl, linolenyl, benzyl, β-phenethyl, 2-methoxyethyl, 4-phenylbutyl, 4-acetoxyethyl, 6-phenoxyhexyl, 12-phenyldodecyl, 18-phenyloctadecyl, 12-(p-chlorophenyl)dodecyl and 2-(diphenyl phosphate)ethyl group.

The alkyl group except Rf that is independently represented by R¹ and R² is more preferably a substituted or unsubstituted alkyl group having from 6 to 18 carbon atoms. Preferred examples of the unsubstituted alkyl group having from 6 to 18 carbon atoms are n-hexyl, cyclohexyl, n-heptyl, n-octyl, 2-ethylhexyl, n-nonyl, 1,1,3-trimethylhexyl, n-decyl, n-dodecyl, cetyl, hexadecyl, 2-hexyldecyl, octadecyl and 4-tert-butylcyclohexyl groups. Preferred examples of the substituted alkyl group having from 6 to 18 carbon atoms in total are phenethyl, 6-phenoxyhexyl, 12-phenyldodecyl, oleyl, linoleyl and linolenyl groups.

Especially preferably, the alkyl group except Rf that is independently represented by R¹ and R² is any of n-hexyl, cyclohexyl, n-heptyl, n-octyl, 2-ethylhexyl, n-nonyl, 1,1,3-trimethylhexyl, n-decyl, n-dodecyl, cetyl, hexadecyl, 2-hexyldecyl, octadecyl, oleyl, linoleyl and linolenyl groups. Most preferably, it is a linear, cyclic or branched unsubstituted alkyl group having from 8 to 16 carbon atoms.

In Formula (1), R³, R⁴ and R⁵ each independently represent a hydrogen atom or a substituent. The substituent includes, for example, an alkyl group (preferably having from 1 to 20, more preferably from 1 to 12, even more preferably from 1 to 8 carbon atoms, e.g., methyl, ethyl, isopropyl, tert-butyl, n-octyl, n-decyl, n-hexadecyl, cyclopropyl, cyclopentyl, cyclohexyl), an alkenyl group (preferably having from 2 to 20, more preferably from 2 to 12, even more preferably from 2 to 8 carbon atoms, e.g., vinyl, allyl, 2-butenyl, 3-pentenyl), an alkynyl group (preferably having from 2 to 20, more preferably from 2 to 12, even more preferably from 2 to 8 carbon atoms, e.g., propargyl, 3-pentynyl), an aryl group (preferably having from 6 to 30, more preferably from 6 to 20, even more preferably from 6 to 12 carbon atoms, e.g., phenyl, p-methylphenyl, naphthyl), a substituted or unsubstituted amino group (preferably having from 0 to 20, more preferably from 0 to 10, even more preferably from 0 to 6 carbon atoms, e.g., unsubstituted amino, methylamino, dimethylamino, diethylamino, dibenzylamino),
an alkoxy group (preferably having from 1 to 20, more preferably from 1 to 12, even more preferably from 1 to 8 carbon atoms, e.g., methoxy, ethoxy, butoxy), an aryloxy group (preferably having from 6 to 20, more preferably from 6 to 16, even more preferably from 6 to 12 carbon atoms, e.g., phenyloxy, 2-naphthyloxy), an acyl group (preferably having from 1 to 20, more preferably from 1 to 16, even more preferably from 1 to 12 carbon atoms, e.g., acetyl, benzoyl, formyl, pivaloyl), an alkoxycarbonyl group (preferably having from 2 to 20, more preferably from 2 to 16, even more preferably from 2 to 12 carbon atoms, e.g., methoxycarbonyl, ethoxycarbonyl), an aryloxycarbonyl group (preferably having from 7 to 20, more preferably from 7 to 16, even more preferably from 7 to 10 carbon atoms, e.g., phenyloxycarbonyl), an acyloxy group (preferably having from 2 to 20, more preferably from 2 to 16, even more preferably from 2 to 10 carbon atoms, e.g., acetoxy, benzoyloxy),
an acylamino group (preferably having from 2 to 20, more preferably from 2 to 16, even more preferably from 2 to 10 carbon atoms, e.g., acetylamino, benzoylamino), an alkoxycarbonylamino group (preferably having from 2 to 20, more preferably from 2 to 16, even more preferably from 2 to 12 carbon atoms, e.g., methoxycarbonylamino), an aryloxycarbonylamino group (preferably having from 7 to 20, more preferably from 7 to 16, even more preferably from 7 to 12 carbon atoms, e.g., phenyloxycarbonylamino), a sulfonylamino group (preferably having from 1 to 20, more preferably from 1 to 16, even more preferably from 1 to 12 carbon atoms, e.g., methanesulfonylamino, benzenesulfonylamino), a sulfamoyl group (preferably having from 0 to 20, more preferably from 0 to 16, even more preferably from 0 to 12 carbon atoms, e.g., sulfamoyl, methylsulfamoyl, dimethylsulfamoyl, phenylsulfamoyl), a carbamoyl group (preferably having from 1 to 20, more preferably from 1 to 16, even more preferably from 1 to 12 carbon atoms, e.g., unsubstituted carbamoyl, methylcarbamoyl, diethylcarbamoyl, phenylcarbamoyl), an alkylthio group (preferably having from 1 to 20, more preferably from 1 to 16, even more preferably from 1 to 12 carbon atoms, e.g., methylthio, ethylthio), an arylthio group (preferably having from 6 to 20, more preferably from 6 to 16, even more preferably from 6 to 12 carbon atoms, e.g., phenylthio), a sulfonyl group (preferably having from 1 to 20, more preferably from 1 to 16, even more preferably from 1 to 12 carbon atoms, e.g., mesyl, tosyl), a sulfinyl group (preferably having from 1 to 20, more preferably from 1 to 16, even more preferably from 1 to 12 carbon atoms, e.g., methanesulfinyl, benzenesulfinyl), an ureido group (preferably having from 1 to 20, more preferably from 1 to 16, even more preferably from 1 to 12 carbon atoms, e.g., unsubstituted ureido, methylureido, phenylureido), a phosphoramido group (preferably having from 1 to 20, more preferably from 1 to 16, even more preferably from 1 to 12 carbon atoms, e.g., diethylphosphoramido, phenylphosphoramido), a hydroxyl group, a mercapto group, a halogen atom (e.g., fluorine, chlorine, bromine, iodine), a cyano group, a sulfo group, a carboxyl group, a nitro group, a hydroxamic acid group, a sulfino group, a hydrazino group, an imino group, a heterocyclic group (preferably having from 1 to 30, more preferably from 1 to 12, for example, a heterocyclic group having hetero atom(s) of nitrogen, oxygen and/or sulfur atoms, e.g., imidazolyl, pyridyl, quinolyl, furyl, piperidyl, morpholino, benzoxazolyl, benzimidazolyl, benzothiazolyl), a silyl group (preferably having from 3 to 40, more preferably from 3 to 30, even more preferably from 3 to 24 carbon atoms, e.g., trimethylsilyl, triphenylsilyl). These substituents may be further substituted. When the compound has two or more substituents, they may be the same or different. If possible, they may bond to each other to form a ring.

Preferably, each of R³, R⁴ and R⁵ is an alkyl group or a hydrogen atom, and more preferably all R³, R⁴ and R⁵ are hydrogen atoms.

In the Formula (1), X¹ and X² each independently represent a divalent linking group or a single bond. The divalent linking group is not specifically defined, but is preferably an arylene group, —O—, —S—, or —NR³¹— (where R³¹ represent a hydrogen atom or a substituent, and the substituent may be the same as that represented by R³, R⁴ and R⁵; R³¹ is preferably an alkyl group, Rf mentioned above, or a hydrogen atom, more preferably a hydrogen atom) alone or is a combination of any of them. More preferably, it is —O—, —S— or —NR³¹—. X¹ and X² are more preferably —O— or —NR³¹—, even more preferably —O— or —NH—, still more preferably —O—.

In the Formula (1), Z represents a divalent linking group or a single bond. The divalent linking group is not specifically defined, but is preferably an alkylene group, an arylene group, C(═O)—, —O—, —S—, —S(═O), —S(═O)₂— or —NR³²— (where R³² represent a hydrogen atom or a substituent, and the substituent may be the same as that represented by R³, R⁴ and R⁵; R³² is preferably an alkyl group or a hydrogen atom, more preferably a hydrogen atom) alone or is a combination of any of them. More preferably, it is an alkylene group having from 1 to 12 carbon atoms, an arylene group having from 6 to 12 carbon atoms, —C(═O)—, —O—, —S—, —S(═O)—, —S(═O)₂— or —NR³²— alone or is a combination of any of them. Even more preferably, Z is an alkylene group having from 1 to 8 carbon atoms, —C(═O)—, —O—, —S—, —S(═O)—, —S(═O)₂— or —NR³²— alone or is a combination of any of them. Examples of the combination include the following:

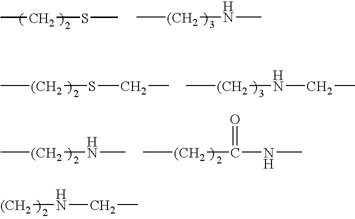

In the above-mentioned formula, M⁺ represents a cationic substituent, preferably an organic cationic substituent, more preferably an organic cationic substituent that contains a nitrogen or phosphorus atom. Even more preferably, it is a pyridinium cation or an ammonium cation. Still more preferably, it is a trialkylammonium cation of the following Formula (2):

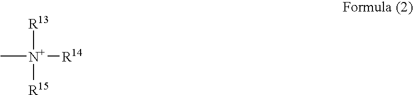

In the Formula (2), R¹³, R¹⁴ and R¹⁵ each independently represent a substituted or unsubstituted alkyl group. The substituent may be the same as those mentioned hereinabove for the substituent of R³, R⁴ and R₅. If possible, R¹³, R¹⁴ and R¹⁵ may bond to each other to form a ring. Preferably, R¹³, R¹⁴ and R¹⁵ each are an alkyl group having from 1 to 12 carbon atoms, more preferably having from 1 to 6 carbon atoms, even more preferably a methyl group, an ethyl group or a methylcarboxyl group, still more preferably a methyl group.

In the Formula (2), Y⁻ represents a counter anion, and it may be an inorganic anion or an organic anion. When the charge of the molecule is 0, Y⁻ may be absent. The inorganic anion is preferably an iodide ion, a bromide ion or a chloride ion. The organic anion is preferably a p-toluenesulfonate ion, a benzenesulfonate ion, a methanesulfonate ion, or a trifluoromethanesulfonate ion. Y⁻ is more preferably an iodide ion, a p-toluenesulfonate ion, or a benzenesulfonate ion, even more preferably a p-toluenesulfonate ion.

In the formula, m is 0 or 1, preferably 0.

Among the compounds represented by Formula (1), more preferred are those of the following Formula (1-a):

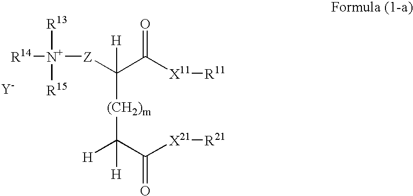

In the Formula (I), R¹¹ and R²¹ each independently represent a substituted or unsubstituted alkyl group, but at least one of R¹¹ and R²¹ is the above-mentioned Rf, and the total of the carbon atoms that constitute the group of R¹¹ and R²¹ is at most 19. R¹³, R¹⁴ and R¹⁵ each independently represent a substituted or unsubstituted alkyl group, and may bond to each other to form a ring. X¹¹ and X²¹ each independently represent —O—, —S— or —NR³¹—; R³¹ represents a hydrogen atom or a substituent; and Z represents a divalent linking group or a single bond. Y⁻ represents a counter anion, but it may be absent when the charge of the molecule is 0.

m is 0 or 1. In the formula, Z and Y each independently have the same meanings as in formula (1), and their preferred ranges are also the same as in formula (1). R¹³, R¹⁴, R¹⁵ and m have the same meanings as in formula (1), and their preferred ranges are also the same as in Formula (1).

In the Formula (1-a), X¹¹ and X²¹ each independently represent —O—, —S— or —NR³¹— where R³¹ represents a hydrogen atom or a substituent. The substituent may be the same as that mentioned hereinabove for R³, R⁴ and R⁵. R³¹ is preferably an alkyl group, the above-mentioned Rf, or a hydrogen atom, more preferably a hydrogen atom. More preferably, X¹¹ and X²¹ each are —O— or —NH—, even more preferably —O—.

R¹¹ and R²¹ each independently have the same meanings as those of R¹ and R² in Formula (1), and their preferred ranges are also the same as those for R¹ and R². However, the total of the carbon atoms that constitute the group of R¹¹ and R²¹ is at most 19. m is 0 or 1.

Specific examples of the compounds of Formula (1) are mentioned below, to which, however, the invention should not be limited. Unless otherwise specifically indicated, the alkyl group and the perfluoroalkyl group in the structures of the following compounds are linear. The abbreviation 2EH mentioned below represents 2-ethylhexyl.

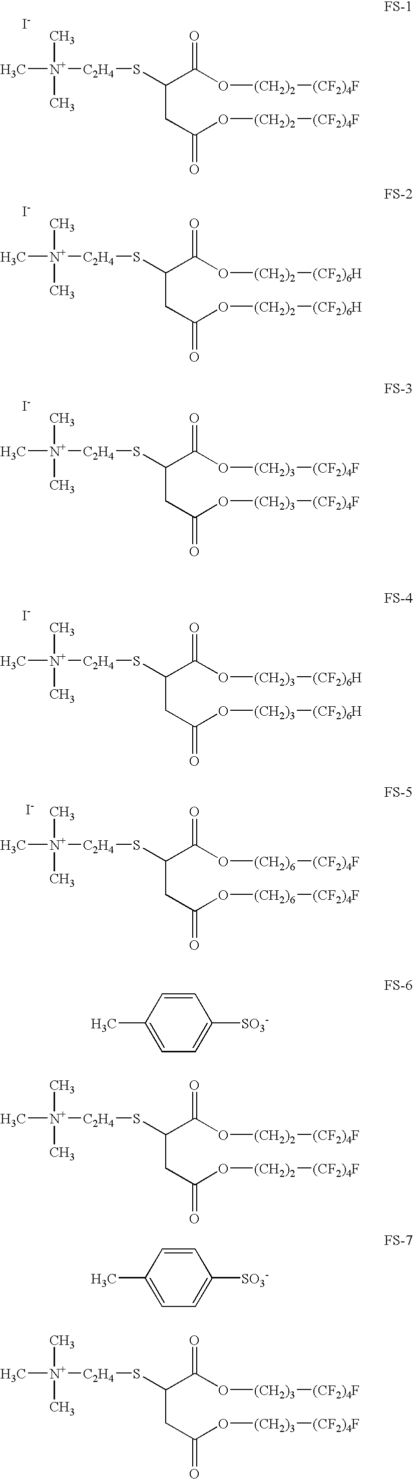

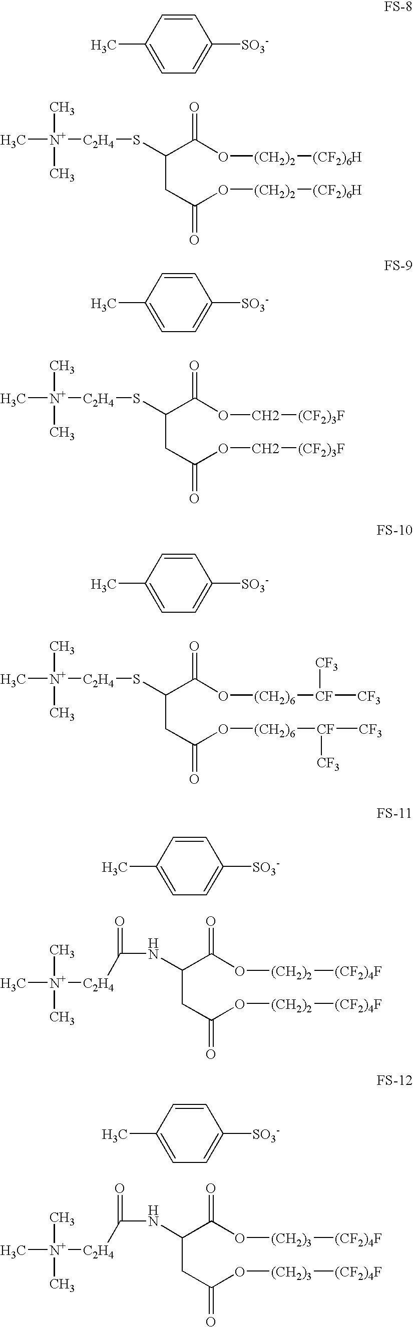

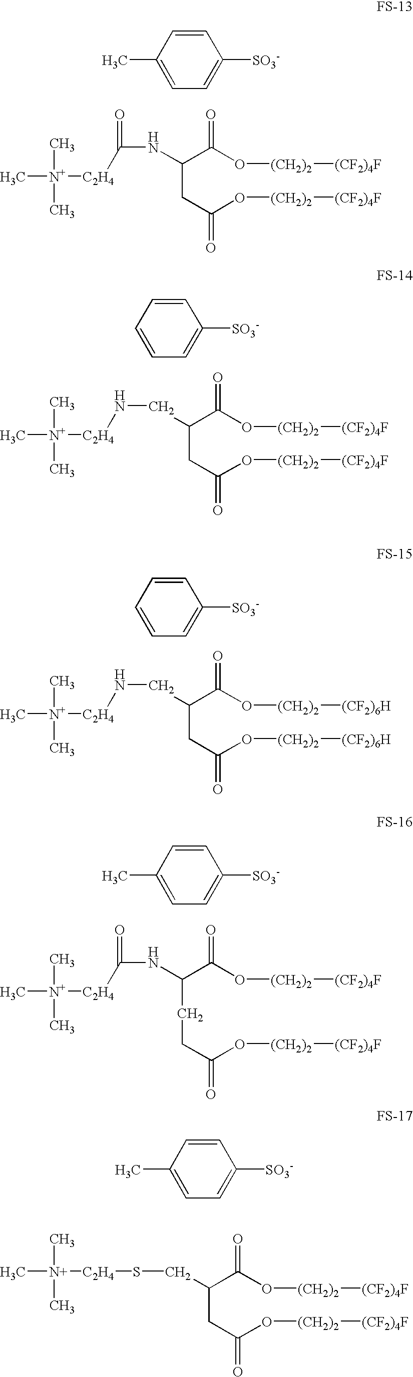

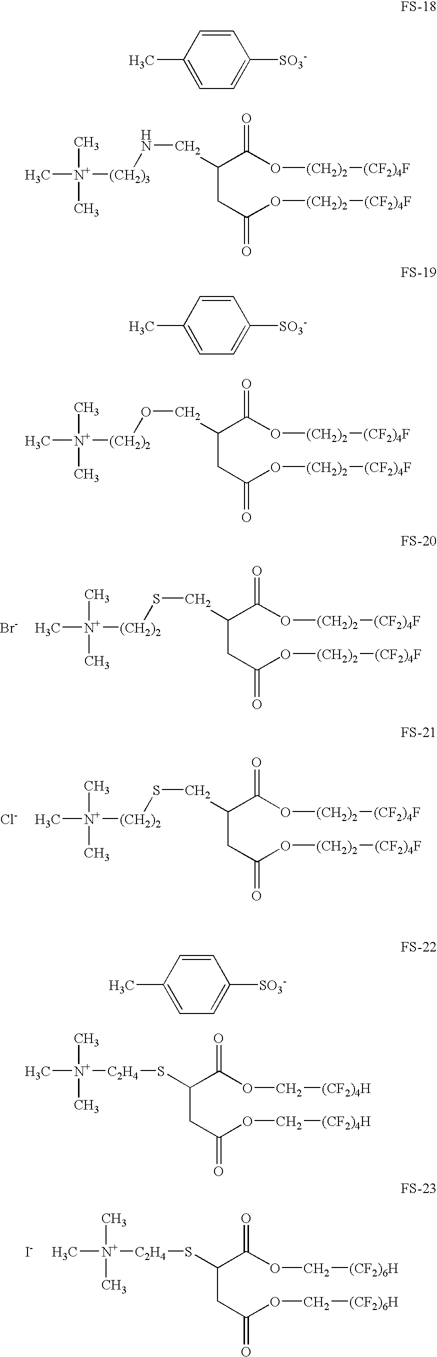

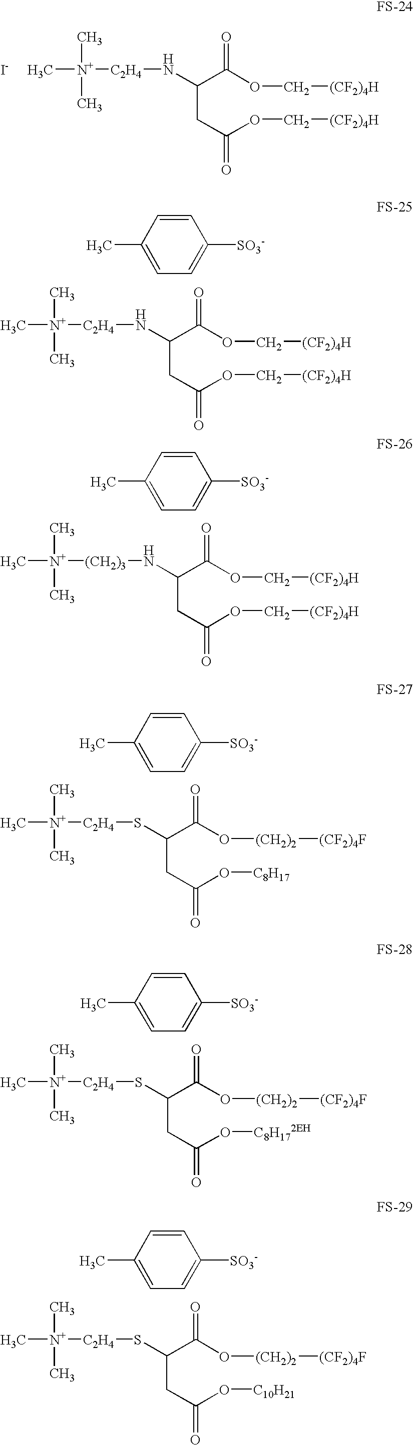

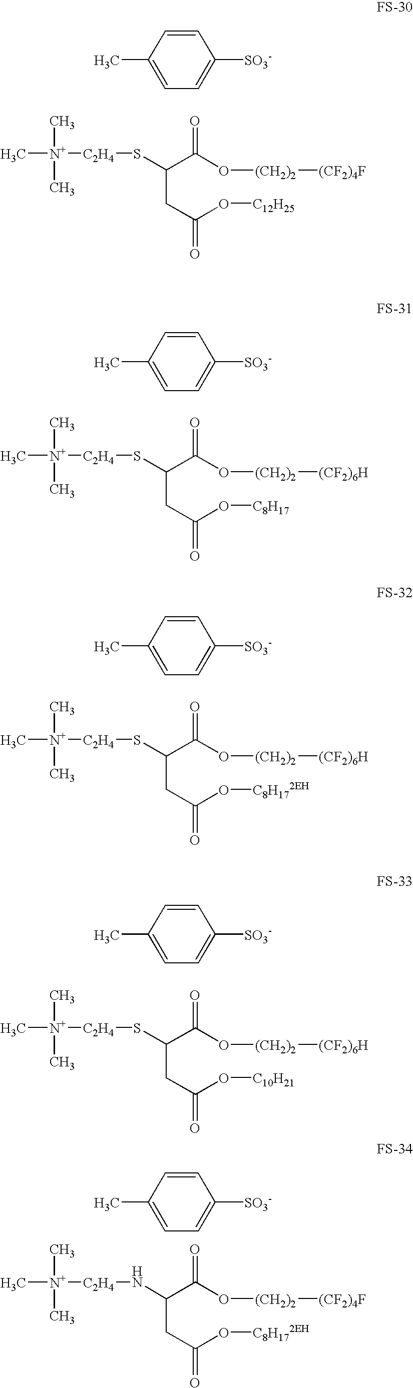

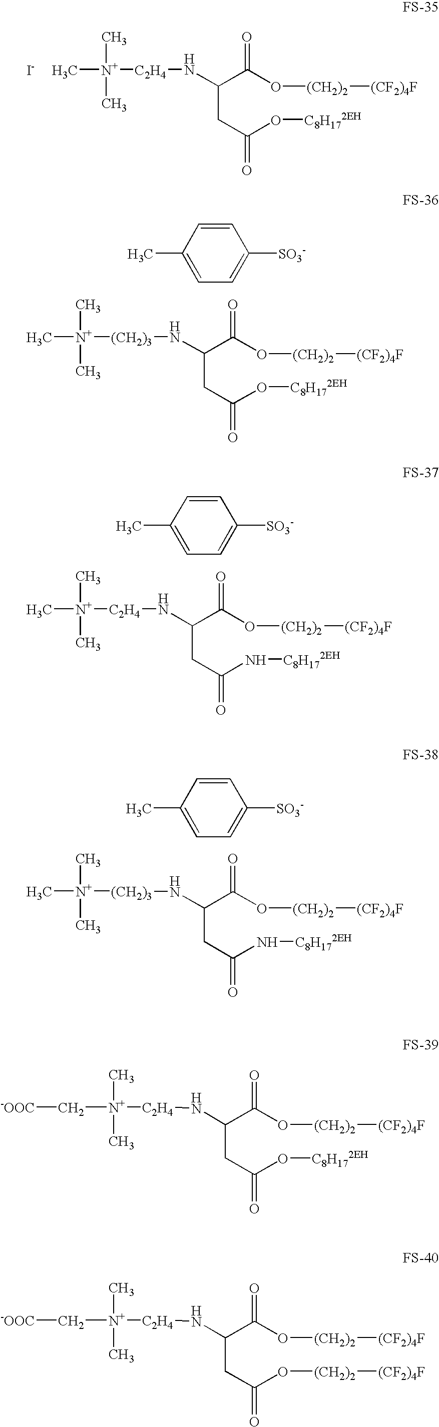

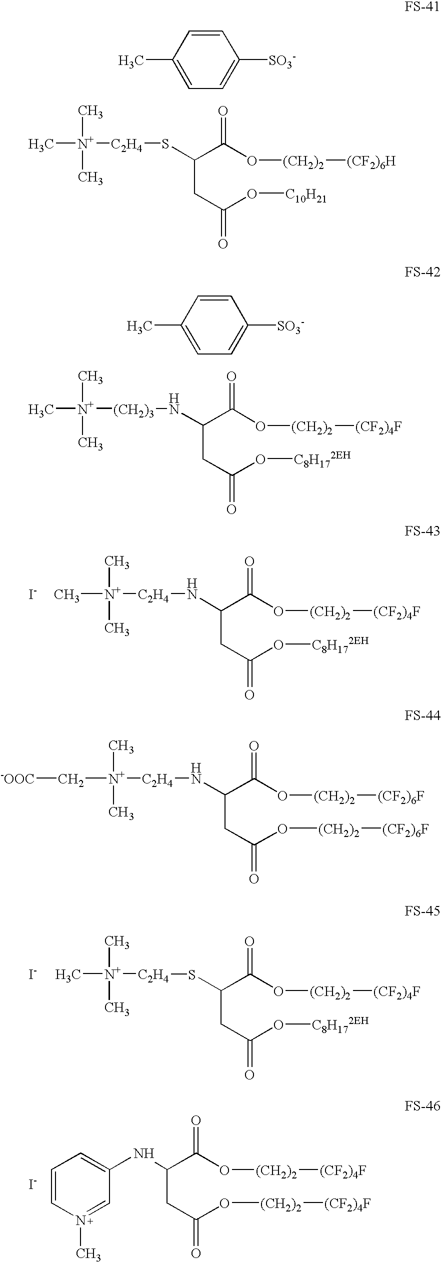

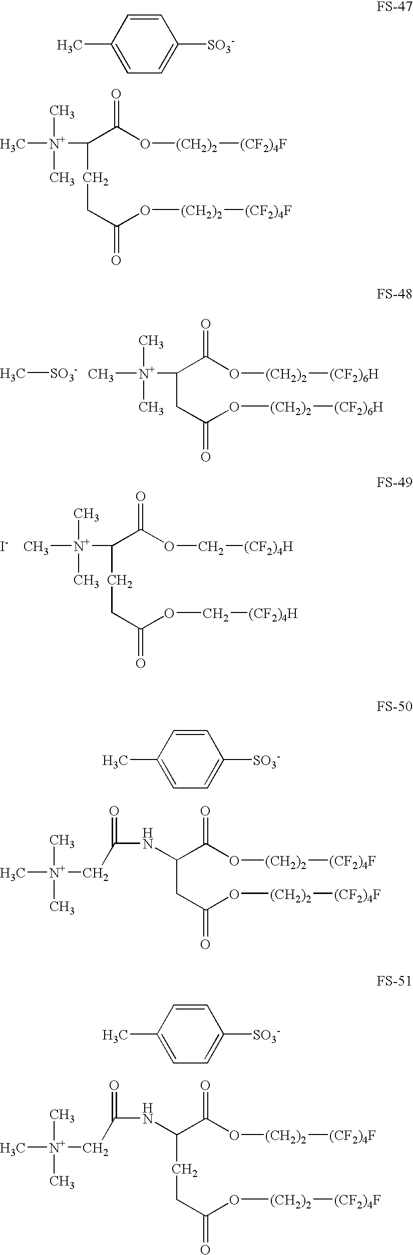

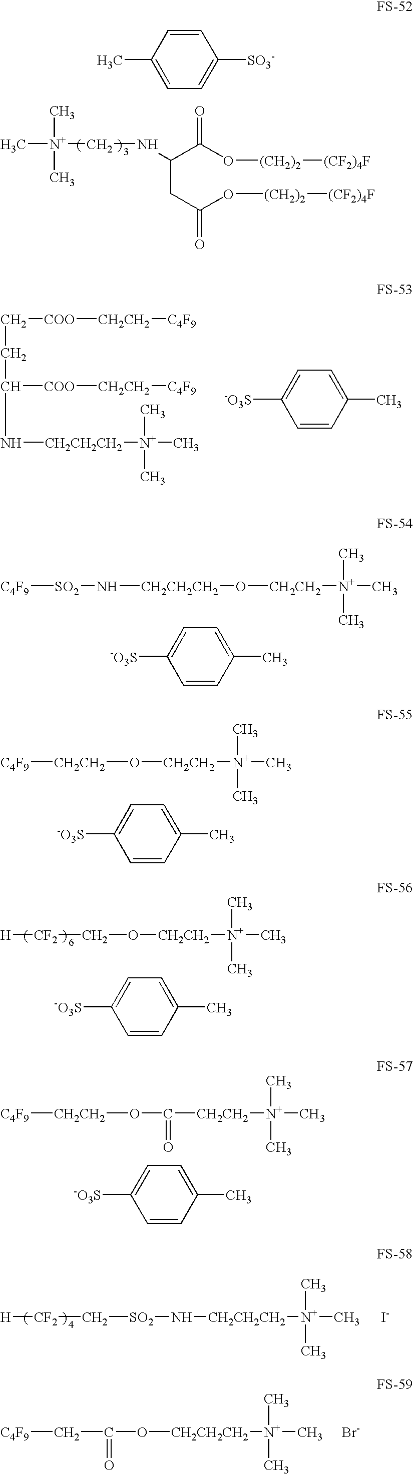

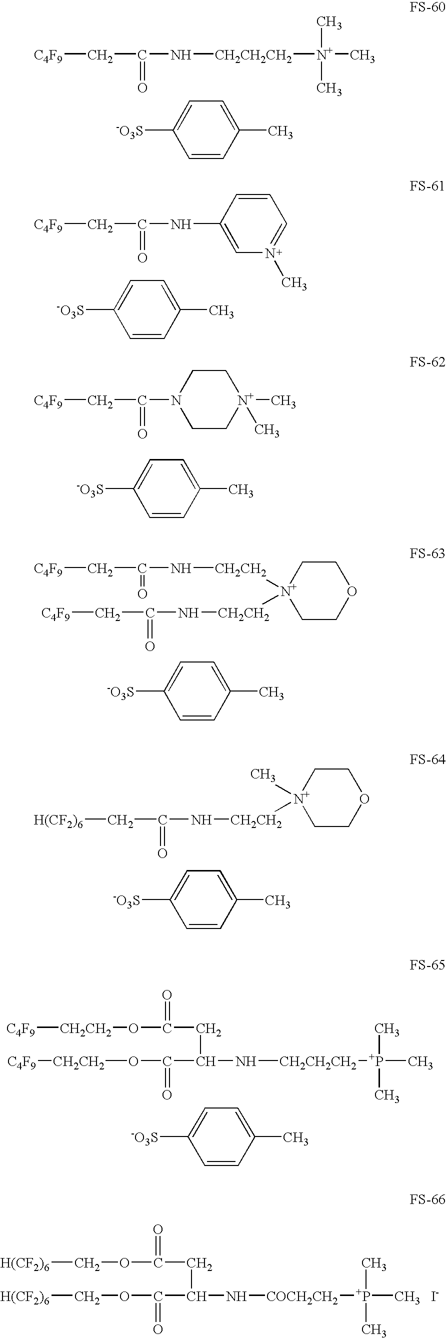

One example of production of the compounds of Formulae (1) and (1-a) for use in the invention is described below, to which, however, the invention should not be limited.

The compounds for use in the invention may be produced from starting material of fumaric acid derivatives, maleic acid derivatives, itaconic acid derivatives, glutamic acid derivatives or aspartic acid derivatives. For example, when fumaric acid derivatives, maleic acid derivatives or itaconic acid derivatives are used as the starting material for them, the double bond in the derivative is exposed to Michel addition reaction with a nucleophilic compound and then cationated with an alkylating agent to give the intended compounds.

The fluorine-containing compounds may have an anionic hydrophilic group.

The anionic hydrophilic group is an acid group having pKa of at most 7, as well as its alkali metal salt or ammonium salt. Concretely, it includes a sulfo group, a carboxyl group, a phosphonic acid group, a carbamoylsulfamoyl group, a sulfamoylsulfamoyl group, an acylsulfamoyl group and their salts. Of those, preferred are a sulfo group, a carboxyl group, a phosphonic acid group and their salts; and more preferred are a sulfo group and their salts. The cation to form the salts includes lithium, sodium, potassium, cesium, ammonium, tetramethylammonium, tetrabutylammonium, methylpyridinium, preferably lithium, sodium, potassium and ammonium.

Preferred examples of the fluorine-containing compound having an anionic hydrophilic group for use in the invention are represented by the following Formula (3):

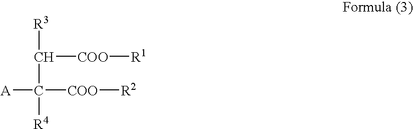

In Formula (3), R¹ and R² each independently represent an alkyl group, but at least one of them is Rf. When R¹ and R² are an alkyl group that is not a fluoroalkyl group, then the alkyl group preferably has from 2 to 18 carbon atoms, more preferably from 4 to 12 carbon atoms. R³ and R⁴ each independently represent a hydrogen atom, or a substituted or unsubstituted alkyl group.

Specific examples of the fluoroalkyl group for R¹ and R² may be the same as those mentioned hereinabove, and their preferred structures are also those of the above-mentioned Formula (A). More preferred examples of their structures are also the same as those mentioned hereinabove for the above-mentioned fluoroalkyl group. Preferably, the alkyl groups of R¹ and R² are both the above-mentioned fluoroalkyl groups.

The substituted or unsubstituted alkyl group for R³ and R⁴ may be linear or branched, or may have a cyclic structure. The substituent is not specifically defined, but is preferably an alkenyl group, an aryl group, an alkoxy group, a halogen atom (preferably Cl), a carboxylate group, a carbonamido group, a carbamoyl group, an oxycarbonyl group or a phosphate group.

A represents -L_{b}-SO₃M, and M represents a cation. Preferred examples of the cation for M are an alkali metal ion (e.g., lithium, sodium, potassium), an alkaline earth metal ion (e.g., barium, calcium), and an ammonium ion. Of those, more preferred are lithium, sodium, potassium and ammonium ions; and even more preferred are lithium, sodium and potassium ions. The ion may be suitably selected, depending on the total number of the carbon atoms constituting the compound of Formula (3), the substituents of the compound, and the degree of branching of the alkyl group in the compound. When the total of the carbon atoms of R¹, R², R³ and R⁴ is 16 or more and when M is a lithium ion, then the compounds are good in point of the balance of the solubility (especially in water), the antistatic property and the uniform coatability thereof.

L_{b} represents a single bond, or a substituted or unsubstituted alkylene group. The substituent is preferably that mentioned hereinabove for R³. When L_{b} is an alkylene group, the number of its carbon atoms is preferably at most 2. Preferably, L_{b} is a single bond or —CH₂—, most preferably —CH₂—.

In Formula (3), it is more desirable that the preferred embodiments mentioned above are combined.

Specific examples of the anionic hydrophilic group-having fluorine-containing compounds for use in the invention are mentioned below, to which, however, the invention should not be limited.

Unless otherwise specifically indicated, the alkyl group and the perfluoroalkyl group in the following structures are linear.

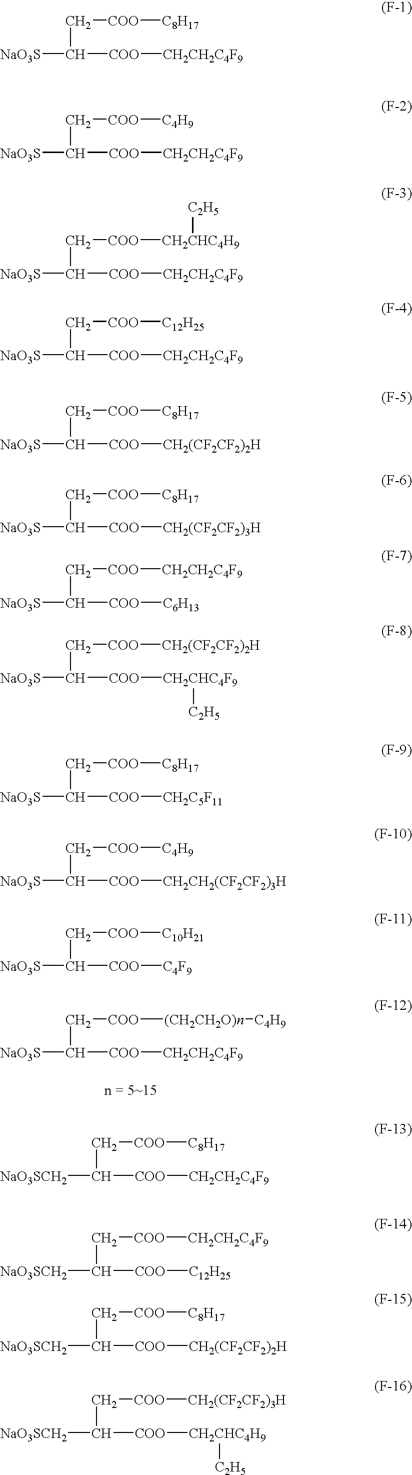

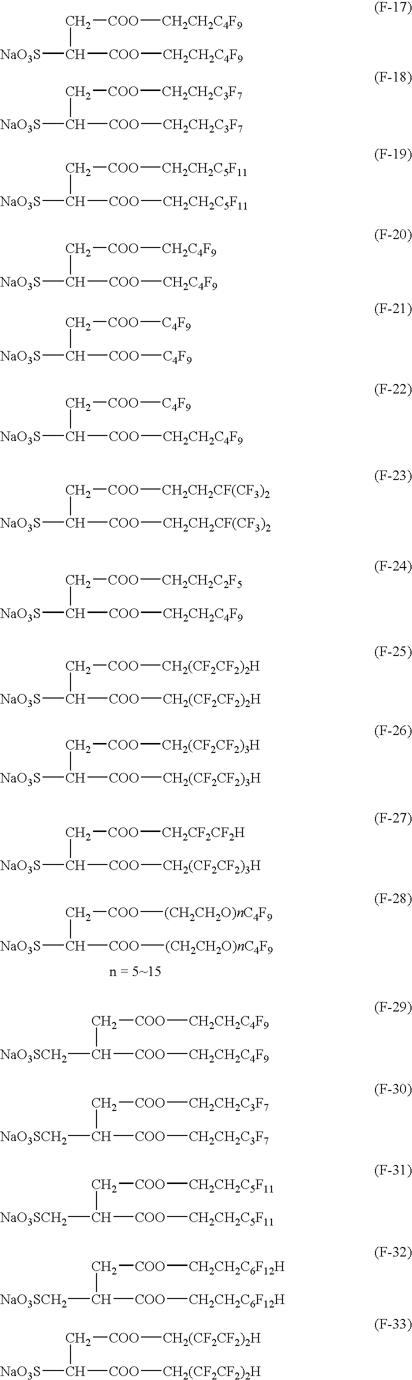

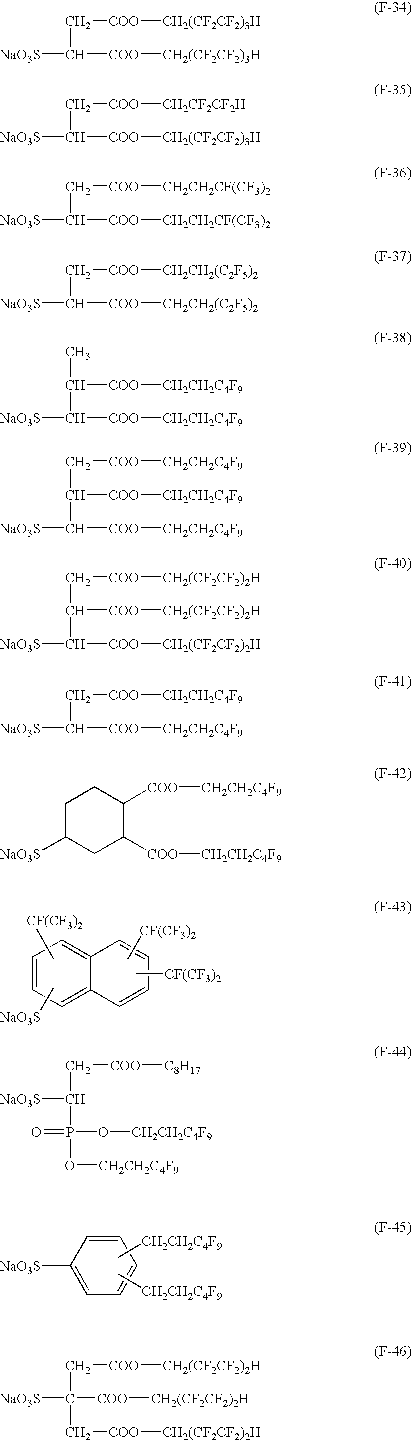

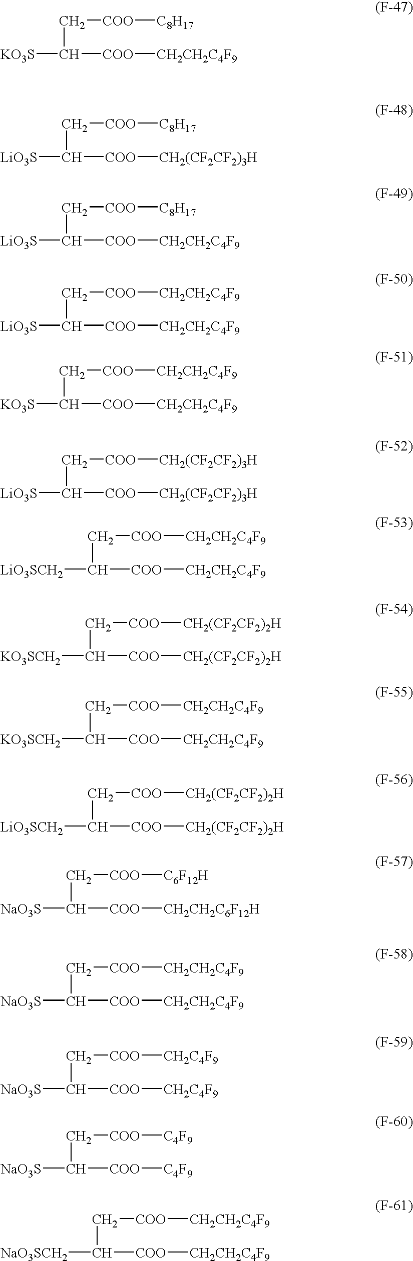

The fluorine-containing compounds may have a nonionic hydrophilic group.

The nonionic hydrophilic group is a group that dissolves in water not dissociating into an ion. Concretely, it includes poly(oxyethylene)alkyl ethers and polyalcohols, to which, however, the invention should not be limited.

Preferred examples of the non-ionic fluorine-containing compounds for use in the invention are represented by the following Formula (4):
Rf-X—((CH₂)ₙ—O)ₘ—R Formula (4)

In Formula (4), Rf is the above-mentioned fluoroalkyl group. Specific examples of Rf are mentioned above, and their preferred structures are also those of the above-mentioned Formula (A). More preferred examples of their structures are also the same as those mentioned hereinabove for Rf.

In Formula (4), X represents a divalent linking group. Not specifically defined, examples thereof are as follows:

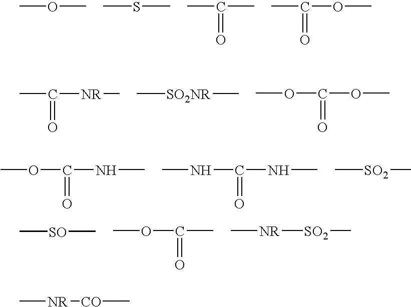

In Formula (4), n is 2 or 3, and m is an integer of 1 to 30. R represents a hydrogen atom, an alkyl group, an aryl group, a heterocyclic group, Rf, or a group having at least one Rf as its substituent.

Specific examples of the nonionic fluorine-containing compounds for use in the invention are mentioned below, to which, however, the invention should not be limited thereby.

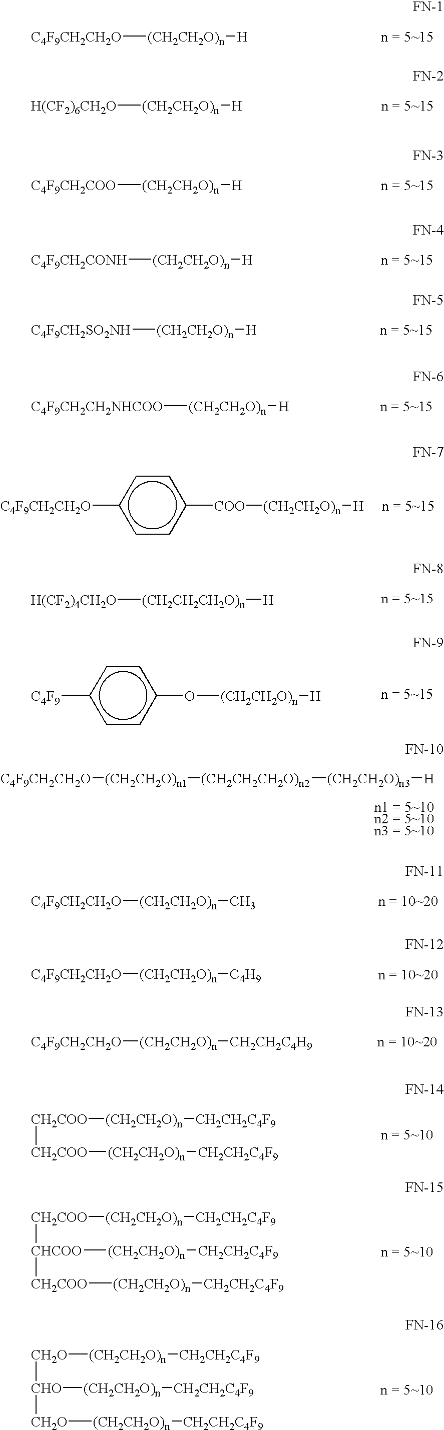

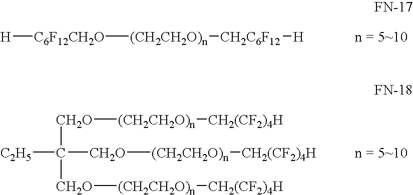

Serving as a surfactant, the specific fluoroalkyl group-having compound is preferably in the coating compositions to form the layers that constitute the photothermographic material of the invention (especially the protective layer, the undercoat layer, backing layer or the like of the material). In particular, the compound is used in forming the outermost layer of the photothermographic material for attaining more effective static charging prevention and more uniform coatability. In addition, it is found that the compounds having the specific structure as in the invention are more effective for improving the storage stability and the service environment dependency of the photothermographic material of the invention. To ensure the effect, it is desirable that the specific fluorine-containing compound of the invention is used in the outermost layer of the image-forming layer or the back layer. When the compound is used in an undercoat layer on a substrate, it realizes the same effect.

The amount of the specific fluorine compound used in the invention is not particularly limited, and can be arbitrally determined depending on the structure and location for use of the used fluorine compound, and the kinds and amounts of other materials contained in the composition. For example, in a case of using a coating liquid for an outermost layer of the photothermographic material, the coating amount of the fluorine compound in the coating liquid is preferably in a range of 0.1 mg/m² to 10 mg/m², and more preferably in a range of 0.5 mg/m² to 20 mg/m².

In the invention, one kind of the above mentioned specific fluorine compounds may be used alone or in a combination of two or more. In addition, other surfactant may be used in combination in addition to the above mentioned specific fluorine compounds. As the surfactant usable in combination, there can be mentioned a variety of surfactants which are anionic, cationic or nonionic. In addition, the surfactant to be used in combination may be a fluorine-containing surfactant other than the above mentioned fluorine compounds. As the surfactant to be used in combination, more preferred is an anionic or nonionic active agent. Examples of the surfactant usable in combination with the surfactant icnlude those described in JP-A-62-215272 (pp. 649-706), Research Disclosure (RD) Item 17643, pp. 26-27 (December, 1978), Research Disclosure (RD) Item 18716, pp. 650 (November, 1979), 307105, pp. 875-876 (November, 1989) and the like.

When other kinds of surfactants are used in combination with the above surfactant, the above mentioned fluorine compound may be comprised in an amount of 0.001 mass % to 20 mass %, and more preferably 0.005 mass % to 10 mass %, and further more preferably 0.01 mass % to 5 mass %, based on the total amount of all the surfactants to be added. The kinds of the surfactant to be used in combination are not particularly limited.

1. Image-Forming Layer

Explanation of a Non-Photosensitive Organic Silver Salt

The photothermographic material of the present invention comprises an organic compound containing reducible silver (I) ions. According to the present invention, the “organic compound containing reducible silver (I) ions” is referred to as a “non-photosensitive organic silver salt”. The non-photosensitive organic silver salt is a silver salt or a coordination compound which forms a silver image that is relatively stable with respect to light by heating in the presence of exposed silver halide and a reducing agent. It is preferable that the heating temperature in such case be at least 50° C., and a temperature range of from 75° C. or higher to 200° C. or lower for formation of a silver image is preferred.

In the present invention, the non-photosensitive organic silver salt includes at least one kind of a silver salt of a nitrogen-containing heterocyclic compound and a silver salt of a mercapto compound. A silver salt of a nitrogen-containing heterocyclic compound and a silver salt of a mercapto compound can be used in combination, and also at least two kinds of the silver salts of a mercapto compound can be used in combination and at least two kinds of the silver salts of a nitrogen-containing heterocyclic compound can be used in combination.

(1) Silver Salt of a Nitrogen-Containing Heterocyclic Compound

The nitrogen-containing heterocyclic compound includes azoles, oxazoles, thiazoles, thiazolines, imidazoles, diazoles, pyridines and triazines, but not limited thereto. Among them, azole is more preferable. Specific preferable examples of the azole include triazole, tetrazole and their derivatives. Further, benztriazole and its derivative are more preferable.

Further, examples of representative nitrogen-containing heterocyclic compounds are raised in the follwoings, but not limited thereto. For example, there can be mentioned 1,2,4-triazole or benztriazole and its derivative (e.g., methylbenzotriazole and 5-chlorobenzotriazole), a 1H-tetrazole compound such as phenyl mercapto tetrazole described in U.S. Pat. No. 4,220,709 (by de Mauriac), imidazole and an imidazole derivative described in U.S. Pat. No. 4,260,677 (Winslow et. al.).

The nitrogen-containing heterocyclic compound may have a substituent or not. In the case of having a substituent, the substituent is not particularly limited, but it is preferably a mercapto group and a thione group.

Representative compounds among the silver salt of the nitrogen-containing heterocyclic compounds having a mercapto group and a thione group, are as follows, but not limited thereto:
a silver salt of 3-mercapto-4-phenyl-1,2,4-triazole;
a silver salt of 2-mercapto-benzimidazole;
a silver salt of 2-mercapto-5-aminothiazole;
a silver salt of 2-(2-ethylglycolamide)benzothiazole;
a silver salt of 5-carboxy-1-methyl-2-phenyl-4-thiopyridine, a silver salt of mercapto triazine;
a silver salt of 2-mercapto benzoxazole;
a silver salt of the compounds described in U.S. Pat. No. 4,123,274 (by Knight et al.) (e.g., a silver salt of a 1,2,4-mercaptothiazole derivative, a silver salt of 3-amino-5-benzylthio-1,2,4-thiazole); and
a silver salt of a thione compound [e.g., a silver salt of 3-(2-carboxyethyl)-4-methyl-4-thiazoline-2-thione described in U.S. Pat. No. 3,785,830 (Sullivan et. al.)].

In the method of preparing a silver salt of a nitrogen-containing heterocyclic compound, the salt can be prepared according to the description in JP-A 1-100177, for example. In a specific preparation method, it can be prepared by Example 1 of JP-A 1-100177.

(2) Silver Salt of a Mercapto Compound

The mercapto compound is preferably an aliphatic mercapto compound or a heterocyclic mercapto compound.

(i) Silver Salt of Aliphatic Mercapto Compound

In the case of an aliphatic mercapto compound, it preferably contains 10 to 30 carbon atoms, and more preferably contains 10 to 25 carbon atoms. An aliphatic moiety of the compound may be linear or branched. Further, it may be either saturated or unsaturated. Furthermore, it may have a substituent or not. In the case of having a substituent, the substituents are not particularly limited, but it is preferably an alkyl group.

As the aliphatic mercapto compound, it is preferable when an aliphatic moiety of the compound is an alkyl group, more preferably an alkyl group having 10 to 23 carbon atoms. It may be substituted or unsubstituted, and be either linear or branched.

Representative silver salts of the aliphatic mercapto compound are as follows, but not limited thereto.

For example, it is alkylthiol containing 10 to 25 carbon atoms and the like, and preferably alkylthiol containing 10 to 23 carbon atoms.

Preparation of a silver salt of the aliphatic mercapto compound can be executed by a common method. For example, the aliphatic mercapto compound is heated and melted in water at a temperature of its melting point or higher (generally, 10 to 90° C.), then sodium hydroxide is used to prepare a sodium salt of aliphatic mercapto compound, and the sodium salt is reacted with silver nitrate to obtain crystals of the silver salt of aliphatic mercapto compound. A dispersion can be prepared by dispersing the crystals using a suitable dispersing agent. When preparing the crystals of the silver salt of aliphatic mercapto compound, hydrophilic colloids such as gelatin may be allowed to coexist to prepare a dispersion of the silver salt of aliphatic mercapto compound. As a method other than this method, aliphatic mercapto may be put into a reaction vessel, to which a silver nitrate is added to obtain a dispersion.

(ii) Silver Salt of Heterocyclic Mercapto Compound

When heterocyclic mercapto compound is used, the heterocycle moiety thereof is preferably a nitrogen containing heterocycle, a sulfur containing heterocycle, an oxygen containing heterocycle and a selenium containing heterocycle, and more preferably a nitrogen containing heterocycle, a sulfur containing heterocycle and an oxygen containing heterocycle. Representative compounds as the nitrogen containing heterocyclic mercapto compounds are the same compounds as described in the above mentioned nitrogen-containing heterocyclic compound having a mercapto group.

The heterocyclic mercapto compound may have a substituent or not. In the case of having a substituent, the substituent is not particularly limited.

Preparation of a silver salt of heterocyclic mercapto compound can be executed by a common method. For example, the heterocyclic mercapto compound is heated and melted in water at a temperature of its melting point or higher (generally in a range of 10 to 90° C.), then sodium hydroxide is used to prepare a sodium salt of heterocyclic mercapto compound, and the a sodium salt is reacted with silver nitrate to obtain crystals of the silver salt of heterocyclic mercapto compound. A dispersion can be prepared by dispersing these using a suitable dispersing agent. When preparing the crystals of the silver salt of heterocyclic mercapto compound, hydrophilic colloids such as gelatin may be allowed to coexist to prepare a dispersion of a silver salt of heterocyclic mercapto compound. As a method other than this method, heterocyclic mercapto compound may be put into a reaction vessel, to which a silver nitrate is added to obtain a dispersion.

In both of the cases of using a silver salt of a nitrogen-containing heterocyclic compound or using a silver salt of a mercapto compound, a method of dispersing an organic silver salt in a coating liquid preferably includes dispersing the organic silver salt in a hydrophilic binder such as gelatin when a binder of the image-forming layer in the black-and-white photothermographic material to which the organic silver salt is added includes gelatin. Further, gelatin may be added upon preparing the organic silver salt or after preparing the organic silver salt, but gelatin is preferably added upon preparing the organic silver salt. The dispersing agent may include a variety of synthesized hydrophilic polymer materials as a hydrophilic binder other than gelatin such as a graft polymer of a gelatin and other polymers, alubmin, protein such as casein, a cellulose derivative such as hydroxyethyl cellulose, carboxymetyl cellulose and cellulose sulfuric esters, sodium alginate, a sugar derivative such as a starch derivative, and a homopolymer or a copolymer such as polyvinyl alcohol, polyvinyl alcohol partial acetal, poly-N-vinylpyrrolidone, polyacrylic acid, polymethacrylic acid, polyacrylamide, polyvinylimidazole and polyvinylpyrazole. Further, as the dispersing agent, a surfactant such as an anionic surfactant such as sodium triisopropyl naphthalenesulfonate (a mixture of the compounds having different substitution positions of three isopropyl groups) may also be used.

While using the above mentioned dispersing agents, there can be employed a ball mill, a colloid mill, a vibrating ball mill, a sand mill, a jet mill, a roller mill or an ultrasonic wave to obtain a dispersion in a suitable solvent such as water. For the above-mentioned mills, beads such as zirconia are usually employed as a dispersion medium. Therefore, Zr and the like are sometimes eluted from such beads and contaminate the dispersion. A concentration of such contaminants depends on a condition used for dispersion, but typically in a range of 1 ppm to 1000 ppm. Zr content in the photosensitive materials being 0.5 mg or less per 1 g of silver does not interfer with practical use.

(3) Additionally-Usable Organic Silver Salt

As the non-photosensitive organic silver salt, a silver salt of carboxylic acid can be additionally used in the invention. Examples of the silver salt of carboxylic acid include a silver salt of aliphatic carboxylic acid (e.g., aliphatic acid having 10 to 30 carbon atoms) and a silver salt of aromatic carboxylic acid.

Preferable examples of a silver salt of aliphatic carboxylic acid include silver behenate, silver arachidate, silver stearate, silver oleate, silver laurate, silver caprate, silver myristate, silver palmitate, silver maleate, silver fumatre, silver tarate, silver furoate, silver linoleate, silver butanoate, silver camphorate or a mixture thereof.

Examples of the aromatic carboxylic acid and other carboxylic acids are as follows, but not limited thereto:
substituted or unsubstituted silver benzoate (e.g., silver 3,5-dihydroxylbenzoate, silver o-methylbenzoate, silver m-methylbenzoate, silver p-methylbenzoate, silver 2,4-dichlorobenzoate, silver acetamide benzoate and silver p-phenylbenzoate);
silver tannate;
silver phthalate;
silver terephthalate;
silver salicylate;
silver phenylacetate; and
silver pyromellitate.

In the invention, a silver salt of aliphatic acid containing a thioether group, such as those described in U.S. Pat. No. 3,330,663 (by Weyde et. al.) can be additionally used. A silver carboxylate having a hydrocarbon chain which contains an ether bond or a thioether bond or a silver carboxylate having a sterically hindered substituent on an α-position (of the hydrocarbon group) or an ortho-position (of the aromatic group) can be also additionally used. These silver carboxylates improve dissolution in a coating solvent, which provides a coating having little light scattering.

Such silver carboxylates are described in U.S. Pat. No. 5,491,059 (Whitcomb et. al.). Any of the mixtures of the silver salts described therein can be used in the invention, if necessary.

The silver salt of sulfonate as described in U.S. Pat. No. 4,504,575 (by Lee et. al.) may be also used with a silver salt of a nitrogen-containing heterocyclic compound and a silver salt of a mercapto compound. The silver salt of sulfosuccinate described in EP-A-0227141 (by Leenders et. al.) can be used in the invention.

Further, for example, the silver salt of acetylene described in U.S. Pat. No. 4,761,361 (by Ozaki et. al.) and U.S. Pat. No. 4,775,613 (by Hirai et. al.) can be used in combination in the invention.

A method which is employed to prepare a soap emulsion of silver is well-known in this technical field. It is described in Research Disclosure [22812 (April, 1983), 23419 (October, 1983)], U.S. Pat. No. 3,985,565 (Gabrielsen et. al.), or the foregoing documents.

A non-photosensitive silver source which can reduce silver ions can be provided as a core-shell type silver salt as described in U.S. Pat. No. 6,355,408 (by Whitcomb et. al.) and the like.

Such silver salt consists of a core containing at least one silver salt and a shell containing at least one other silver salt.

A silver dimeric composite consisting of two different silver salts described in U.S. Pat. No. 6,472,131 (by Whitcomb et. al.) can be used. Such non-photosensitive silver dimer composite consists of two different silver salts. When the above described two kinds of the silver salts include a linear saturated hydrocarbon group as a silver ligand, difference in numbers of carbon atoms of the ligand is 6 or more.

A skilled person in this art can understand that the non-photosensitive organic silver salt can be contained as a mixture of various silver salt compounds described herein.

When a non-photosensitive organic silver salt other than the silver salt of a nitrogen-containing heterocyclic compound and the silver salt of a mercapto compound is used in combination, the content of the silver salt of a nitrogen-containing heterocyclic compound and the silver salt of a mercapto compound relative to a total non-photosensitive organic silver salt is preferably 50 mole % or more and 100 mole % or less, and more preferably 80 mole % or more and 99.9 mole % or less.

It is necessary to allow the photosensitive silver halide and the non-photosensitive organic silver salt to exist within a range that catalytic reaction can occur (in other words, a distance which makes the reaction possible). Preferably, a layer containing the photosensitive silver halide and a layer containing the non-photosensitive organic silver salt are the same layer, or they may be positioned adjacently. More preferably, a layer containing the photosensitive silver halide and a layer containing the non-photosensitive organic silver salt are the same layer.

The non-photosensitive organic silver salt is preferably comprised in an amount of 5 mass % or more and 98 mass % or less, more preferably 10 mass % or more and 95 mass % or less, and further more preferably 20 mass % or more and 90 mass % or less, based on the total silver amount in the image-forming layer.

In addition, the non-photosensitive organic silver salt is usually comprised in an amount of 0.0005 mol/m² or more and 0.2 mol/m² or less, and preferably 0.01 mol/m² or more and 0.5 mass % or less.

The total silver amount in the photothermographic material of the invention is preferably 0.001 mol/m² or more and 0.05 mol/m² or less, and more preferably 0.005 mol/m² or more and 0.03 mol/m² or less.

Binder

In the photothermographic material of the invention, a hydrophilic binder constitutes 50 mass % or more of the binders contained in the image forming layer. More preferably, the hydrophilic binder constitutes 55 mass % or more and 100 mass % or less, and further more preferably 60 mass % or more and 99 mass % or less of the binders contained in the image forming layer.

In the invention, the hydrophilic binder is defined as one which can be dissolved in water or a mixture solution containing water and an organic solvent, which is a solvent which can be arbitrary mixed with water.

Examples of a useful hydrophilic binder include protein and a protein derivative, gelatin and a gelatin derivative (hard film or non-hard film, alkali-treated and acid-treated gelatin, acetylated gelatin, oxidation-treated gelatin, phthalated gelatin and deionized gelatin), a cellulose material such as hydroxymethyl cellulose and cellulose ester, an acrylamide/methacrylamide polymer, an acrylic/methacrylic acid polymer, polyvinylpyrrolidone, polyvinyl alcohol, poly(vinyllactam), a polymer of sulfoalkyl acrylate or methacrylate, hydrolyzed vinyl polyacetate, polyacrylamide, polysaccharide (e.g., dextrin, starch ether), and other synthetic or natural peptizer which is well-known as an aqueous photographic emulsion (disclosed in, e.g., Research Disclosure No. 38957), but not limited thereto. Cationic starch is preferably used as a peptizer of silver halide particle in the form of plate as described in U.S. Pat. No. 5,620,840 (by Maskasky) and U.S. Pat. No. 5,667,955 (by Maskasky).

A particularly useful hydrophilic binder is gelatin, a gelatin derivative, polyvinyl alcohol and a cellulose material. A particularly preferred hydrophilic binder is gelatin and its derivative. In the most preferable embodiment of the binder of the image-forming layer, gelatin and its derivative constitute at least 75 mass % of all the binder of the image-forming layer.

For the binder of an image-forming layer, a hydrophobic binder can be used in combination. Examples of the typical hydrophobic binders include polyvinyl acetal, polyvinyl chloride, polyvinyl acetate, cellulose acetate, cellulose acetate butyrate, polyolefin, polyester, polystyrene, polyacrylonitrile, polycarbonate, a methacrylate copolymer, a maleic anhydride ester copolymer, a butadiene/styrene copolymer, and other materials known in this field, but not limited thereto. Copolymer (including a trimer) is included in a definition of a polymer. Particularly preferred are polyvinyl acetal (e.g., polyvinyl butyral and polyvinyl formal) and a vinyl copolymer (e.g., polyvinyl acetate and polyvinyl chloride). A particularly suitable binder is a polyvinyl butyral resin which is used as BUTVAR® B79 (manufactured by Solutia) and PIOLOFORM® BS-18, and PIOLOFORM® BL-16 (manufactured by Wacker chemicals Co., Ltd.). Also, a small amount of a water dispersion of a hydrophobic binder can be used. For example, such latex binders are described in EP-0911691 A1 (by Ishizaka et. al.).

A curing agent for a variety of the binders can be used in accordance with necessity. The hydrophilic binder used in the photothermographic material can be partially or completely cured by using a conventional curing agent. Useful curing agents are well-known in the art, and, examples thereof include a vinylsulfone composite described in U.S. Pat. No. 6,143,487 (by Philip et. al.) and EP 0460589 (by Gathmann et. al.), and other curing agents such as aldehydes are described in U.S. Pat. No. 6,190,822 (by Dickerson et. al.) and “Theory of the Photographic Process” edited by T. H. James (the 4^{th} edition), Eastman Kodak Co., Ltd., Rochester, N.Y., 1977, Chapter 2, pp. 77.

A binder should be capable of bearing the conditions of time and temperature required for developing the photothermographic material. Generally, it is preferable that the binder does not degrade at 150° C. for 60 seconds or change in structure. It is more preferable that the binder does not degrade at 177° C. for 60 seconds or change in structure.

The total amount of all binders in the image-forming layer is such that the weight ratio of all the binders/the organic silver salts is in a range of from 1/10 to 10/1, preferably 1/3 to 5/1, and more preferably 1/1 to 3/1. In addition, the weight ratio of the binders/silver halide is in a range of from 400 to 5, and preferably 200 to 10.

The coating amount of all the binders of the image-forming layer is preferably 0.2 g/m² or more and 30 g/m² or less, preferably 1 g/m² or more and 15 g/m² or less, and more preferably 2 g/m² or more and 10 g/m² or less. In the present invention, a crosslinking agent for crosslinking, a surface active agent for improving coating property, etc. may be added to the image-forming layer.

Preferable Solvent for Coating Liquid

In the invention, a solvent of a coating liquid for the image forming layer (wherein a solvent and water are collectively described as a solvent for simplicity) is preferably an aqueous solvent containing water at 30% by weight or more. Examples of solvents other than water may include any of water-miscible organic solvents such as methyl alcohol, ethyl alcohol, isopropyl alcohol, methyl cellosolve, ethyl cellosolve, dimethylformamide and ethyl acetate. A water content in a solvent is more preferably 50% by weight or more and still more preferably 70% by weight or more. Concrete examples of a preferable solvent composition, in addition to water=100, are compositions in which methyl alcohol is contained at ratios of water/methyl alcohol=90/10 and 70/30, in which dimethylformamide is further contained at a ratio of water/methyl alcohol/dimethylformamide=80/15/5, in which ethyl cellosolve is further contained at a ratio of water/methyl alcohol/ethyl cellosolve=85/10/5, and in which isopropyl alcohol is further contained at a ratio of water/methyl alcohol/isopropyl alcohol=85/10/5 (wherein the numerals presented above are values in % by weight).

Explanaition of Silver Halide

1) Halogen Composition

For the photosensitive silver halide used in the invention, there is no particular restriction on the halogen composition and silver chloride, silver bromochloride, silver bromide, silver iodobromide, silver iodochlorobromide and silver iodide can be used. Among them, silver bromide, silver iodobromide and silver iodide are preferred. The distribution of the halogen composition in a grain may be uniform or the halogen composition may be changed stepwise, or it may be changed continuously. Further, a silver halide grain having a core/shell structure can be used preferably. Preferred structure is a twofold to fivefold structure and, more preferably, core/shell grain having a twofold to fourfold structure can be used. Further, a technique of localizing silver bromide or silver iodide to the surface of a silver chloride, silver bromide or silver chlorobromide grains can also be used preferably.

2) Method of Grain Formation

The method of forming photosensitive silver halide is well-known in the relevant art and, for example, methods described in Research Disclosure No. 10729, June 1978 and U.S. Pat. No. 3,700,458 can be used. Specifically, a method of preparing a photosensitive silver halide by adding a silver-supplying compound and a halogen-supplying compound in a gelatin or other polymer solution and then mixing them with an organic silver salt is used. Further, a method described in JP-A No. 11-119374 (paragraph Nos. 0217 to 0224) and methods described in JP-A Nos. 11-352627 and 2000-347335 are also preferred.

3) Grain Size

The grain size of the photosensitive silver halide is preferably small with an aim of suppressing clouding after image formation and, specifically, it is 0.20 μm or less, more preferably, 0.01 μm to 0.15 μm and, further preferably, 0.02 μm to 0.12 μm. The grain size as used herein means an average diameter of a circle converted such that it has a same area as a projected area of the silver halide grain (projected area of a main plane in a case of a tabular grain).

4) Grain Shape

The shape of the silver halide grain can include, for example, cubic, octahedral, tabular, spherical, rod-like or potato-like shape. The cubic grain is particularly preferred in the invention. A silver halide grain rounded at corners can also be used preferably. While there is no particular restriction on the index of plane (Mirror's index) of an crystal surface of the photosensitive silver halide grain, it is preferred that the ratio of {100} face is higher, in which the spectral sensitizing efficiency is higher in a case of adsorption of a spectral sensitizing dye. The ratio is preferably 50% or more, more preferably, 65% or more, and further preferably, 80% or more. The ratio of the Mirror's index {100} face can be determined by the method of utilizing the adsorption dependency of {111} face and {100} face upon adsorption of a sensitizing dye described by T. Tani; in J. Imaging Sci., vol. 29, page 165 (1985).

5) Heavy Metal

The photosensitive silver halide grain of the invention can contain metals or complexes of metals belonging to groups 8 to 10 of the periodic table (showing groups 1 to 18). The metal or the center metal of the metal complex from groups 8 to 10 of the periodic table is preferably rhodium, ruthenium or iridium. The metal complex may be used alone, or two or more kinds of complexes comprising identical or different species of metals may be used together. A preferred content is in the range from 1×10⁻⁹ mol to 1×10⁻³ mol per one mol of silver. The heavy metals, metal complexes and the adding method thereof are described in JP-A No. 7-225449, in paragraph Nos. 0018 to 0024 of JP-A No. 11-65021 and in paragraph Nos. 0227 to 0240 of JP-A No. 11-119374.

In the invention, a silver halide grain having a hexacyano metal complex is present on the outermost surface of the grain is preferred. The hexacyano metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, hexacyano Fe complex is preferred.

Since the hexacyano complex exists in ionic form in an aqueous solution, paired cation is not important and alkali metal ion such as sodium ion, potassium ion, rubidium ion, cesium ion and lithium ion, ammonium ion, alkyl ammonium ion (for example, tetramethyl ammonium ion, tetraethyl ammonium ion, tetrapropyl ammonium ion, and tetra(n-butyl)ammonium ion), which are easily misible with water and suitable to precipitation operation of a silver halide emulsion are preferably used.

The hexacyano metal complex can be added while being mixed with water, as well as a mixed solvent of water and an appropriate organic solvent miscible with water (for example, alcohols, ethers, glycols, ketones, esters and amides) or gelatin.

The addition amount of the hexacyano metal complex is preferably from 1×10⁻⁵ mol to 1×10⁻² mol and, more preferably, from 1×10⁻⁴ mol to 1×10⁻³ per 1 mol of silver in each case.

In order to allow the hexacyano metal complex to be present on the outermost surface of a silver halide grain, the hexacyano metal complex is directly added in any stage of: after completion of addition of an aqueous solution of silver nitrate used for grain formation, before completion of emulsion formation step prior to a chemical sensitization step, of conducting chalcogen sensitization such as sulfur sensitization, selenium sensitization and tellurium sensitization or noble metal sensitization such as gold sensitization, during washing step, during dispersion step and before chemical sensitization step. In order not to grow the fine silver halide grain, the hexacyano metal complex is rapidly added preferably after the grain is formed, and it is preferably added before completion of the emulsion formation step.

Addition of the hexacyano complex may be started after addition of 96% by weight of an entire amount of silver nitrate to be added for grain formation, more preferably started after addition of 98% by weight and, particularly preferably, started after addition of 99% by weight.

When any of the hexacyano metal complex is added after addition of an aqueous silver nitrate just before completion of grain formation, it can be adsorbed to the outermost surface of the silver halide grain and most of them form an insoluble salt with silver ions on the surface of the grain. Since the hexacyano iron (II) silver salt is a less soluble salt than AgI re-dissolution with fine grins can be prevented and fine silver halide grains with smaller grain size can be prepared.

Metal atoms that can be contained in the silver halide grain used in the invention (for example, [Fe(CN)₆]⁴⁻, desalting method of a silver halide emulsion and chemical sensitizing method are described in paragraph Nos. 0046 to 0050 of JP-A No. 11-84574, in paragraph Nos. 0025 to 0031 of JP-A No. 11-65021, and paragraph Nos. 0242 to 0250 of JP-A No. 11-119374.

6) Gelatin

As the gelatin contained the photosensitive silver halide emulsion used in the invention, various kinds of gelatins can be used. It is necessary to maintain an excellent dispersion state of a photosensitive silver halide emulsion in an organic silver salt containing coating liquid, and gelatin having a molecular weight of 10,000 to 1,000,000 is preferably used. And phthalated gelatin is also preferably used. These gelatins may be used at grain formation step or at the time of dispersion after desalting treatment and it is preferably used at grain formation step.

7) Sensitizing Dye

As the sensitizing dye applicable in the invention, those capable of spectrally sensitizing silver halide grains in a desired wavelength region upon adsorption to silver halide grains having spectral sensitivity suitable to spectral characteristic of an exposure light source can be selected advantageously. The sensitizing dyes and the adding method are disclosed, for example, JP-A No. 11-65021 (paragraph Nos. 0103 to 0109), as a compound represented by the formula (II) in JP-A No. 10-186572, dyes represented by the formula (1) in JP-A No. 11-119374 (paragraph No. 0106), dyes described in U.S. Pat. Nos. 5,510,236 and 3,871,887 (Example 5), dyes disclosed in JP-A Nos. 2-96131 and 59-48753, as well as in page 19, line 38 to page 20, line 35 of EP-A No. 0803764A1, and in JP-A Nos. 2001-272747, 2001-290238 and 2002-23306. The sensitizing dyes described above may be used alone or two or more of them may be used in combination. In the invention, sensitizing dye can be added preferably after desalting step and before coating step, and more preferably after desalting step and before the completion of chemical ripening.

In the invention, the sensitizing dye may be added at any amount according to the property of sensitivity and fogging, but it is preferably added from 10⁻⁶ mol to 1 mol, and more preferably from 10⁻⁴ mol to 10⁻¹ mol, per 1 mol of silver halide in the image forming layer.

The photothermographic material of the invention may also contain super sensitizers in order to improve spectral sensitizing effect. The super sensitizers usable in the invention can include those compounds described in EP-A No. 587338, U.S. Pat. Nos. 3,877,943 and 4,873,184 and JP-A Nos. 5-341432, 11-109547, and 10-111543.

8) Chemical Sensitization

The photosensitive silver halide grain in the invention is preferably chemically sensitized by sulfur sensitizing method, selenium sensitizing method or tellurium sensitizing method. As the compound used preferably for sulfur sensitizing method, selenium sensitizing method and tellurium sensitizing method, known compounds, for example, compounds described in JP-A No. 7-128768 can be used. Particularly, tellurium sensitization is preferred in the invention and compounds described in the literature cited in paragraph No. 0030 in JP-A No. 11-65021 and compounds shown by formulae (II), (III), and (MV) in JP-A No. 5-313284 are more preferred.

The photosensitive silver halide grain in the invention is preferably chemically sensitized by gold sensitizing method alone or in combination with the chalcogen sensitization described above. As the gold sensitizer, those having a pxidation number of gold of either +1 or +3 are preferred and those gold compounds used usually as the gold sensitizer are preferred. As typical examples, chloroauric acid, bromoauric acid, potassium chloroaurate, potassium bromoaurate, auric trichloride, potassium auric thiocyanate, potassium iodoaurate, tetracyanoauric acid, ammonium aurothiocyanate and pyridyl trichloro gold are preferred. Further, gold sensitizers described in U.S. Pat. No. 5,858,637 and JP-A No. 2002-278016 are also used preferably.

In the invention, chemical sensitization can be applied at any time so long as it is after grain formation and before coating and it can be applied, after desalting, (1) before spectral sensitization, (2) simultaneously with spectral sensitization, (3) after spectral sensitization and (4) just before coating.

The amount of sulfur, selenium and tellurium sensitizer used in the invention may vary depending on the silver halide grain used, the chemical ripening condition and the like and it is used by about 10⁻⁸ mol to 10⁻² mol, preferably, 10⁻⁷ mol to 10⁻³ mol per 1 mol of silver halide.

The addition amount of the gold sensitizer may vary depending on various conditions and it is generally about 10⁻⁷ mol to 10⁻³ mol and, more preferably, 10⁻⁶ mol to 5×10⁻⁴ mol per 1 mol of silver halide.

There is no particular restriction on the condition for the chemical sensitization in the invention and, appropriately, pH is 5 to 8, pAg is 6 to 11 and temperature is at 40° C. to 95° C.

In the silver halide emulsion used in the invention, a thiosulfonic acid compound may be added by the method shown in EP-A No. 293917.

A reductive compound is used preferably for the photosensitive silver halide grain in the invention. As the specific compound for the reduction sensitization, ascorbic acid or thiourea dioxide is preferred, as well as use of stannous chloride, aminoimino methane sulfonic acid, hydrazine derivatives, borane compounds, silane compounds and polyamine compounds are preferred. The reduction sensitizer may be added at any stage in the photosensitive emulsion production process from crystal growth to the preparation step just before coating. Further, it is preferred to apply reduction sensitization by ripening while keeping pH to 7 or higher or pAg to 8.3 or lower for the emulsion, and it is also preferred to apply reduction sensitization by introducing a single addition portion of silver ions during grain formation.

9) Compound that can be One-Electron-Oxidized to Provide a One-Electron Oxidation Product which Releases One or More Electrons

The photothermographic material of the invention preferably contains a compound that can be one-electron-oxidized to provide a one-electron oxidation product which releases one or more electrons. The said compound can be used alone or in combination with various chemical sensitizers described above to increase the sensitivity of silver halide.

As the compound that can be one-electron-oxidized to provide a one-electron oxidation product which releases one or more electrons is a compound selected from the following Groups 1 and 2.

The compounds of Groups 1 and 2 contained in the photothermographic material of the invention are explained in the followings:
Group 1: a compound that can be one-electron-oxidized to provide a one-electron oxidation product which further releases one or more electrons, due to being subjected to a subsequent bond cleavage reaction;
Group 2: a compound that can be one-electron-oxidized to provide a one-electron oxidation product, which further releases one or more electrons after being subjected to a subsequent bond formation.

The compound of Group 1 will be explained below.

In the compound of Group 1, as for a compound that can be one-electron-oxidized to provide a one-electron oxidation product which further releases one electron, due to being subjected to a subsequent bond cleavage reaction, specific examples include examples of compound referred to as “one photon two electrons sensitizer” or “deprotonating electron-donating sensitizer” described in JP-A No. 9-211769 (Compound PMT-1 to S-37 in Tables E and F, pages 28 to 32); JP-A No. 9-211774; JP-A No. 11-95355 (Compound INV 1 to 36); JP-W No. 2001-500996 (Compound 1 to 74, 80 to 87, and 92 to 122); U.S. Pat. Nos. 5,747,235 and 5,747,236; EP No. 786692 A1 (Compound INV 1 to 35); EP No. 893732 A1; U.S. Pat. Nos. 6,054,260 and 5,994,051; etc. Preferred ranges of these compounds are the same as the preferred ranges described in the quoted specifications.

In the compound of Group 1, as for a compound that can be one-electron-oxidized to provide a one-electron oxidation product which further releases one or more electrons, due to being subjected to a subsequent bond cleavage reaction, specific examples include the compounds represented by the following Formula (G1) (same as formula (1) described in JP-A No. 2003-114487), Formula (G2) (same as formula (2) described in JP-A No. 2003-114487), Formula (G3) (same as formula (1) described in JP-A No. 2003-114488), Formula (G4) (same as formula (2) described in JP-A No. 2003-114488), Formula (G5) (same as formula (3) described in JP-A No. 2003-114488), Formula (G6) (same as formula (1) described in JP-A No. 2003-75950), Formula (G7) (same as formula (2) described in JP-A No. 2003-75950), and Formula (G8), and the compound represented by Formula (G9) among the compounds which can undergo the chemical reaction represented by Reaction Scheme (1). And the preferable range of these compounds is the same as the preferable range described in the quoted specification.

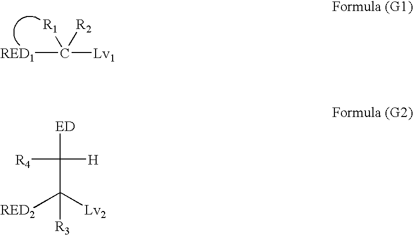

In Formulae (G1) and (G2), RED₁ and RED₂ represent a reducing group. R₁ represents a non-metal atomic group capable of forming a ring structure corresponding to a tetrahydro form or a hexahydro form of a 5- or 6-membered aromatic ring (including an aromatic heterocycle) together with a carbon atom (C) and RED₁. R₂, R₃ and R₄ represent a hydrogen atom or a substituent. Lv₁ and Lv₂ represent a leaving group. ED represents an electron donating group.

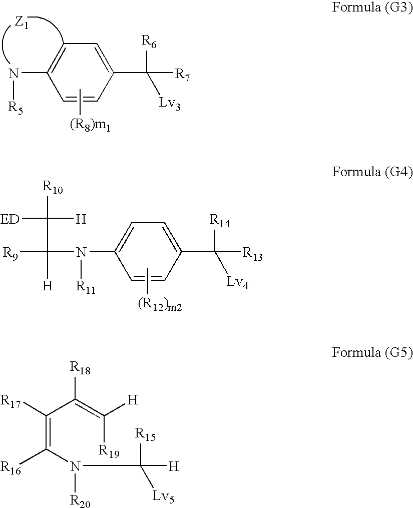

In Formulae (G3), (G4) and (G5), Z₁ represents an atomic group capable of forming a 6-membered ring together with a nitrogen atom and two carbon atoms of the benzene ring. R₅, R₆, R₇, R₉, R₁₀, R₁₁, R₁₃, R₁₄, R₁₅, R₁₆, R₁₇, R₁₈ and R₁₉ represent a hydrogen atom or a substituent. R₂₀ represents a hydrogen atom or a substituent, but when R₂₀ represents a group other than an aryl group, R₁₆ and R₁₇ are mutually bonded to form an aromatic ring or an aromatic heterocycle. R₈ and R₁₂ represent a group that can be a substitutent on the benzene ring, m₁ represents an integer from 0 to 3, m₂ represents an integer from 0 to 4, and Lv₃, Lv₄ and Lv₅ represent a leaving group.

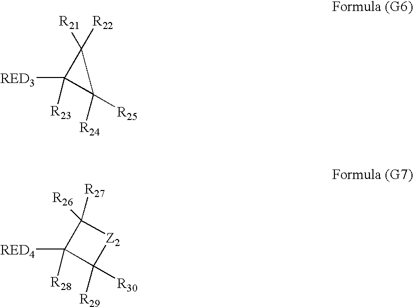

In Formulae (G6) and (G7), RED₃ and RED₄ represent a reducing group. R₂₁, to R₃₀ represent a hydrogen atom or a substituent, Z₂ represents —CR₁₁₁R₁₁₂—, —NR₁₁₃— or —O—. R₁₁₁ and R₁₁₂ each independently represent a hydrogen atom or a substituent. R₁₁₃ represents a hydrogen atom, an alkyl group, an aryl group or a heterocyclic group.

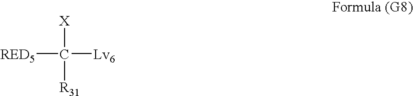

In Formula (G8), RED₅ is a reducing group and represents an arylamino group or a heterocyclic amino group. R₃₁ represents a hydrogen atom or a substituent. X represents an alkoxy group, an aryloxy group, a heterocyclic oxy group, an alkylthio group, an arylthio group, a heterocyclic thio group, an alkylamino group, an arylamino group or a heterocyclic amino group. Lv₆ is a leaving group and represents a carboxyl group or a salt thereof, or hydrogen atom.

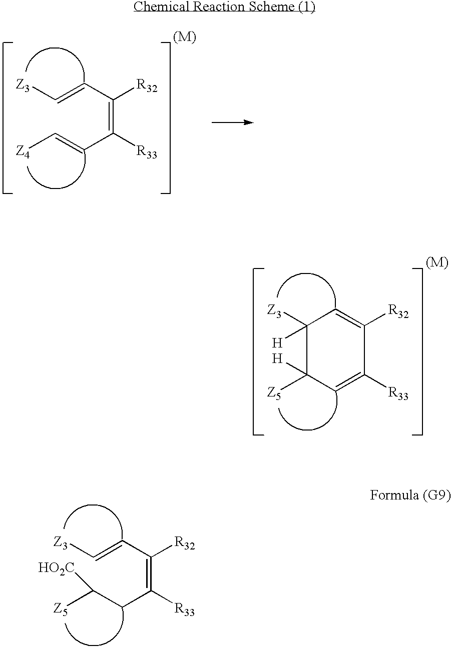

The compound represented by Formula (G9) is a compound which is capable, after being subjected to 2-electron oxidation accompanied by decarboxylation, of a bond forming reaction represented by the chemical Reaction Scheme (1). In the chemical Reaction Scheme (1), R₃₂ and R₃₃ represent a hydrogen atom or a substituent. Z₃ represents a group which forms a 5- or 6-membered heterocycle together with C═C. Z₄ represents a group which forms a 5- or 6-membered aryl group or heterocyclic group together with C═C. M represents a radical, a radical cation or a cation. In Formula (G9), R₃₂, R₃₃ and Z₃ have the same meanings as in the chemical Reaction Scheme (1). Z₅ represents a group which forms a 5- or 6-membered cyclic aliphatic hydrocarbon group or a heterocyclic group together with C—C.

Next, the compound of Group 2 is explained.

In the compound of Group 2, as for a compound that can be one-electron-oxidized to provide a one-electron oxidation product which further releases one or more electrons, after being subjected to a subsequent bond cleavage reaction, specific examples can include the compound represented by (G10) (same as Formula (1) described in JP-A No. 2003-140287), and the compound represented by Formula (G11) which can undergo the chemical reaction represented by chemical reaction scheme (1). The preferable range of these compounds is the same as the preferable range described in the quoted specification.
RED₆-Q-Y Formula (G10)

In Formula (G10), RED₆ represents an electron-oxidized reducing group. Y represents a reactive group including a carbon-carbon double bond portion, a carbon-carbon triple bond portion, an aromatic group portion or a nonaromatic heterocyclic group portion of a benzo condensed ring, each of which is formed by reacting RED₆ with a 1-electron oxidized product generated by 1-electron oxidation. Q represents a linking group which connects RED₆ and Y.

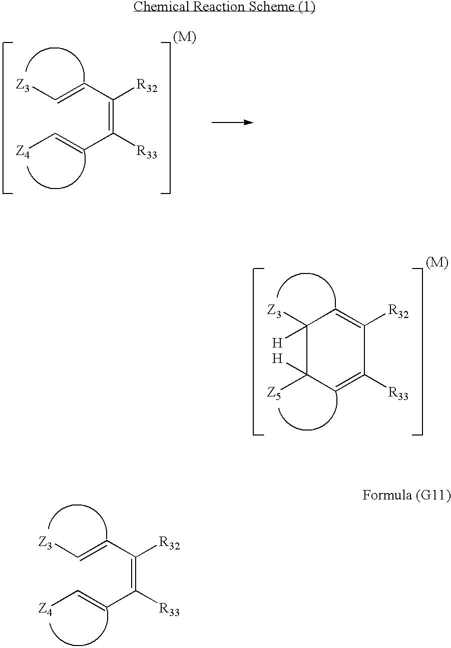

The compound represented by Formula (G11) is a compound which gives rise to a bond forming reaction represented by the Chemical Reaction Scheme (1) through oxidation. In the Chemical Reaction Scheme (1), R₃₂ and R₃₃ are a hydrogen atom or a substituent. Z₃ represents a group which forms a 5- or 6-membered heterocycle together with C═C. Z₄ represents a group which forms a 5- or 6-membered aryl group or heterocyclic group together with C═C. Z₅ represents a group which forms a 5- or 6-membered cyclic aliphatic hydrocarbon group or heterocyclic group together with C—C. M represents a radical, a radical cation or a cation. In Formula (G11), R₃₂, R₃₃, Z₃ and Z₄ have the same meanings as in the Chemical Reaction Scheme (1).

The compounds of Groups 1 and 2 preferably are “the compound having an adsorptive group to silver halide in a molecule” or “the compound having a partial structure of a spectral sensitizing dye in a molecule”. The representative adsorptive group to silver halide is the group described in JP-A No. 2003-156823, page 16 right, line 1 to page 17 right, line 12. A partial structure of a spectral sensitizing dye is the structure described in JP-A No. 2003-156823, line 34 in right column on page 17 to line 6 in left column on page 18.

As the compound of Groups 1 and 2, “the compound having at least one adsorptive group to silver halide in a molecule” is more preferred, and “the compound having two or more adsorptive groups to silver halide in a molecule” is further preferred. In the case where two or more adsorptive groups exist in a single molecule, those adsorptive groups may be identical or different with each other.

As preferable adsorptive group, a nitrogen containing heterocyclic group substituted by a mercapto group (e.g., a 2-mercaptothiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzothiazole group, a 1,5-dimethyl-1,2,4-triazolium-3-thiolate group and the like) or a nitrogen containing heterocyclic group having —NH— group as a partial structure of heterocycle capable to form a silver imidate (>NAg) (e.g., a benzotriazole group, a benzimidazole group, an indazole group and the like) are described. A 5-mercaptotetrazole group, a 3-mercapto-1,2,4-triazole group and a benzotriazole group are particularly preferable and a 3-mercapto-1,2,4-triazole group and a 5-mercaptotetrazole group are most preferable.

As an adsorptive group, the group which has two or more mercapto groups as a partial structure in a molecule is also particularly preferable. Herein, a mercapto group (—SH) may become a thione group in the case where it can tautomerize. As preferred examples of adsorptive group having two or more mercapto groups as a partial structure (dimercapto-substituted nitrogen containing heterocyclic group and the like), a 2,4-dimercaptopyrimidine group, a 2,4-dimercaptotriazine group and a 3,5-dimercapto-1,2,4-triazole group are described.

Further, a quaternary salt structure of nitrogen or phosphor is also preferably used as an adsorptive group. As typical quaternary salt structure of nitrogen, an ammonio group (a trialkylammonio group, a dialkylarylammonio group, a dialkylheteroarylammonio group, an alkyldiarylammonio group, an alkyldiheteroarylammonio group and the like) and a nitrogen containing heterocyclic group containing quaternary nitrogen atom are described. As a quaternary salt structure of phosphor, a phosphonio group (a trialkylphosphonio group, a dialkylarylphosphonio group, a dialkylheteroarylphosphonio group, an alkyldiarylphosphonio group, an alkyldiheteroarylphosphonio group, a triarylphosphonio group, a triheteroarylphosphonio group and the like) are described. A quaternary salt structure of nitrogen is more preferably used and a 5 or 6 membered aromatic heterocyclic group containing a quaternary nitrogen atom is further preferably used. Particularly preferably, a pyrydinio group, a quinolinio group and an isoquinolinio group are used. These nitrogen containing heterocyclic groups containing a quaternary nitrogen atom may have any substituent.

As examples of counter anion of quaternary salt, halogen ion, carboxylate ion, sulfonate ion, sulfate ion, perchlorate ion, carbonate ion, nitrate ion, BF₄⁻, PF₆⁻, Ph₄B⁻ and the like are described. In the case where the group having negative charge at carboxylate group and the like exists in a molecule, an inner salt may be formed with it. As a counter ion outside of a molecule, chloro ion, bromo ion and methanesulfonate ion are particularly preferable.

The preferred structure of the compound represented by Group 1 and 2 compound having a quaternary salt of nitrogen or phosphor as an adsorptive group is represented by formula (X).
(P-Q₁-)ᵢ-R(-Q₂-S)ⱼ Formula (G10)

In Formula (X), P and R each independently represent a quaternary salt structure of nitrogen or phosphor, which is not a partial structure of a spectral sensitizing dye. Q₁ and Q₂ each independently represent a linking group and typically represent a single bond, an alkylene group, an arylene group, a heterocyclic group, —O—, —S—, —NR_{N}, —C(═O)—, —SO₂—, —SO—, —P(═O)— and the group which consists of combination of these groups. Herein, R_{N} represents a hydrogen atom, an alkyl group, an aryl group or a heterocyclic group. S represents a residue which is obtained by removing one atom from the compound represented by Group 1 or 2. i and j are an integral number of one or more and are selected in a range of i+j=2 to 6. The case where i is 1 to 3 and j is 1 to 2 is preferable, the case where i is 1 or 2 and j is 1 is more preferable, and the case where i is 1 and j is 1 is particularly preferable. The compound represented by formula (X) preferably has 10 to 100 carbon atoms in total, more preferably 10 to 70 carbon atoms, further preferably 11 to 60 carbon atoms, and particularly preferably 12 to 50 carbon atoms.

In the following, specific examples of the compounds represented by Groups 1 and 2 will be shown, but the invention is not limited to such examples.

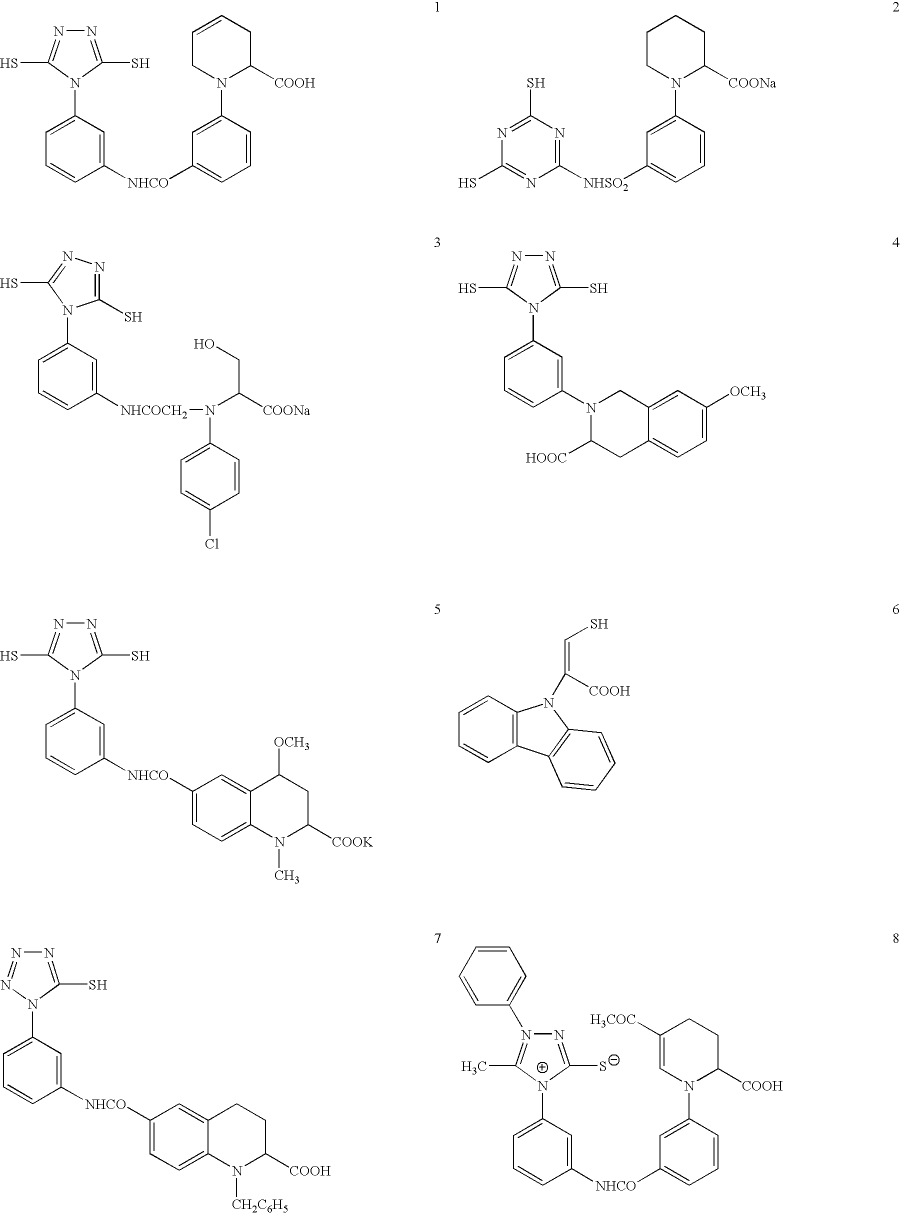

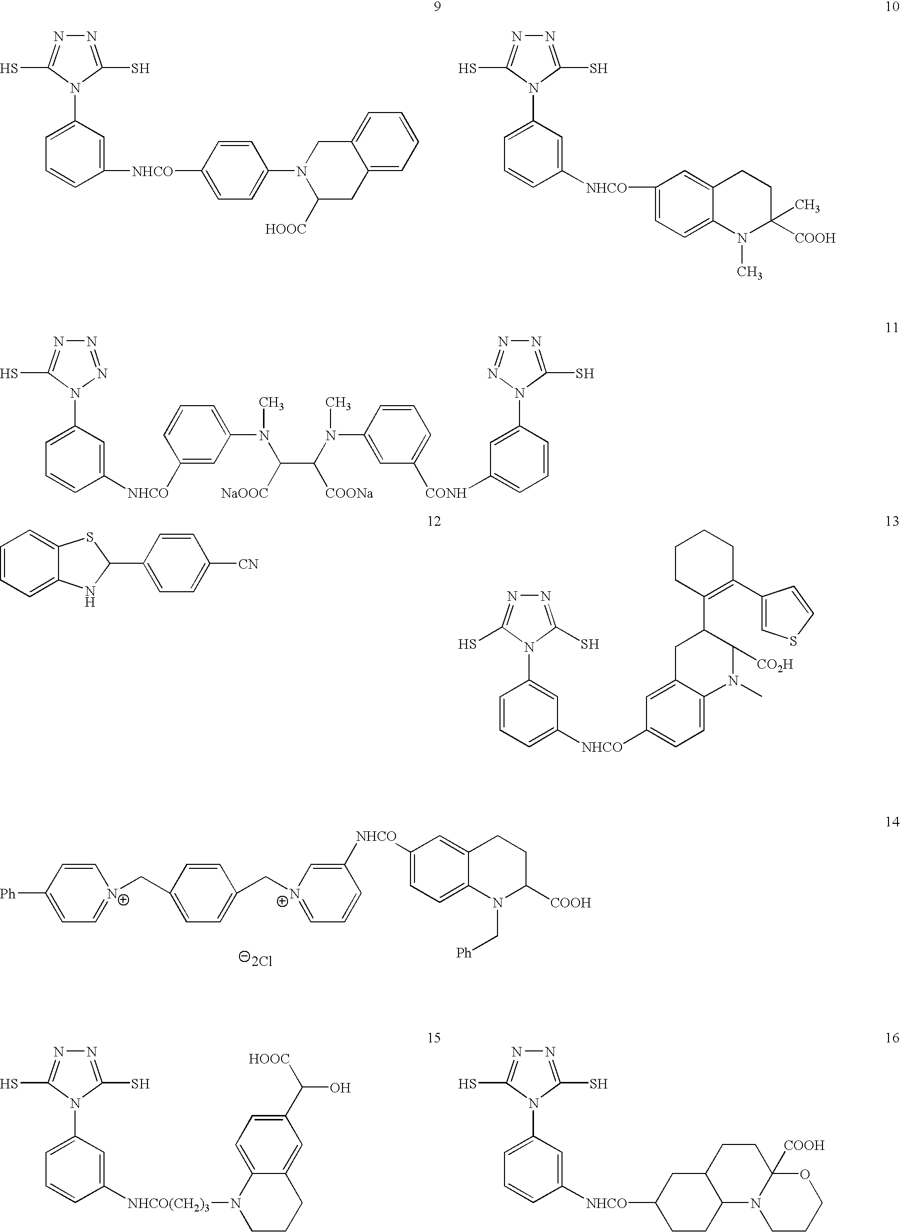

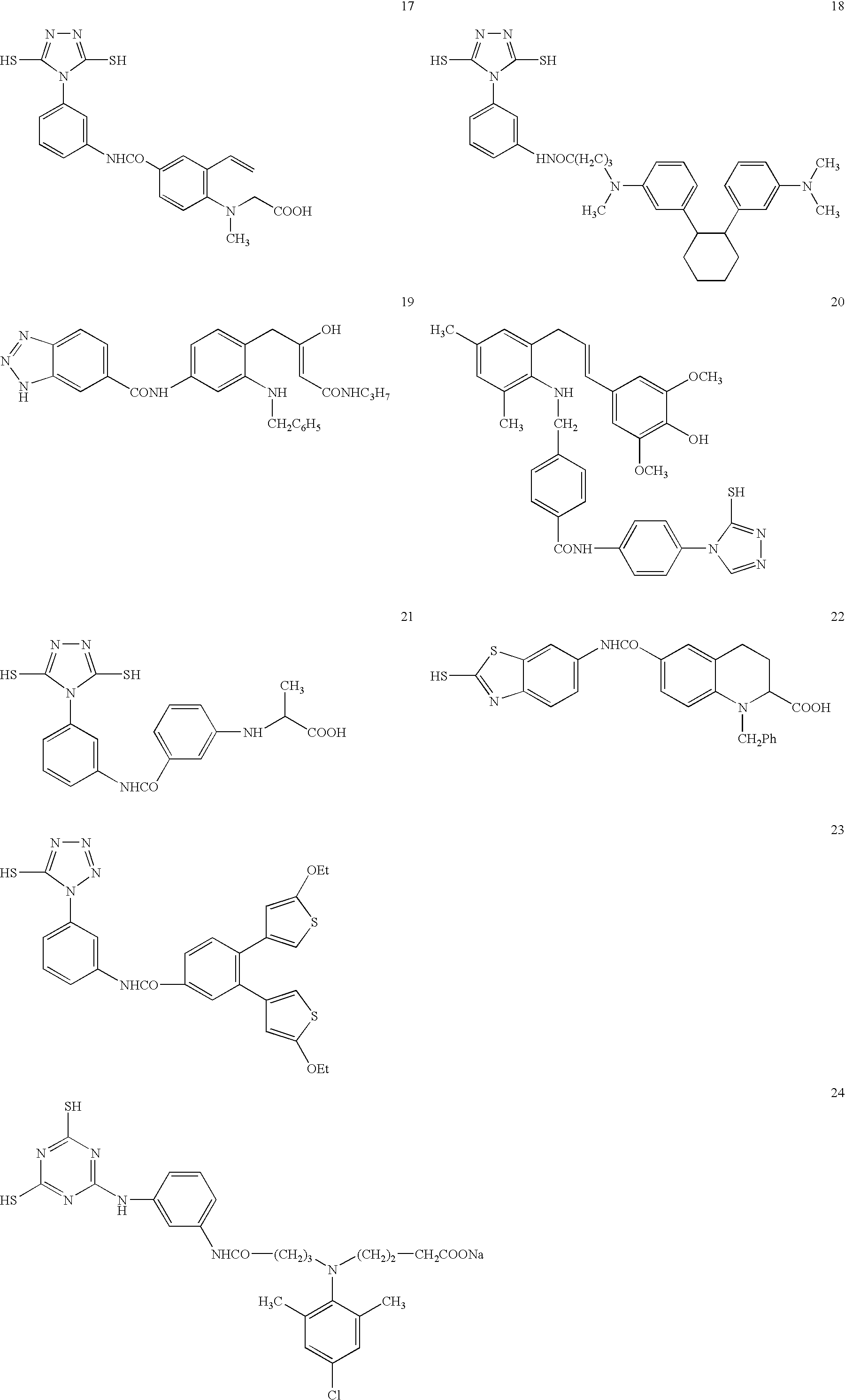

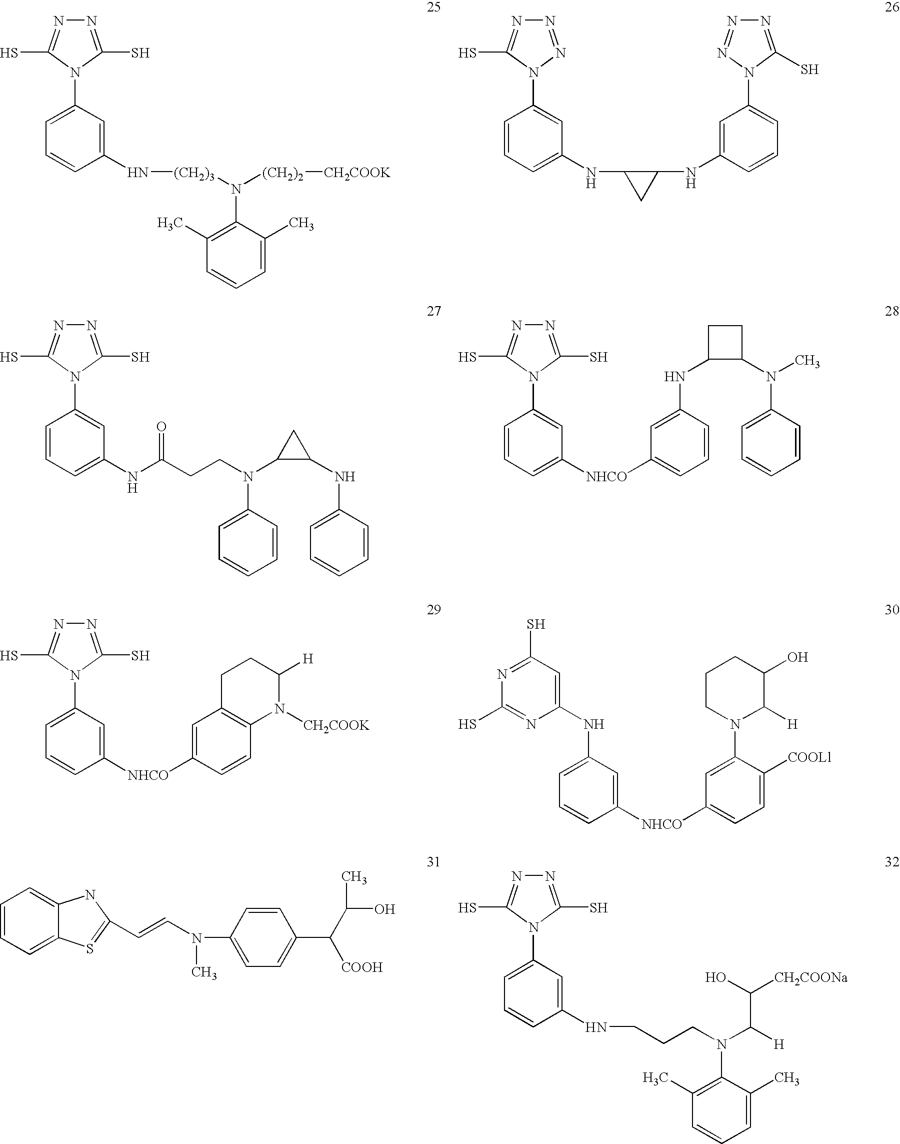

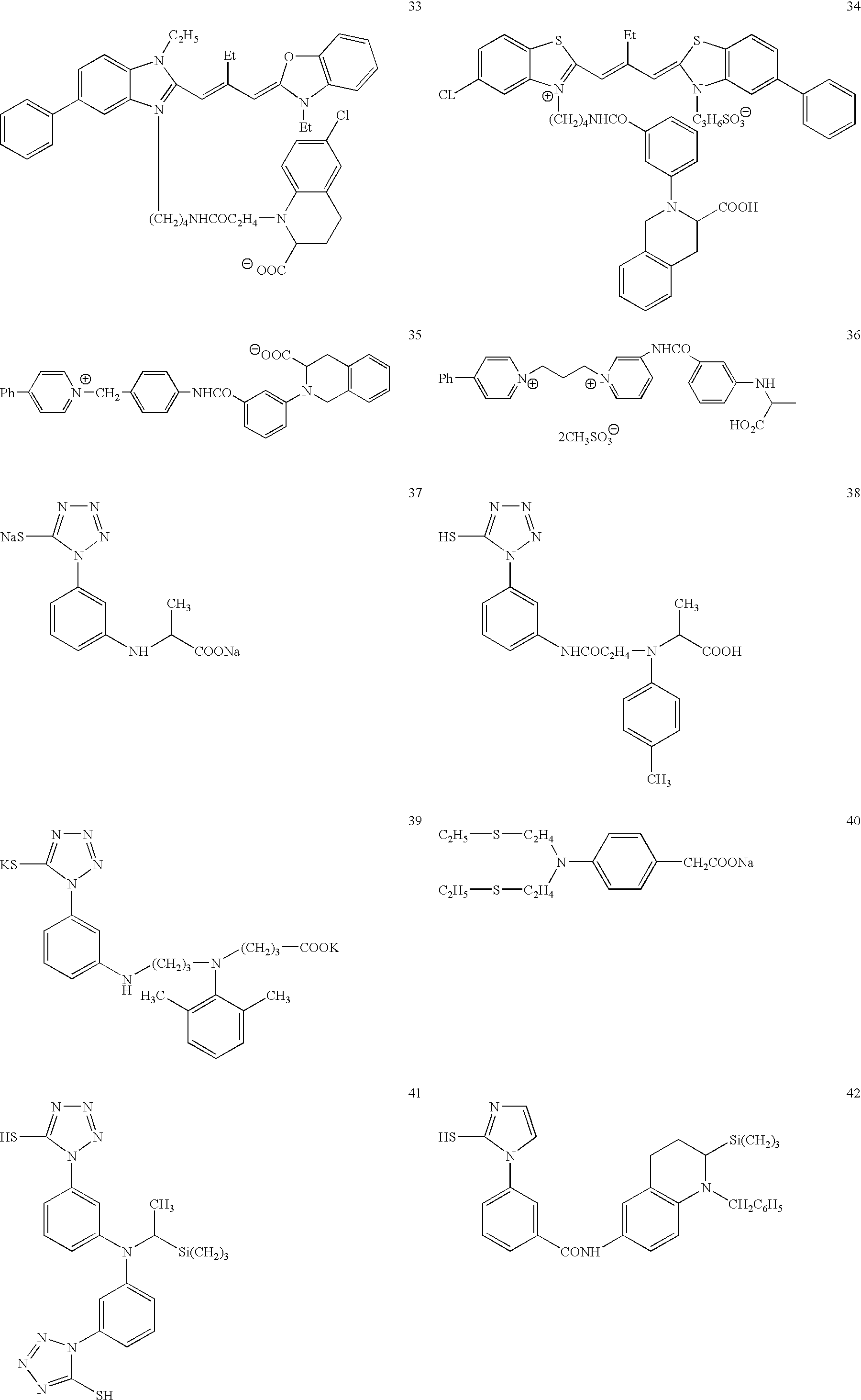

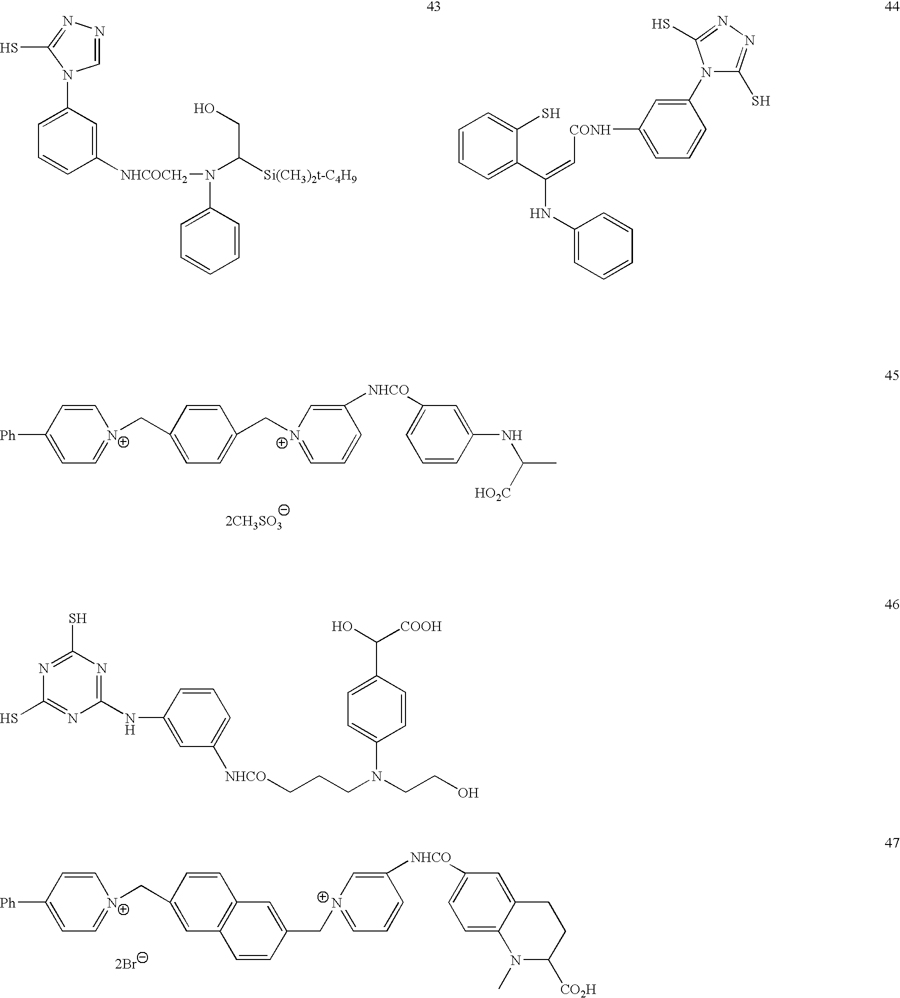

The compounds of Groups 1 and 2 may be used at any time during preparation of the photosensitive silver halide emulsion and production of the photothermographic material. For example, the compound may be used in a photosensitive silver halide grain formation step, in a desalting step, in a chemical sensitization step, and before coating, etc. The compound may be added in several times, during these steps. The compound is preferably added, after the photosensitive silver halide grain formation step and before the desalting step; in the chemical sensitization step (just before the chemical sensitization to immediately after the chemical sensitization); or more preferweably, before chemical sensitization step or coating. The compound is more preferably added, just before the chemical sensitization step to before mixing with the non-photosensitive organic silver salt.

It is preferred that the compounds of Groups 1 and 2 used in the invention is dissolved in water, a water-soluble solvent such as methanol and ethanol, or a mixed solvent thereof, to be added. In the case where the compound is dissolved in water and solubility of the compound is increased by increasing or decreasing a pH value of the solvent, the pH value may be increased or decreased to dissolve and add the compound.

The compounds of Groups 1 and 2 used in the invention is preferably used to the emulsion layer (the image forming layer). The compound may be added to a surface protective layer or an intermediate layer as well as the image forming layer, to be diffused to the image forming layer in the coating step. The compound may be added before or after addition of a sensitizing dye. Each compound is contained in the silver halide eulsion layer (the image forming layer) preferably in an amount of 1×10⁻⁹ mol to 5×10⁻¹ mol, more preferably 1×10⁻⁸ mol to 5×10⁻³ mol per 1 mol of silver halide.

10) Compound Having Adsorptive Group and Reducible Group

The photothermographic material of the invention preferably comprises a compound having an adsorptive group and a reducible group in a molecule. It is preferred that the compound having an adsorptive group and a reducible group used in the invention is represented by the following formula (I).
A-(W)ₙ—B Formula (1)

In Formula (I), A represents a group capable of adsorbing to a silver halide (hereafter, it is called an adsorptive group), W represents a divalent linking group, n represents 0 or 1, and B represents a reducible group.

In Formula (I), the adsorptive group represented by A is a group to adsorb directly to a silver halide or a group to promote adsorption to a silver halide. As typical examples, a mercapto group (or a salt thereof), a thione group (—C(═S)—), a nitrogen atom, a heterocyclic group containing at least one atom selected from a nitrogen atom, a sulfur atom, a selenium atom and a tellurium atom, a sulfide group, a disulfide group, a cationic group, an ethynyl group and the like are described.

The mercapto group as an adsorptive group means a mercapto group (and a salt thereof) itself and simultaneously more preferably represents a heterocyclic group or an aryl group or an alkyl group substituted by at least one mercapto group (or a salt thereof). Herein, as the heterocyclic group, a monocyclic or a condensed aromatic or nonaromatic heterocyclic group having at least a 5 to 7 membered ring, e.g., an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group and the like are described. A heterocyclic group having a quaternary nitrogen atom may also be adopted, wherein a mercapto group as a substituent may dissociate to form a mesoion. As a counter ion, whereby a mercapto group forms a salt thereof, a cation such as an alkali metal, an alkali earth metal, a heavy metal and the like (Li⁺, Na⁺, K⁺, Mg²⁺, Ag⁺, Zn²⁺ and the like), an ammonium ion, a heterocyclic group comprising a quaternary nitrogen atom, a phosphonium ion and the like are described.

Further, the mercapto group as an adsorptive group may become a thione group by a tautomerization.

The thione group as an adsorptive group may also contain a chain or a cyclic thioamide group, a thioureido group, a thiouretane group or a dithiocarbamic acid ester group.

The heterocyclic group containing at least one atom selected from a nitrogen atom, a sulfur atom, a selenium atom and a tellurium atom represents a nitrogen atom containing heterocyclic group having —NH— group, as a partial structure of heterocycle, capable to form a silver iminate (>NAg) or a heterocyclic group, having —S— group, —Se— group, —Te— group or ═N— group as a partial structure of heterocycle, and capable to coordinate to a silver ion by a chelate bonding. As the former examples, a benzotriazole group, a triazole group, an indazole group, a pyrazole group, a tetrazole group, a benzimidazole group, a purine group and the like are described. As the latter examples, a thiophene group, a thiazole group, a benzoxazole group, a thiadiazole group, an oxadiazole group, a triazine group, a selenoazole group, a benzoselenazole group, a tellurazole group, a benzotellurazole group and the like are described.

The sulfide group or disulfide group as an adsorptive group contains all groups having “—S—” or “—S—S—” as a partial structure.

The cationic group as an adsorptive group means the group containing a quaternary nitrogen atom, such as an ammonio group or a nitrogen containing heterocyclic group containing a quaternary nitrogen atom. As examples of the heterocyclic group containing a quaternary nitrogen atom, a pyridinio group, a quinolinio group, an isoquinolinio group, an imidazolio group and the like are described.

The ethynyl group as an adsorptive group means —C≡CH group and the said hydrogen atom may be substituted.

The adsorptive group described above may have any substituent.

Further, as typical examples of an adsorptive group, the compounds described in pages 4 to 7 in the specification of JP-A No. 11-95355 are described.

As an adsorptive group represented by A in formula (I), a heterocyclic group substituted by a mercapto group (e.g., a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazorium-3-thiolate group, a 2,4-dimercaptopyrimidine group, a 2,4-dimercaptotriazine group, a 3,5-dimercapto-1,2,4-triazole group, a 2,5-dimercapto-1,3-thiazole group and the like) or a nitrogen atom containing heterocyclic group having a —NH— group capable to form an imino-silver (>NAg) as a partial structure of heterocycle (e.g., a benzotriazole group, a benzimidazole group, an indazole group and the like) is preferable, and more preferable as an adsorptive group is a 2-mercaptobenzimidazole group or a 3,5-dimercapto-1,2,4-azole group.

In Formula (I), W represents a divalent linking group. The said linking group may be any divalent linking group, as far as it does not give a bad effect toward a photographic property. For example, a divalent linking group, which includes a carbon atom, a hydrogen atom, an oxygen atom a nitrogen atom and a sulfur atom, can be used. As typical examples, an alkylene group having 1 to 20 carbon atoms (e.g., a methylene group, an ethylene group, a trimethylene group, a tetramethylene group, a hexamethylene group and the like), an alkenylene group having 2 to 20 carbon atoms, an alkinylene group having 2 to 20 carbon atoms, an arylene group having 6 to 20 carbon atoms (e.g., a phenylene group, a nephthylene group and the like), —CO—, —SO₂—, —O—, —S—, —NR₁—, and the combination of these linking groups are described. Herein, R₁ represents a hydrogen atom, an alkyl group, a heterocyclic group, or an aryl group.

The divalent linking group represented by W may have any substituent.

In Formula (I), a reducible group represented by B represents the group capable to reduce a silver ion. As the examples, a formyl group, an amino group, a triple bonding group such as an acetylene group, a propargyl group and the like, a mercapto group, hydroxylamines, hydroxamic acids, hydroxyureas, hydroxyurethanes, hydroxysemicarbazides, reductones (reductone derivatives are contained), anilines, phenols (chroman-6-ols, 2,3-dihydrobenzofuran-5-ols, aminophenols, sulfonamidophenols and polyphenols such as hydroquinones, catechols, resorcinols, benzenetriols, bisphenols are contained), aclhydrazines, carbamoylhydrazides and a residue which is obtained by removing one hydrogen atom from 3-pyrazolidones and the like can be described. They may have any substituent.

The oxidation potential of a reducible group represented by B in Formula (I), can be measured by using the measuring method described in Akira Fujishima, “DENKIKAGAKU SOKUTEIHO”, pages 150 to 208, GIHODO SHUPPAN and NIHON KAGAKUKAI, “ZIKKEN KAGAKUKOUZA”, 4th ed., vol. 9, pages 282 to 344, MARUZEN. For example, the method of rotating disc voltammetry can be used; namely the sample is dissolved in the solution (methanol: pH 6.5 Britton-Robinson buffer=10%:90% (% by volume)) and after bubbling with nitrogen gas during 10 minutes the voltamograph can be measured under the condition of 1000 rotations/minute, the sweep rate 20 mV/second, at 25° C. by using a rotating disc electrode (RDE) made by glassy carbon as a working electrode, a platinum electrode as a counter electrode and a saturated calomel electrode as a reference electrode. The half wave potential (E1/2) can be calculated by that obtained voltamograph.

When a reducible group represented by B in the invention is measured by the method described above, an oxidation potential preferably is in the range of about −0.3 V to about 1.0 V, more preferably about −0.1 V to about 0.8 V, and most preferably about 0 V to about 0.7 V.

In Formula (I), a reducible group represented by B preferably is hydroxylamines, hydroxamic acids, hydroxyureas, hydroxysemicarbazides, reductones, phenols, acylhydrazines, carbamoylhydrazides, or a residue which is obtained by removing one hydrogen atom from 3-pyrazolidones and the like.

The compound of Formula (I) in the invention may have the ballasted group or polymer chain in it generally used in the nonmoving photographic additives as a coupler. And as a polymer, for example, the polymer described in JP-A No. 1-100530 can be described.

The compound of Formula (I) in the invention may be bis type or tris type. The molecular weight of the compound represented by Formula (I) in the invention is preferably 100 to 10,000 and more preferably 120 to 1,000 and particularly preferably 150 to 500.

The examples of the compound represented by Formula (1) in the invention are shown below, but the invention is not limited by these.

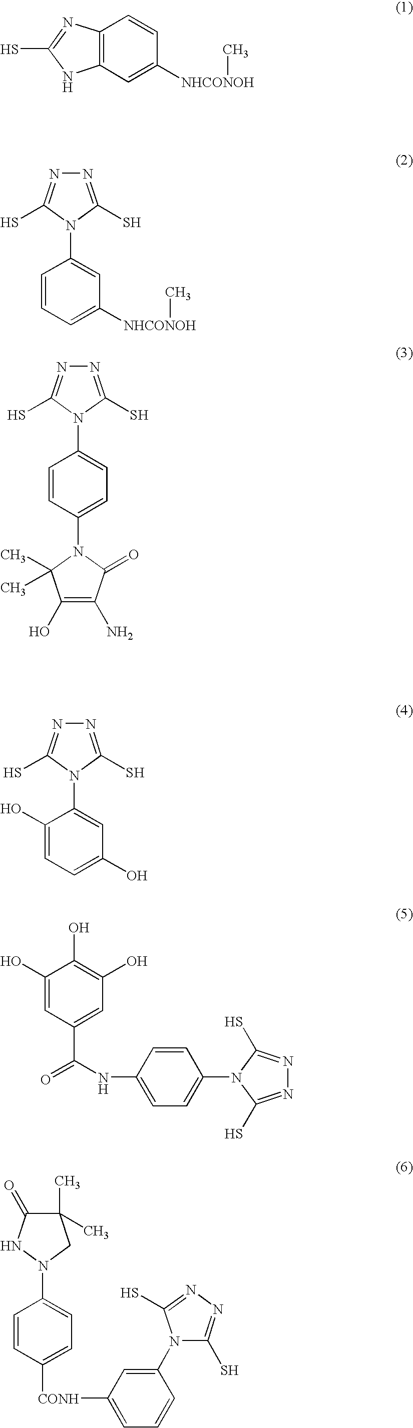

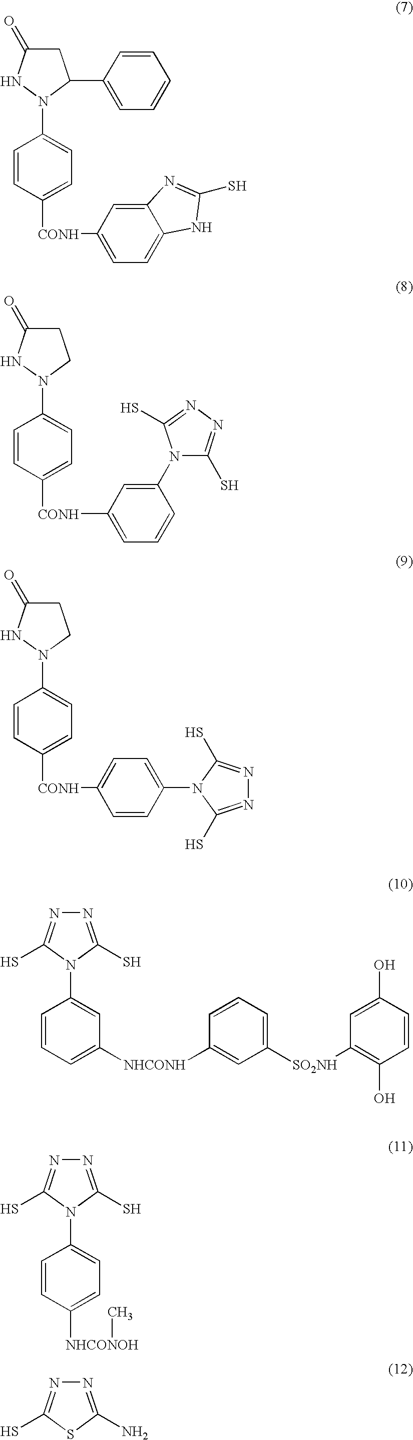

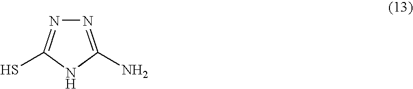

Further, example compounds 1 to 30 and 1″-1 to 1″-77 shown in EP No. 1308776A2, pages 73 to 87 are also described as preferable examples of the compound having an adsorptive group and a reducible group according to the invention.

These compounds can be easily synthesized by the known method. The compound of Formula (I) in the invention can be used alone as only one kind of the compound, but it is preferred to use two or more kinds of the compounds at the same time. When two or more kinds of the compounds are used in combination, those may be added to the same layer or the different layers, whereby adding methods may be different from each other.

The compound represented by Formula (I) in the invention preferably is added to an image forming layer and more preferably is to be added at an emulsion preparing process. In the case, wherein these compounds are added at an emulsion preparing process, these compounds may be added at any step in the process. For example, the silver halide grain formation step, a step before starting of desalting step, the desalting step, the step before chemical ripening, the chemical ripening step, the step before preparing a final emulsion and the like are described. Also, the addition can be performed in the plural divided times during the process. It is preferred to be added in the image forming layer, but also to be diffused at a coating step from a protective layer or an intermediate layer adjacent to the image forming layer, wherein these compounds are added in the protective layer or the intermediate layer in combination with their addition to the image forming layer.

The preferable addition amount is largely depend on the adding method described above or the kind of the compound, but is generally in the range of 1×10⁻⁴ mol to 1 mol preferably 1×10⁻⁵ mol to 5×10⁻¹ mol and more preferably 1×10⁻⁴ mol to 1×10⁻¹ mol, per 1 mol of photosensitive silver halide.

The compound represented by Formula (I) in the invention can be added by dissolving in water or water-soluble solvent such as methanol ethanol and the like or a mixed solution thereof. At this time, pH may be arranged suitably by an acid or an alkaline and a surfactant can be coexisted. Further, these compounds may be added as an emulsified dispersion by dissolving them in an organic solvent having a high boiling point and also may be added as a solid dispersion.

11) Combined Use of a Plurality of Silver Halides

The photosensitive silver halide emulsion in the photothermographic material used in the invention may be used alone as one kind, or two or more kinds of them (for example, those of different average grain sizes, different halogen compositions, of different crystal habits and of different conditions for chemical sensitization) may be used together. Gradation can be controlled by using plural kinds of photosensitive silver halide of different sensitivity. The relevant techniques can include those described, for example, in JP-A Nos. 57-119341, 53-106125, 47-3929, 48-55730, 46-5187, 50-73627, and 57-150841. It is preferred to provide a sensitivity difference of 0.2 or more in terms of log E between each of the emulsions.

12) Coating Amount

The addition amount of the photosensitive silver halide, when expressed by the amount of coated silver per 1 m² of the photothermographic material, is preferably from 0.03 g/m² to 0.6 g/m², more preferably, from 0.05 g/m² to 0.4 g/m² and, further preferably, from 0.07 g/m² to 0.3 g/m². The photosensitive silver halide is used in the range from 0.01 mol to 0.5 mol, preferably, from 0.02 mol to 0.3 mol, and further preferably from 0.03 mol to 0.2 mol, per 1 mol of the organic silver salt.

13) Mixing Silver Halide and Organic Silver Salt

The method of mixing the silver halide and the organic silver salt can include a method of mixing a separately prepared photosensitive silver halide and an organic silver salt by a high speed stirrer, ball mil, sand mill, colloid mill, vibration mill, or homogenizer, or a method of mixing a photosensitive silver halide completed for preparation at any timing in the preparation of an organic silver salt and preparing the organic silver salt. The effect of the invention can be obtained preferably by any of the methods described above. Further, a method of mixing two or more kinds of aqueous dispersions of organic silver salts and two or more kinds of aqueous dispersions of photosensitive silver salts upon mixing is used preferably for controlling the photographic properties.

14) Mixing Silver Halide into Coating Liquid

In the invention, the time of adding silver halide to the coating liquid for the image forming layer is preferably in the range from 180 minutes before to just prior to the coating, more preferably, 60 minutes before to 10 seconds before coating. But there is no restriction for mixing method and mixing condition as far as the effect of the invention appears sufficient. As an embodiment of a mixing method, there is a method of mixing in the tank controlling the average residence time to be desired. The average residence time herein is calculated from addition flux and the amount of solution transferred to the coater. And another embodiment of mixing method is a method using a static mixer, which is described in 8th edition of “Ekitai kongou gijutu” by N. Harnby and M. F Edwards, translated by Kouji Takahashi (Nikkankougyou shinbunsya, 1989).

Nucleating Agent

In the following, a nucleating agent which is used in the invention will be explained.

The nucleating agent in the invention refers to a compound to produce a compound which, as a result of initial development, reacts with a development product to newly induce development in the reaction. It was conventionally known that a nucleating agent is used in a super-hard tone photosensitive material suited for a printing and plating. The super-hard tone photosensitive material has an average gradient of 10 or more, and is not suitable for a photosensitive material used for general photography, in particular for a medical use. The super-hard tone photosensitive material has coarse graininess and insufficient sharpness, and thus it was not suitable at all for medical diagnosis, which requires high diagnosis ability. The nucleating agent in the invention has completely different effects from those of a conventional super-hard tone photosensitive material. The nucleating agent in the invention does not make contrast gradients hard. The nucleating agent in the invention is a compound which can cause development sufficiently even with the extremely smaller number of the photosensitive silver halide, as compared with the non-photosensitive organic silver salt. The mechanism thereof is not clear, however, when development is performed using the nucleating agent in the invention, the number of development silver particles is greater than that of the photosensitive silver halide particles in the maximum density parts. Accordingly, it is presumed that the nucleating agent in the invention has function to form a new development point (a development nucleus) at the positions where silver halide particles do not exist.

Preferable examples of the nucleating agent include a hydrazine compound represented by the following Formula [H], a vinyl compound represented by the following Formula (G), a quaternary onium compound represented by the following Formula (P), and a cyclic olefin compound represented by any of the Formulas (A), (B), and (C).

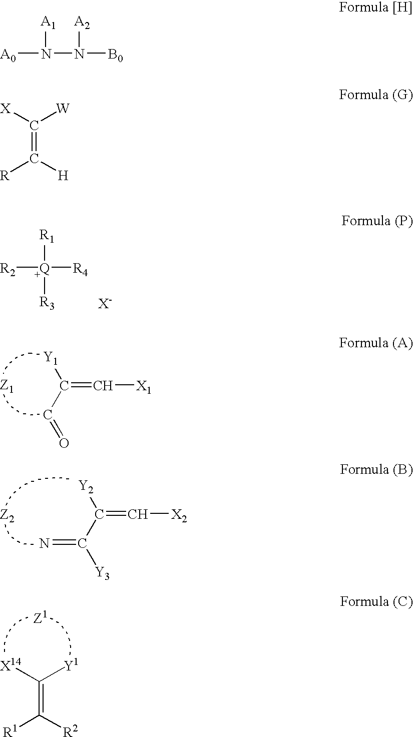

In Formula [H], A₀ represents an aliphatic group, an aromatic group, a heterocyclic group, or -G₀-D₀, each of which may have a substituent; B⁰ represents a blocking group; both of A¹ and A² represent hydrogen atoms, or one of them represents a hydrogen atom and the other represents an acyl group, a sulfonyl group, or an oxalyl group, where G₀ represents —CO—, —COCO—, —CS—, —C(═NG¹D¹)-, —SO—, —SO₂, or P(O)(G₁D₁)-, in which G¹ represents a single bond, —O—, —S—, or —N(D¹)-, in which D¹ represents an aliphatic group, an aromatic group, a heterocyclic group, or a hydrogen atom, provided that when a plurality of D₁s are present in the molecule, they may be the same or different, and D₀ represents a hydrogen atom, an aliphatic group, an aromatic group, a heterocyclic group, an amino group, an alkoxy group, an aryloxy group, an alkylthio group, or arylthio group. Examples of a preferable group as D₀⁰ include a hydrogen atom, an alkyl group, an alkoxy group, an amino group, or the like.

In Formula [H], the aliphatic group represented by A₀ preferably has 1 to 30 carbon atoms, and in particular preferably a straight-chain, branched, or cyclic alkyl group having 1 to 20 carbon atoms. Examples thereof may include a methyl group, an ethyl group, a t-butyl group, an octyl group, a cyclohexyl group, and a benzyl group, each of which may further be substituted by a proper substituent (such as an aryl group, an alkoxy group, an aryloxy group, an alkylthio group, an arylthio, a sulfoxy group, a sulfonamido group, a sulfamoyl group, an acylamino group, or a ureido group).

In Formula [H], the aromatic group represented by A₀ is preferably a monocyclic or condensed-ring aryl group, such as a benzene ring or a naphthalene ring. The heterocyclic group represented by A₀ is preferably a heterocyclic group which is the monocyclic or condensed-ring one, and contains at least one hetero atom selected from nitrogen, sulfur, and oxygen atoms. Examples thereof may include a pyrrolidine ring, an imidazole ring, a tetrahydrofuran ring, a morpholine ring, a pyridine ring, a pyrimidine ring, a quinoline ring, a thiazole ring, a benzothiazole ring, a thiophene ring, and a furan ring. The aromatic group, the heterocyclic group, or the -G₀-D₀ group of A₀ may have a substituent. A₀ is in particular preferably an aryl group or a -G₀-D₀ group.

In formula [H], A₀ preferably contains at least one anti-diffusion group or silver halide adsorbing group. The anti-diffusion group is preferably a ballast group which is commonly used in an immobile photographic additive such as a coupler. Examples of the ballast group may include a photographically inactive alkyl group, alkenyl group, alkynyl group, alkoxy group, phenyl group, phenoxy group, and alkylphenoxy group, and the total number of carbon atoms of the substituent moiety is preferably 8 or more.

In Formula [H], as the silver halide adsorption promoting group, mention may be made of thiourea, a thiourethane group, a mercapto group, a thioether group, a thione group, a heterocyclic group, a thioamido heterocyclic group, a mercapto-heterocyclic group, a adsorbing group described in JP-A No. 64-90439, or the like.

In Formula [H], B₀ represents a blocking group, and preferably -G₀-D₀, where G₀ represents —CO—, —COCO—, —CS—, —C(═NG¹D¹)-, —SO—, —SO₂—, or —P(O)(G₁D₁)-. As a preferred G₀ mention may be made of —CO— or —COCO—, where G₁ represents a single bond, —O—, —S—, or —N(D₁)-, in which D₁ represents an aliphatic group, an aromatic group, a heterocyclic group, or a hydrogen atom, provided that when a plurality of D₁s are present in the molecule, they may be the same or different. D₀ represents a hydrogen atom, an aliphatic group, an aromatic group, a heterocyclic group, an amino group, an alkoxy group, an aryloxy group, an alkylthio group, or an arylthio group. As preferred D⁰, mention may be made of a hydrogen atom, an alkyl group, an alkoxy group, an amino group, or the like. Herein, when A₀ is a heterocyclic group, B₀ will not be —CONHR— (carbamoyl group), —SO₂NHR— (sulfamoyl group), or —SOR— (sulfonyl group) (where R represents an aliphatic group, an aromatic group, or a heterocyclic group).

Both of A₁ and A₂ represent hydrogen atoms, or one of them is a hydrogen atom and the other represents an acyl group, (acetyl group, trifluoroacetyl group, benzoyl group, or the like), a sulfonyl group (methanesulfonyl group, toluenesulfonyl group, or the like), or an oxalyl group (ethoxalyl group).

Specific examples of a compound represented by Formula [H] include compounds H-1 to H-35 of [kagaku 12] to [kagaku 18] and compounds H-1-1 to H-4-5 of [kagaku 20] to [kagaku 26] in JP-A-2002-131864, but not limited thereto.

The compounds represented by Formulae (H-1) to (H-4) of the invention can be readily synthesized in accordance with known methods. The compounds can be synthesized by reference to, for example, U.S. Pat. Nos. 5,464,738 and 5,496,695.

Other than these, preferably usable hydrazine derivatives are the compounds H-1 to H-29 described in U.S. Pat. No. 5,545,505, col. 11 to 20; and the compounds 1 to 12 described in U.S. Pat. No. 5,464,738, col. 9 to 11. These hydrazine derivatives can be synthesized with known methods.

In Formula (G), X and R are expressed in the cis form. However, the case where X and R are expressed in the trans form is also included in Formula (G). The same also applies to the expression of the structure of a specific compound.

In Formula (G), X represents an electron attracting group, and W represents a hydrogen atom, an alkyl group, an alkenyl group, an alkynyl group, an aryl group, a heterocyclic group, a halogen atom, an acyl group, a thioacyl group, an oxalyl group, an oxyoxalyl group, a thiooxalyl group, an oxamoyl group, an oxycarbonyl group, a thiocarbonyl group, a carbamoyl group, a thiocarbamoyl group, a sulfonyl group, a sulfinyl group, an oxysulfinyl group, a thiosulfinyl group, a sulfamoyl group, an oxysulfinyl, a thiosulfinyl group, a sulfinamoyl group, a phosphoryl group, a nitro group, an imino group, an N-carbonyliminio group, an N-sulfinylimino group, a dicyanoethylene group, an ammonium group, a sulfonium group, a phosphonium group, a pyrylium group, or an immonium group.

R represents a halogen atom, a hydroxyl group, an alkoxy group, an aryloxy group, a heterocyclic oxy group, an alkenyloxy group, an acyloxy group, an alkoxycarbonyloxy group, an aminocarbonyloxy group, a mercapto group, an alkylthio group, an arylthio group, a heterocyclic thio group, an alkenylthio group, an acylthio group, an alkoxycarbonylthio group, an aminocarbonylthio group, an organic or inorganic salt (e.g., a sodium salt, a potassium salt, or a silver salt) of a hydroxyl group or a mercapto group, an amino group, an alkylamino group, a cyclic amino group (e.g., a pyrrolidino group), an acylamino group, an oxycarbonylamino group, a heterocyclic group (a 5- or 6-membered nitrogen-containing heterocyclic group such as a benzotriazolyl group, an imidazolyl group, a triazolyl group, or a tetrazolyl group), a ureido group, or a sulfonamido group. X and W, and X and R may respectively bond with each other to form a ring. Examples of the rings formed by X and W may include pyrazolone, pyrazolidinone, cyclopentanedione, β-ketolactone, and β-ketolactam.

The electron attracting group represented by X is a substituent in which the substituent constant op can take on a positive value. Specific examples thereof may include: substituted alkyl groups (such as halogen substituted alkyl), substituted alkenyl groups (such as cyanovinyl), substituted and unsubstituted alkynyl groups (such as tifluoromethylacetylenyl and cyanoacetylenyl), substituted aryl groups (such as cyanophenyl), substituted and unsubstituted heterocyclic groups (such as pyridyl, triazinyl, and benzoxazolyl), halogen atoms, cyano groups, acyl groups (such as acetyl, trifluoroacetyl, and formyl), thioacetyl groups (such as thioacetyl and thioformyl), oxalyl groups (such as methyloxalyl), oxyoxalyl groups (such as ethoxalyl), thiooxalyl groups (such as ethylthiooxalyl), oxamoyl groups (such as methyloxamoyl), oxycarbonyl groups (such as ethoxycarbonyl), carboxyl groups, thiocarbonyl groups (such as ethylthiocarbonyl), carbamoyl groups, thiocarbamoyl groups, sulfonyl groups, sulfinyl groups, oxysulfonyl groups (such as ethoxysulfonyl), thiosulfonyl groups (such as ethylthiosulfonyl), sulfamoyl groups, oxysulfinyl groups (such as methoxysulfinyl), thiosulfinyl groups (such as methylthiosulfinyl), sulfinamoyl groups, phosphoryl groups, nitro groups, imino groups, N-carbonylimino groups (such as N-acetylimino), N-sulfonylimino groups (such as N-methanesulfonylimino), dicyanoethylene groups, ammonium groups, sulfonium groups, phosphonium groups, pyrylium groups, and immonium groups. The heterocyclic ones whose rings are formed by an ammonium group, an sulfonium group, a phosphonium group, an immonium group, and the like are also included. Substituents having a σₚ value of 0.30 or more is in particular preferred.

Examples of the groups represented by W may include: for the alkyl groups, methyl, ethyl, and trifluoromethyl; for the alkenyl groups, vinyl, halogen substituted vinyl, and cyanovinyl; for the alkynyl groups, acetylenyl and cyanoacetylenyl; for the aryl groups, nitrophenyl, cyanophenyl, and pentafluorophenyl; and for the heterocyclic groups, pyridyl, pyrimidyl, triazinyl, succinimido, tetrazolyl, triazolyl, imidazolyl, and benzoxazolyl. W is preferably an electron attracting group having a positive σₚ value, and further preferably an electron attracting group having a positive σₚ value of 0.30 or more.

Among the above-described substituents of R, mention may preferably be made of a hydroxyl group, a mercapto group, an alkoxy group, an alkylthio group, a halogen atom, an organic or inorganic salt of a hydroxyl group or a mercapto group, and a heterocyclic group; mention may more preferably be made of a hydroxyl group, an alkoxy group, an organic or inorganic salt of a hydroxyl group or a mercapto group, and a heterocyclic group; and mention may in particular preferably made of a hydroxyl group, an organic or inorganic salt of a hydroxyl group or a mercapto group.

Further, among the above-described substituents of X and W, the ones each having a thioether bond in the substituent are preferred.

Specific examples of a compound represented by Formula (G) include 1-1 to 92-7 of chemical formulas 27 to 50 in JP-A 2002-131864, but not limited thereto.

In Formula (P), Q represents a nitrogen atom or a phosphorus atom, R₁, R₂, R₃, and R₄ each independently represent a hydrogen atom or a substituent, and X⁻ represents an anion. Incidentally, R₁ to R₄ may bond with each other to form a ring.

As the substituents represented by R₁ to R₄, mention may be made of an alkyl group (such as a methyl group, an ethyl group, a propyl group, a butyl group, a hexyl group, or a cyclohexyl group), an alkenyl group (such as an allyl group or a butenyl group), an alkyl group (such as a propargyl group or a butynyl group), an aryl group (such as a phenyl group or a naphthyl group), a heterocyclic groups (such as a piperidinyl group, a piperazinyl group, a morpholinyl group, a pyridyl group, a furyl group, a thienyl group, a tetrahydrofuryl group, a tetrahydrothienyl group, or a sulfolanyl group), an amino group, and the like.

As the rings which may be formed by mutual combination of R₁ to R₄, mention may be made of a piperidine ring, a morpholine ring, a piperazine ring, a quinuclidine ring, a pyridine ring, a pyrrole ring, an imidazole ring, a triazole ring, and a tetrazole ring.

The groups represented by R₁ to R₄ may have substituents such as a hydroxyl group, an alkoxy group, an aryloxy group, a carboxyl group, a sulfo group, an alkyl group, and an aryl group. R¹, R², R³, and R⁴ are each independently preferably a hydrogen atom or an alkyl group.

As anions represented by X⁻, mention may be made of inorganic and organic anions such as a halogen ion, a sulfate ion, a nitrate ion, an acetate ion, and a p-toluenesulfonate ion.

The structures of formula (P) are more preferably the structures described in the paragraphs [0153] to [0163] of JP-A 2002-131864.

Specific examples of a compound represented by Formula (P) include P-1 to P-52, and T-1 to T-18 of chemical formulas 53 to 62 in JP-A 2002-131864, but not limited thereto.

The above-described quaternary onium compounds can be synthesized by reference to known methods. For example, for the above-described tetrazolium compound, the method described in CHEMICAL REVIEWS, vol. 55, p. 335 to 483 can serve as a reference.

In the following, the compound represented by Formulae (A) and (B) will be explained in detail. In the Formula (A), Z- represents a non-metal atomic group capable of forming a 5- to 7-membered ring structure together with —Y₁—C(═CH—X₁)—C(═O)—. Z₁ is preferably an atomic group selected from a carbon atom, an oxygen atom, a sulfur atom, a nitrogen atom and a hydrogen atom, in which the atoms of the number selected from these are mutually single- or double-bonded to form a 5- to 7-membered ring structure together with —Y₁—C(═CH—X₁)—C(═O)—. Z₁ may comprise a substituent and Z₁ itself may be a part of an aromatic or nonaromatic carbocyclic ring or an aromatic or non-aromatic heterocycle. In this case, the 5- to 7-membered ring structure which Z₁ forms together with —Y₁—C(═CH—X₁)—C(═O)—, will form a condensed ring structure.

In the Formula (B), Z₂ represents a non-metal atomic group capable of forming a 5- to 7-membered ring structure together with —Y₂—C(═CH—X₂)—C(Y₃)═N—. Z₂ is preferably an atomic group selected from a carbon atom, an oxygen atom, a sulfur atom, a nitrogen atom and a hydrogen atom, in which the atoms of the number selected from these are mutually single- or double-bonded to form a 5- to 7-membered ring structure with —Y₂—C(═CH—X₂)—C(Y₃)═N—. Z₂ may comprise a substituent and Z₂ itself may be a part of an aromatic or nonaromatic carbocyclic ring or an aromatic or nonaromatic heterocycle. In this case, the 5- to 7-membered ring structure which Z₂ forms together with —Y₂—C(═CH—X₂)—C(Y₃)═N—, will form a condensed ring structure.

When Z₁ and Z₂ have a substituent, examples of the substituent can be selected from the followings. Namely, as a representative substituent, there can be mentioned a halogen atom (a fluorine atom, a chlorine atom, a bromine atom and an iodine atom), an alkyl group (including an aralkyl group, a cycloalkyl group and an active methine group), an alkenyl group, an arginyl group, an aryl group, a heterocyclic group, a heterocyclic group containing a quaternary nitrogen atom (e.g., a pyridinio group), an acyl group, an alkoxycarbonyl group, an aryloxycarbonyl group, a carbamoyl group, a carboxyl group or a salt thereof, a sulfonylcarbamoyl group, an acylcarbamoyl group, a sulfamoylcarbamoyl group, a carbazoyl group, an oxalyl group, an oxamoyl group, a cyano group, a thiocarbamoyl group, a hydroxyl group, an alkoxy group (including a group containing the repeating ethyleneoxy units or repeating propyleneoxy units), an aryloxy group, a heterocyclic oxy group, an acyloxy group, an (alkoxy or aryloxy)carbonyloxy group, a carbamoyloxy group, a sulfonyloxy group, an amino group, an (alkyl, aryl, or heterocyclic)amino group, an N-substituted nitrogen-containing heterocyclic group, an acylamino group, a sulfonamido group, a ureido group, a thioureido group, an imido group, an (alkoxy or aryloxy)carbonylamino group, a sulfamoylamino group, a semicarbazido group, a thiosemicarbazido group, a hydrazino group, a quaternary ammonio group, an oxamoylamino group, an (alkyl or aryl)sulfonylureido group, an acylureido group, an acylsulfamoylamino group, a nitro group, a mercapto group, an (alkyl, aryl or heterocyclic)thio group, an (alkyl or aryl)sulfonyl group, an (alkyl or aryl)sulfinyl group, a sulfo group or a salt thereof, a sulfamoyl group, an acylsulfamoyl group, a sulfonylsulfamoyl group or a salt thereof, a group including a phosphoric acid amide or a phosphoric acid ester structure, a silyl group, and a stannyl group. Such substituent may be further substituted by (a) substituent(s) selected from these substituents.

In the following, Y₃ will be explained. In the formula (B), Y₃ represents a hydrogen atom or a substituent, but when Y₃ represents a substituent, the substituent specifically includes the following groups. In other words, it includes an alkyl group, an aryl group, a heterocyclic group, a cyano group, an acyl group, an alkoxycarbonyl group, and aryloxycarbonyl group, a carbamoyl group, an amino group, an (alkyl, aryl or heterocyclic) amino group, an acylamino group, a sulfonamido group, a ureido group, a thioureido group, an imido group, an alkoxy group, an aryloxy group and an (alkyl, aryl or heterocyclic)thio group. Such substituent may be further substituted by (a) substituent(s) selected from these substituents, and specifically it includes the substituents which Z₁ or Z₂ may have.

In the Formulae (A) and (B), X₁ and X₂ each represents a hydroxyl group (or a salt thereof), an alkoxy group (e.g., a methoxy group, an ethoxy group, a propoxy group, an isopropoxy group, an octyloxy group, a dodecyloxy group, a cetyloxy group and a t-butoxy group), an aryloxy group (e.g., a phenoxy group, a p-t-pentylphenoxy group and a p-t-octylphenoxy group), a heterocyclic oxy group (e.g., a benzotriazole-5-oxy group and a pyridinyl-3-oxy group), a mercapto group (or a salt thereof), an alkylthio group (e.g., a methylthio group, an ethylthio group, a butylthio group and a dodecylthio group), an arylthio group (e.g., a phenylthio group and a p-dodecylphenylthio group), a heterocyclic thio group (e.g., 1-phenyltetrazoyl-5-thio group, 2-methyl-1-phenyltriazolyl-5-thio group and a mercaptothiadiazolylthio group), an amino group, an alkylamino group (e.g., a methylamino group, a propylamino group, an octylamino group and a dimethylamino group), an arylamino group (e.g., an anilino group, a naphthylamino group and o-methoxyanilino group), a heterocyclic amino group (e.g., a pyridylamino group and a benzotriazol-5-ylamino group), an acylamino group (e.g., an acetamido group, an octanoylamino group and a benzoylamino group), a sulfonamido group (e.g., a methanesulfonamido group, a benzenesulfonamido group and a dodecylsulfonamido group) or a heterocyclic group.

The heterocyclic group as used herein is an aromatic or nonaromatic, saturated or unsaturated, single- or condensed-ring, and substituted or unsubstituted heterocyclic group, for example, an N-methylhidantoyl group, an N-phenylhidantoyl group, a succinimido group, a phthalimido group, an N,N′-dimethylurazolyol group, an imidazolyl group, a benzotriazolyl group, an indazolyl group, a morpholino group and a 4,4-dimethyl-2,5-dioxo-oxyazolyl group.

In addition, the salt as used herein represents a salt of alkali metals (sodium, potassium or lithium) or alkaline earth metals (magnesium or calcium), a silver salt, a quaternary ammonium salt (a tetraethyl ammonium salt or a dimethylcetylbenzyl ammonium salt) and a quaternary phosphonium salt. In Formulae (A) and (B), Y₁ and Y₂ represent —C(═O)— or —SO₂—.

A preferable range of the compounds represented by Formulae (A) and (B) is described in paragraphs [0027] to [0043] in JP-A-11-231459. Specific examples of the compounds of Formulae (A) and (B) include compounds 1 to 110 of Tables 1 to 8 in JP-A-11-231459, but not limited thereto.

In the following, the compounds represented by Formula (C) of the invention are explained in detail. In Formula (C), X₁ represents an oxygen atom, a sulfur atom and a nitrogen atom. When X₁ represents a nitrogen atom, a bond between X₁ and Z₁ may be a single- or double-bond, and when the bond is a single-bond, the nitrogen atom may have a hydrogen atom or any substituent. The substituent includes, for example, an alkyl group (including an aralkyl group, a cycloalkyl group and an active methine group), an alkenyl group, an alkynyl group, an aryl group, a heterocyclic group, an acyl group, an alkoxycarbonyl group, an aryloxycarbonyl group, a carbamoyl group and an (alkyl, aryl or heterocyclic) sulfonyl group. Y₁ represents a group represented by —C(═O)—, —C(═S)—, —SO—, —SO₂, —C(═NR₃)— or —(R₄)C═N—. Z₁ represents a non-metal atomic group which forms a 5- to 7-membered ring structure together with X₁ and Y₁. The atomic group which forms the ring is an atomic group having 2 or 4 atoms other than the metal atoms. The atoms may be single- or double-bonded and comprise a hydrogen atom or any substituent (e.g., an alkyl group, an aryl group, a heterocyclic group, an alkoxy group, an alkylthio group, an acyl group, an amino group and an alkenyl group). When Z₁ forms a 5- to 7-membered ring structure together with X₁ and Y₁, the ring may be a saturated or unsaturated heterocycle, and may have a single- or condensed-ring. In the condensed ring of this case, when Y₁ is a group represented by C(═NR₃) or (R₄)C═N, and R₃ or R₄ may be a group formed by bonding with the substituents of Z₁.

In Formula (C), R₁, R₂, R₃ and R₄ each independently represent a hydrogen atom or a substituent. But it is not necessary that R₁ and R₂ mutually bond to form a cyclic structure.

When each of R₁ and R₂ represents a monovalent substituent, the monovalent substituent includes the following groups.

The monovalent substituent includes, for example, a halogen atom (a fluorine atom, a chlorine atom, a bromine atom or an iodine atom), an alkyl group (including an aralkyl group, a cycloalkyl group and an active methine group), an alkenyl group, an alkyl group, an aryl group, a heterocyclic group, a heterocyclic group containing a quaternary nitrogen atom (e.g., a pyridinio group), an acyl group, an alkoxycarbonyl group, an aryloxycarbonyl group, a carbamoyl group, a carboxyl group or a salt thereof, a sulfonylcarbamoyl group, an acylcarbamoyl group, a sulfamoylcarbamoyl group, a carbazoyl group, an oxalyl group, an oxamoyl group, a cyano group, a thiocarbamoyl group, a hydroxyl group or a salt thereof, an alkoxy group (including a group containing repeating ethyleneoxy units or repeating propyleneoxy units), an aryloxy group, a heterocyclic oxy group, an acyloxy group, an (alkoxy or aryloxy)carbonyloxy group, a carbamoyloxy group, a sulfonyloxy group, an amino group, an (alkyl, aryl, or heterocyclic)amino group, an N-substituted nitrogen-containing heterocyclic group, an acylamino group, a sulfonamido group, a ureido group, a thioureido group, an imido group, an (alkoxy or aryloxy)carbonylamino group, a sulfamoylamino group, a semicarbazido group, a thiosemicarbazido group, a hydrazino group, a quaternary ammonio group, an oxamoylamino group, an (alkyl or aryl)sulfonylureido group, an acylureido group, an acylsulfamoylamino group, a nitro group, a mercapto group or a salt thereof, an (alkyl, aryl or heterocyclic)thio group, an (alkyl or aryl)sulfonyl group, an (alkyl or aryl)sulfinyl group, a sulfo group or a salt thereof, a sulfamoyl group, an acylsulfamoyl group, a sulfonylsulfamoyl group or a salt thereof, a group including a phosphoric acid amide or a phosphoric acid ester structure, a silyl group, and a stannyl group. Such substituent may be further substituted by (a) monovalent substituent(s).

In the following, when R₃ and R₄ represent a substituent, the substituent includes the same those as the substituents which R₁ and R₂ may have, except a halogen atom. R₃ and R₄ may be bonded and condensed with Z₁ to form a ring.

In the following, preferable compounds among the compounds represented by Formula (C) will be explained. In Formula (C), Z₁ preferably represents a non-metal atomic group which forms a 5- to 7-membered ring structure together with X₁ and Y₁, and comprises 2 to 4 atoms selected from a carbon atom, a nitrogen atom, a sulfur atom and an oxygen atom. The heterocycle which Z₁ forms together with X₁ and Y₁, has 3 to 40 carbon atoms, preferably 3 to 25 carbon atoms, and most preferably 3 to 20 carbon atoms, and preferably Z₁ has at least one carbon atom.

In Formula (C), Y₁ is preferably —C(═O)—, —C(═S)—, —SO₂— or —(R₄)C═N—, particularly preferably —C(═O)—, —C(═S)— or —SO₂—, and most preferably —C(═O)—.

In Formula (C), when R₁ and R₂ represent a monovalent substituent, the monovalent substituent represented by R₁ and R₂ preferably includes a group having 0 to at least 25 carbon atoms in total, in other words, an alkyl group, an aryl group, a heterocyclic group, an alkoxy group, an aryloxy group, a heterocyclic oxy group, an alkylthio group, an arylthio group, a heterocyclic thio group, an amino group, an alkylamino group, an arylamino group, a heterocyclic amino group, a ureido group, an imido group, an acylamino group, a hydroxyl group or a salt thereof, a mercapto group or a salt thereof, or an electron attracting group. The electron attracting group as used herein is a substituent having a positive (+) Hammett substituent constant σ, and specifically includes a cyano group, a sulfamoyl group, an alkylsulfonyl group, an aryl sulfonyl group, a sulfonamido group, an imino group, a nitro group, a halogen atom, an acyl group, a formyl group, a phosphoryl group, a carboxyl group (or a salt thereof), a sulfo group (a salt thereof), a saturated or unsaturated heterocyclic group, an alkenyl group, an alkynyl group, an acyloxy group, an acylthio group, a sulfonyl oxy group, and an aryl group substituted with an electron attracting group, each of which may have any substituent.

In Formula (C), when R₁ and R₂ represent a monovalent substituent, more preferably the substituent includes an alkoxy group, an aryloxy group, a heterocyclic oxy group, an alkylthio group, an arylthio group, a heterocyclic thio group, an amino group, an alkylamino group, an arylamino group, a heterocyclic amino group, an ureido group, an imido group, an acylamino group, a sulfonamido group, a heterocyclic group, a hydroxyl group or a salt thereof, a mercapto group or a salt thereof. In formula (C), particularly preferably R₁ and R₂ include a hydrogen atom, an alkoxy group, an aryloxy group, an alkylthio group, an arylthio group, a heterocyclic group, a hydroxyl group or a salt thereof and a mercapto group or a salt thereof. In formula (C), most preferably one of R₁ and R₂ is a hydrogen atom, and the other is an alkoxy group, an aryloxy group, an alkylthio group, an arylthio group, a heterocyclic group, a hydroxyl group or a salt thereof, and a mercapto group or a salt thereof.

In Formula (C), when R₃ represents a substituent, preferably the substituent includes an alkyl group having 1 to 25 carbon atoms (including an aralkyl group, a cycloalkyl group and an active methine group), an alkenyl group, an aryl group, a heterocyclic group, a heterocyclic group containing a quaternary nitrogen atom (e.g., a pyridinio group), an acyl group, an alkoxycarbonyl group, an aryloxycarbonyl group, a carbamoyl group, an (alkyl or aryl)sulfonyl group, an (alkyl or aryl)sulfinyl group, a sulfosulfamoyl group, an alkoxy group, an aryloxy group, a heterocyclic oxy group, an alkylthio group, an arylthio group, a heterocyclic thio group and an amino group. Particularly preferably it includes an alkyl group and an aryl group.

In Formula (C), when R₄ represents a substituent, preferably the substituent includes an alkyl group having 1 to 25 carbon atoms (including an aralkyl group, a cycloalkyl group and an active methine group), an aryl group, a heterocyclic group, a heterocyclic group containing a quaternary nitrogen atom (e.g., a pyridinio group), an acyl group, an alkoxycarbonyl group, an aryloxycarbonyl group, a carbamoyl group, an (alkyl or aryl)sulfonyl group, an (alkyl or aryl)sulfinyl group, a sulfosulfamoyl group, an alkoxy group, an aryloxy group, a heterocyclic oxy group, an alkylthio group, an arylthio group and a heterocyclic thio group. Particularly preferably, it includes an alkyl group, an aryl group, an alkoxy group, an aryloxy group, a heterocyclic oxy group, an alkylthio group, an arylthio group and a heterocyclic thio group. When Y₁ represents C(R₄)═N, the substituted carbon atoms in X₁ and Y₁ are bonded with the carbon atoms in Y₁.

Specific compounds of Formula (C) are shown in A-1 to A-230 of chemical formula 6 to 18 in JP-A-11-133546, but not limited thereto.

The amount of the above mentioned nucleating agent added is 10⁻⁵ mole or more and 1 mole or less, and preferably 10⁻⁴ mole or more and 5×10⁻¹ mole or less, based on 1 mole of the non-photosensitive organic silver salt.

As for the method of adding the above mentioned nucleating agent, the nucleating agent may be contained, using any method, for example, in the form of a solution, an emulsified dispersion or a dispersion of fine solid particles, etc., and thus it may be in the photosensitive material.

A well-known method for preparing an emulsified dispersion is executed by dissolving in an oil such as dibutyl phthalate, tricresyl phosphate, dioctyl sebacate and tri(2-ethylhexyl)phosphate or an auxiliary solvent such as ethyl acetate and cyclohexanone, adding a surfactant such as sodium dodecylbenzenesulfonate and sodium oleoyl-N-methyl taurinate, sodium di(2-ethylhexyl)sulfosuccinate, followed by a mechanical preparation of an emulsified dispersion, or the like. At this time, it is preferable to add a polymer such as an α-methylstyrene oligomer and poly(t-butylacrylamide) for the purpose of adjustment of a viscosity and a refraction index of an oil droplet.

Further, the fine solid particle dispersion method can include a method of dispersing a powder of the nucleating agent in an appropriate solvent such as water by a ball mill, colloid mill, vibration ball mill, sand mill, jet mill, roller mill or supersonic waves thereby preparing a solid dispersion. In this case, a protection colloid (for example, polyvinyl alcohol), a surfactant (for example, anionic surfactant such as sodium triisopropyl naphthalene sulfonate (mixture of those having different substitution positions for three isopropyl groups)) may be used. In the mills described above, beads of zirconia, etc. are generally used as the dispersion medium, and Zr or the like leaching from the beads may sometimes intrude into the dispersion. Depending on the dispersion condition, it is usually within a range of 1 ppm or more and 1000 ppm or less. When the content of Zr in the photosensitive material is 0.5 mg or less per 1 g of the silver, it causes no practical problem.

The liquid dispersion is preferably incorporated with a corrosion inhibitor (for example, sodium salt of benzoisothiazolinone).

It is particularly preferable in the invention to use the method of dispersing a powder of the nucleating agent. The nucleating agent is added as having average size of the grain diameter being preferably in a range of 0.01 to 10 μM, more preferably in a range of 0.05 to 5 μm, and further preferably in a range of 0.1 to 2 μm. It is preferable that solid dispersants other than the nucleating agent also have the same range of the average size of the grain diameter and used in the material of the invention.

Among the above mentioned nucleating agents, for the sensitive materials processed in quick development in which a developing time is 20 seconds or less, preferably the compound represented by Formulae [H] and (P) are used, and particularly preferably the compound represented by Formula [H] is used.

For low fogging, preferably the compound represented by formulae (G), (A), (B) and (C) are used, and particularly preferably the compound represented by formulae (A) and (B) are used. In addition, when they are used in various environmental conditions (temperature or humidity), for sensitive materials which have little change in photography ability depending on environmental conditions, the compound represented by formula (C) is preferably used.

Among the above mentioned nucleating agents, specific compounds are as follows, but not limited thereto.

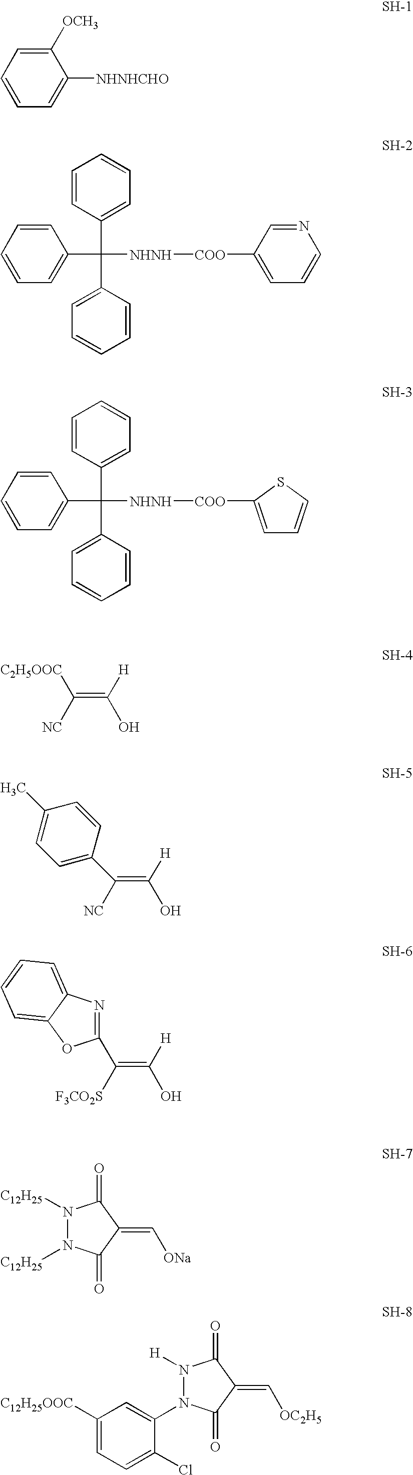

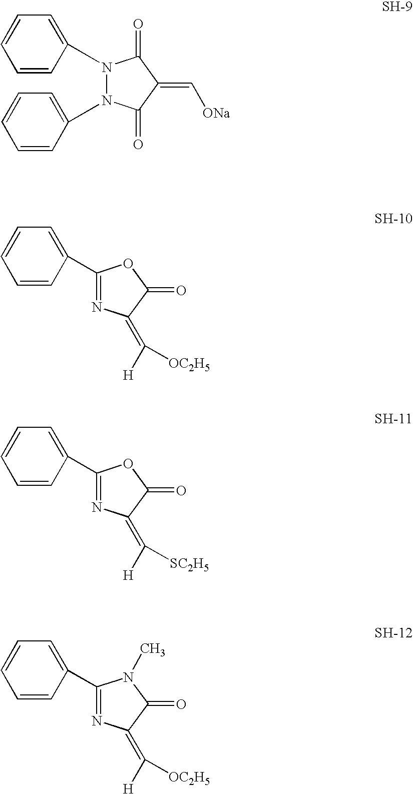

The nucleating agent of the invention can be added to an image-forming layer or a layer adjacent to the image-forming layer, and preferably to an image-forming layer. The amount of the nucleating agent added is 10⁻⁵ mole or more and 1 mole or less, and preferably 10⁻⁴ mole or more and 5×10⁻¹ mole or less, relative to 1 mole of the non-photosensitive organic silver salt. The nucleating agent may be added alone or in combination of two or more kinds.

The photothermographic material of the invention may contain two or more image-forming layers containing photosensitive silver halide. In the case of comprising two or more layers, any one of the image-forming layers may contain a nucleating agent. Preferably, the photothermographic material contains two or more image-forming layers consisting of at least one image-forming layer which does not contain the nucleating agent and at least one image-forming layers which contains the nucleating agent.

Reducing Agent

As a reducing agent for silver ions (a mixture comprising one or at least two kinds of the reducing agents components), any material which can reduce silver (I) ions to silver (preferably an organic material) can be used.

A developing agent for wet photography (e.g., methyl gallate, hydroquinone, substituted hydroquinone, 3-pyrazolidones, p-aminophenols, p-phenyldiamines, hindered phenols, amidoximes, azines, catechols, pyrogallols, ascorbic acid (or a derivative thereof) and leuco pigments) and other materials which are clear to a skilled person in the art, can be used in the invention according to the description in U.S. Pat. No. 6,020,117 (by Bauer et. al.).

An “ascorbic acid reducing agent” (also referred to as a developing agent) means a composite with ascorbic acid or a derivative thereof. The ascorbic acid developing agent is described in many documents, for example, U.S. Pat. No. 5,236,816 (by Purol et. al.) and the documents incorporated therein.

The reducing agent in the invention is preferably an ascorbic acid developing agent. A useful ascorbic acid developing agent comprises ascorbic acid and an analogue thereof, and an isomer and a derivative thereof. Such a compound includes the following ones, but not limited thereto.

Examples thereof include D- or L-ascorbic acid and a sugar derivative thereof (e.g., sorboascorbic acid, gamma-lactoascorbic acid, 6-desoxy-L ascorbic acid, L-rhamnoascorbic acid, imino-6-desoxy-L ascorbic acid, glucoascorbic acid, fucoascorbic acid, glucoheptoascorbic acid, maltoascorbic acid, L-arabosascorbic acid), sodium ascorbate, potassium ascorbic acid, isoascorbic acid (or L-erythroascorbic acid), a salt thereof (e.g., an alkali metal salt, an ammonium salt or a salt which is known in this field of the art), an endiol type ascorbic acid, an enaminol type ascorbic acid, a thioenol type ascorbic acid, for example, compounds which are described in the U.S. Pat. No. 5,498,511 (by Yamashita et. al.), EP-A-0585792 (by Passarella et. al.), EP-A-0573700 (by Lingier et. al.), EP-A-0588408 (by Hieronymus et. al.), U.S. Pat. No. 5,089,819 (by Knapp), U.S. Pat. No. 5,278,035 (by Knapp), U.S. Pat. No. 5,384,232 (by Bishop et. al.), U.S. Pat. No. 5,376,510 (by Parker et. al.), JP 7-56286 (by Toyota), U.S. Pat. No. 2,688,549 (by James et. al.) and Research Disclosure 37152 (by March, 1995).

Among these compounds, preferred are D-, L- or D,L-ascorbic acid (or an alkali metal salt thereof) or isoascorbic acid (or an alkali metal salt thereof), and the metal salt is preferably a sodium salt. A mixture of these developing agents can be used, if necessary.

Hindered phenols can be used alone or in combination with at least one contrast developing agent and a nucleating agent.

The hindered phenol has a compound which has only one hydroxyl group on a benzene ring and has at least one substituent in an ortho-position relative to the hydroxyl group. If the hindered phenol reducing agent has plural hydroxyl groups in separate benzene rings, plural hydroxyl groups may be provided.

The hindered phenol reducing agents include, for example, binaphthols (in other words, dihydroxy binaphthols), biphenols (in other words, dihydroxy biphenols), bis(hydroxynaphthyl)methanes, bis(hydroxyphenyl)methanes (in other words, bisphenols), hindered phenols and hindered naphthols, each of which may be substituted.

In the following, representative naphthols are shown, but not limited thereto:
1,1′-bi-2-naphthol;
1,1′-bi-4-methyl-2-naphthol; and
6,6′-dibromo-bi-2-naphthol.

Other compounds are described in U.S. Pat. No. 3,094,417 (by Workman) and U.S. Pat. No. 5,262,295 (by Tanaka et. al.).

In the following, representative biphenols are shown, but not limited thereto:
2,2′-dihydroxy-3,3′-di-t-butyl-5,5-dimethylbiphenyl;
2,2′-dihydroxy-3,3′,5,5′-tetra-t-butylbiphenyl;
2,2′-dihydroxy-3,3′-di-t-butyl-5,5′-dichlorobiphenyl;
2-(2-hydroxy-3-t-butyl-5-ethylphenyl)-4-methyl-6-n-hexylphenol;
4,4′-dihydroxy-3,3′,5,5′-tetra-t-butylbiphenyl;
4,4′-dihydroxy-3,3′,5,5′-tetraemethylbiphenyl, and
the compounds described in U.S. Pat. No. 5,262,295.

In the following, representative bis(hydroxynaphthyl)methanes are shown, but not limited thereto:
4,4′-methylenbis(2-methyl-1-naphthol); and
the compounds described in U.S. Pat. No. 5,262,295.

In the following, representative bis(hydroxyphenyl)methanes are shown, but not limited thereto:
bis(2-hydroxy-3-t-butyl-5-methylphenyl)methane (CAO-5);
1,1′-bis(2-hydroxy-3,5-dimethylphenyl)-3,5,5-trimethylhexane (trade name: NONOX or PERMANAX WSO, both manufactured by St-Jean Photo Chemicals Inc.);
1,1′-bis(3,5-di-t-butyl-4-hydroxyphenyl)methane;
2,2′-bis(4-hydroxy-3-methylphenyl)propane;
4,4′-ethylidene-bis(2-t-butyl-6-ethylphenol);
2,2′-isobutylidene-bis(4,6-dimethylphenol) (trade name: LOWINOX 221B46);
2,2′-bis(3,5-dimethyl-4-hydroxyphenyl)propane; and
the compounds described in U.S. Pat. No. 5,262,295.

In the following, representative hindered phenols are shown, but not limited thereto:
2,6-di-t-butylphenol;
2,6-t-butyl-4-methylphenol;
2,4-di-t-butylphenol;
2,6-dichlorophenol;
2,6-dimethylphenol; and
2-t-butyl-6-methylphenol.

In the following, representative hindered napthols are shown, but not limited thereto:
1-naphthol;
4-methyl-1-naphthol;
4-methoxy-1-naphthol;
4-chloro-1-naphthol;
2-methyl-1-naphthol; and
the compounds described in U.S. Pat. No. 5,262,295.

Particularly, the following compounds are those that are disclosed as reducing agents suited for the photothermographic material:
amidoximes (e.g., phenyl amidoxime);
2-thienyl amidoxime;
p-phenoxyphenyl amidoxime;
azines (e.g., 4-hydroxy-3,5-dimethoxybenzaldehydrazine);
a combination of aliphatic allylhydrazide carboxylate and ascorbic acid (e.g., a combination of 2,2′-bis(hydroxy methyl)-propionyl-β-phenylhydrazide and ascorbic acid);
polyhydroxybenzene and hydroxylamine,
a combination of reductone and/or hydrazine (e.g., a combination of hydroquinone and bis(ethoxyethyl)hydroxylamine);
piperidine-4-methylphenylhydrazine;
hydroxamic acid (e.g., phenylhydroxamic acid, p-hydroxyphenylhydroxamic acid and o-allanylhydroxamic acid);
a combination of azine and sulfonamide phenols (e.g., phenothiazine, 2,6-dichloro-4-benzene sulfonamide phenol);
an α-cyanophenyl acetic acid derivative (e.g., ethyl-α-cyano-2-methylphenyl acetic acid, ethyl-α-cyanophenyl acetic acid);
bis-o-naphthol (e.g., 2,2′-dihydroxy-1-binaphthyl, 6,6′-dibromo-2,2′-dihydroxy-1,1′-binaphthol, bis(2-hydroxy-1-naphthol)methane);
a combination of bis-o-naphthol and 1,3-dihydroxybenzene derivative (e.g., 2,4-dihydroxybenzophenone, 2,4-dihydroxyacetophenone);
5-pyrazolone (e.g., 3-methyl-1-phenyl-5-pyrazolone);
reductones (e.g., dimethylaminohexose reductone, anhydrodihydro-aminohexose reductone, anhydrodihydro-piperidone-hexose reductone);
a sulfonamide phenol reducing agent (e.g., 2,6-dichloro-4-benzene sulfonamide phenol, p-benzene sulfonamide phenol);
indane-1,3-diones (e.g., 2-phenylindane-1,3-dione);
   chromans (e.g., 2,2-dimethyl-7-t-butyl-6-hydroxy chroman);
1,4-dihydroxypyridines (e.g., 2,6-dimethoxy-3,5-dicarboethoxy-1,4-dihydropyridine);
an ascorbic acid derivative (1-ascorbic palmitate, ascorbic acid stearate);
unsaturated aldehyde (ketone); and
3-pyrazolidone.

Examples of the reducing agent which can be used as a developing agent include substituted hydrazines including sulfonyl hydrazines as described in U.S. Pat. No. 5,464,738 (by Lynch et. al.). Other useful reducing agents are described in, for example, U.S. Pat. No. 3,074,809 (by Owen et. al.), U.S. Pat. No. 3,094,417 (by Workman et. al.), U.S. Pat. No. 3,080,254 (by Grant, Jr.) and U.S. Pat. No. 3,887,417 (by Klein et. al.). An auxiliary developing agent described in U.S. Pat. No. 5,981,151 (by Leenders et. al.) is also useful. All of these patents can be incorporated herein.

The reducing agent element may be constituted by at least two elements consisting of a hindered phenol reducing agent and other various co-reducing agent listed below. Further, a mixture of three developing agent, in which a nucleating agent is further added to the above reducing agent element, can be used. The nucleating agent is selected from the following compounds.

As a co-reducing agent, there can be used trityl hydrazide or formyl-phenyl hydrazide described in U.S. Pat. No. 5,496,695 (by Simpson et. al.).

Various nucleating agents used in the photothermographic material can be employed as the co-reducing agent. Effective examples of the nucleating agent include the following compounds, but not limited thereto:

Hydroxyl amine (including hydroxylamine and an alkyl- or aryl-substituted derivative), alkanol amines and ammonium phthalamate compounds described in, for example, U.S. Pat. No. 5,545,505 (by Simpson), hydroxamic acid compounds described in, for example, U.S. Pat. No. 5,545,507 (by Simpson et. al.), N-acylhydrazine compounds described in, for example, U.S. Pat. No. 5,558,983 (by Simpson et. al.), hydrogen atom-donating compounds described in U.S. Pat. No. 5,637,449 (by Harring et. al.). All of these patents are incorporated by reference herein.

When the silver salt of a nitrogen-containing heterocyclic compound or the silver salt of a mercapto compound according to the invention is used as a non-photosensitive organic silver salt, it is preferable to use ascorbic acid or a derivative thereof as a reducing agent. As one example of the specific preferable combinations, a silver salt of benzotriazole or a substituted compound thereof (e.g., a silver salt of benzotriazole which has a mercapto group as a substituent) or a mixture thereof as a non-photosensitive organic silver salt is used, and ascorbic acid may be used as the reducing agent.

The reducing agents as used herein (or a mixture thereof) are comprised in an amount of 1 mass % or more and 10 mass % or less (dry mass), based on the image-forming layer. In the multi-layered structure, if the reducing agent is added to a layer other than the image-forming layer, the proportion thereof is higher, and desirably the proportion is 2 mass % or more and 15 mass % or less. The co-developing agent is comprised in an amount of about 0.001 mass % or more and 1.5 mass % or less based on the image-forming layer (dry weight).

The reducing agent in the invention can be contained in any of the image-forming layer containing the non-photosensitive organic silver salt and the photosensitive silver halide and a layer adjacent to the image-forming layer, but is more preferably incorporated in the image-forming layer.

The reducing agent in the invention may be incorporated in a coating liquid and in turn the photosensitive material as any form such as a solution, an emulsified dispersion and a solid microparticle dispersion.

An example of a well known emulsion dispersion method is a method in which the reducing agent is dissolved in an oil such as dibutyl phthalate, tricresyl phosphate, glyceryl triacetate or diethyl phtalate, or an auxiliary solvent such as ethyl acetate or cyclohexanone, and then mechanically emulsion-dispersed.

An example of a solid microparticle dispersion method is a method in which the reducing agent is dispersed in a suitable solvent such as water by using a ball mill, a colloid mill, a vibrational ball mill, a sand mill, a jet mill, a roller mill or an ultrasonic wave to produce a solid dispersion. It is preferable that the sand mill is used in the method. In this method, a protective colloid (such as polyvinyl alcohol) or a surfactant (such as anionic surfactant, examples thereof include sodium triisopropylnaphthalenesulfonate (mixture of sulfonates having three isopropyl groups at different sites)) may be employed. An aqueous dispersion may contain an antiseptic agent (such as benzoisothiazolinon sodium salt).

The solid particle dispersion method of the reducing agent is particularly preferable. The reducing agent is preferably used as a solid dispersion including microparticles which has an average particle size in the range of 0.01 μm to 10 μm, preferably in a range of 0.05 μm to 5 μm, and more preferably in a range of 0.1 μm to 1 μm. In the invention, it is preferable that particles included in other solid dispersions also have a size within the above range.

Development Accelerator

The photothermographic material of the invention preferably contains a development accelerator such as sulfonamidophenol compounds represented by formula (A) described in JP-A Nos. 2000-267222 and 2000-330234, hindered phenol compounds represented by formula (II) described in JP-A No. 2001-92075, compounds represented by formula (I) described in JP-A No. 10-62895 and 11-15116, hydrazine compounds represented by formula (I) described in JP-A No. 2002-278017, and phenol and naphthol compounds represented by formula (2) described in JP-A No. 2001-264929. The content of the development accelerator is 0.1 mol % to 20 mol %, preferably 0.5 mol % to 10 mol %, and more preferably 1 mol % to 5 mol % with respect to the amount of the reducing agent. The development accelerator can be introduced into the photothermographic material in the same manner as the introduction of the reducing agent, and is preferably introduced by adding thereof as a solid dispersion or an emulsified dispersion. When the development accelerator is used in a form of an emulsified dispersion, the development accelerator is preferably used as an emulsified dispersion obtained by dispersing the development accelerator in a solvent which has a high-boiling point and is solid at ordinary temperature and an auxiliary solvent which has a low-boiling point, or as a so-called oilless emulsified dispersion, which does not use a solvent which has a high-boiling point.

In the invention, the development accelerator is particularly preferably a hydrazine compound represented by formula (1) described in JP-A No. 2001-278017 and a phenol or naphthol compound represented by formula (2) described in JP-A No. 2001-264929.

Preferable examples of the development accelerator in the invention are shown below. However, it should be understood that the invention is not limited to them. 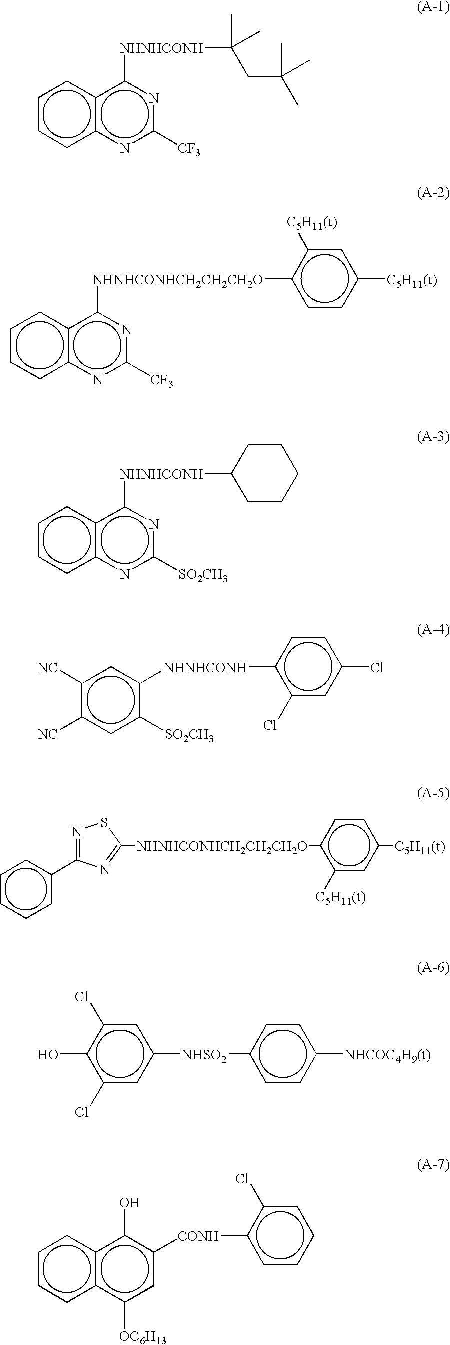 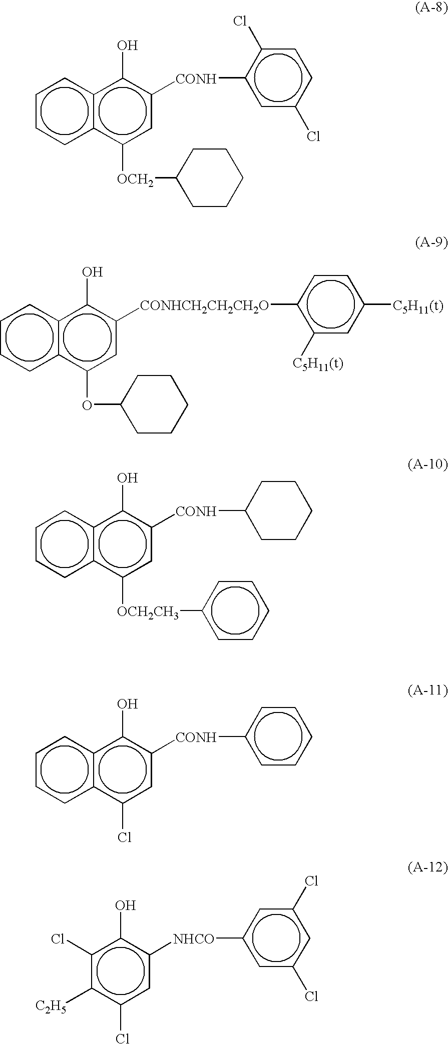
Hydrogen Bonding Compound

In the invention, the photosensntive material and the thermographic material preferably contain a non-reducing compound having a group, with which an aromatic hydroxyl group (—OH) of a reducint agent or an amino group in a case when a reducing agent has the amino group is capable of forming a hydrogen bond.

Examples of the group capable of forming a hydrogen bond include a phosphoryl group, a sulfoxide group, a sulfonyl group, a carbonyl group, an amide group, an ester group, an urethane group, an ureido group, a tertiary amino group, or a nitrogen-containing aromatic group. Among them, compounds having a phosphoryl group, a sulfoxide group, an amide group (that has no >N—H group and blocked such that the nitrogen atom fomrs a >N—Ra group (Ra is a substituent other than hydrogen)), an urethane group (that has no >N—H group and blocked such that the nitrogen atom forms a >N—Ra group (Ra is a substituent other than hydrogen)) or an ureido group (that has no >N—H group and blocked such that the nitrogen atom forms a >N—Ra group (Ra is a substituent other than hydrogen)) are preferable.

In the invention, the hydrogen bonding compound is particularly preferably a compound represented by the following Formula (D).

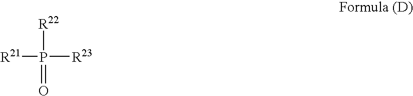

In Formula (D), each of R²¹ to R²³ independently represents an alkyl group, an aryl group, an alkoxy group, an aryloxy group, an amino group, or a heterocyclic group. These groups may be unsubstituted or substituted.

Examples of a substituent which may substitute R²¹, R²² or R²³ include a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, or a phosphoryl group. Among them, an alkyl group or an aryl group, specific examples of which include a methyl group, an ethyl group, an isopropyl group, a t-butyl group, a t-octyl group, a phenyl group, a 4-alkoxyphenyl group, and a 4-acyloxyphenyl group, are preferably used as a substitutent.

Specific examples of the alkyl group represented by R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group.

Examples of the aryl group include a phenyl group, a cresyl group, a xylyl group, a naphthyl group, a 4-t-butylphenyl group, a 4-t-octylphenyl group, a 4-anisidyl group, and a 3,5-dichlorophenyl group.

Examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, and a benzyloxy group.

Examples of the aryloxy group include a phenoxy group, a cresyloxy group, an isopropylphenoxy group, a 4-t-butylphenoxy group, a naphthoxy group, and a biphenyloxy group.

Examples of the amino group include a dimethylamino group, a diethylaminoamino group, a dibutylamino group, a dioctylamino group, a N-methyl-N-hexylamino group, a dicyclohexylamino group, a diphenylamino group and a N-methyl-N-phenylamino group.

Each of R²¹ to R²³ preferably independently represents an alkyl group, an aryl group, an alkoxy group, or an aryloxy group. From the viewpoint of effects of the invention, it is preferable that at least one of R²¹ to R²³ is an alkyl group or an aryl group. It is more preferable that each of at least two of R²¹ to R²³ independently represents an alkyl group or an aryl group. Further, it is preferable that R²¹ to R²³ are the same group, since such a compound is inexpensively available.

Hereinafter, specific examples of the hydrogen bonding compound in the invention including the compound represented by Formula (D) are shown. However, the invention is not limited to them.

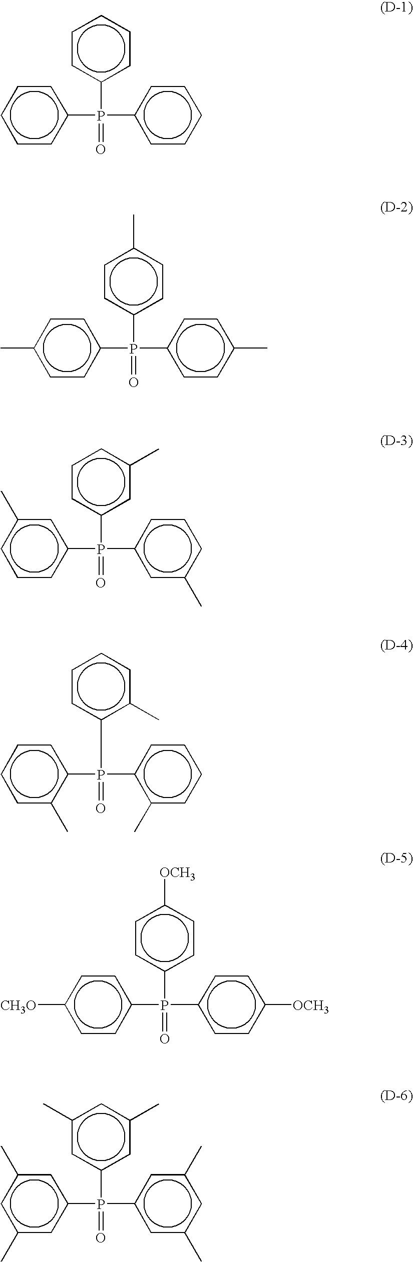

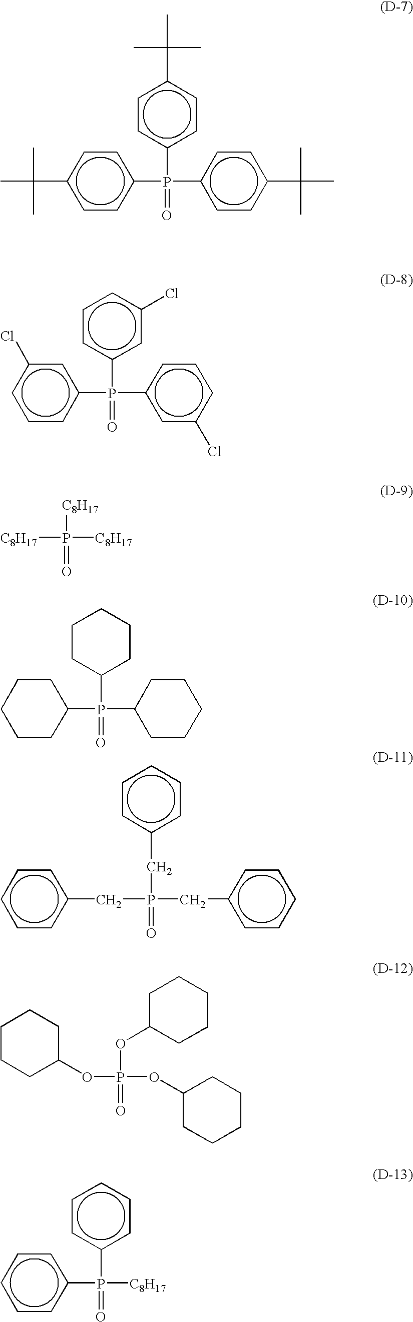

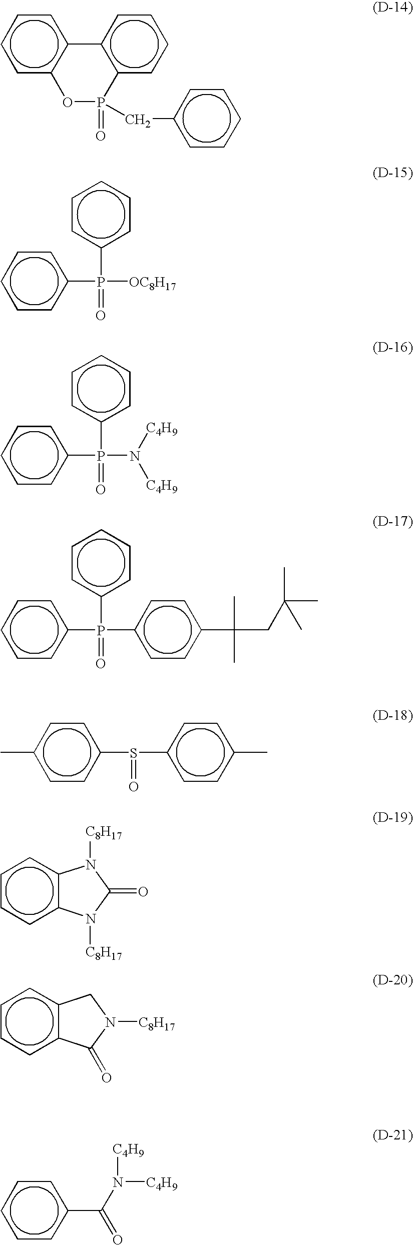

In addition to the above, specific examples of the hydrogen bonding compound further include those described in EP No. 1096310, JP-A Nos. 2002-156727 and 2002-318431.

Similarly as the reducing agent, the hydrogen bonding compound of the invention can be incorporated in a coating liquid and used for the photosensitive material in a form of a solution, an emulsified dispersion, or a solid-dispersed fine particle dispersion. The hydrogen bonding compound in the invention forms a complex with a compound having a phenolic hydroxyl group through a hydrogen bond in a solution. Therefore, the complex can be isolated as crystalline depending on kinds of combinations of the reducing agent and the compound represented by Formula (A) in the invention.

The crystal powder thus isolated is particularly preferably used as a solid-dispersed fine particle dispersion in order to obtain stable performance. In addition, a method can also be preferably conducted in which powder of the reducing agent is mixed with powder of the hydrogen bonding compound in the invention, and in which the resultant mixture is dispersed with a suitable dispersant by a sand grinder mill to form a complex.

The content of the hydrogen bonding compound in the invention can be preferably in a range of 1 mol % to 200 mol %, more preferably in a range of 10 mol % to 150 mol %, and still more preferably in a range of 30 mol % to 100 mol % with respect to the amount of the reducing agent.

Antifogging Agent

In order to control performances of properties of a photothermographic material (e.g., gradation, Dmin and fogging), the invention preferably includes at least one heteroaromatic mercapto compound or heteroaromatic disulfide compound represented by general formulae Ar—S-M¹ or Ar—S—S—Ar. Herein, M¹ represents a hydrogen atom or an alkali metal atom, and Ar represents a heteroaromatic ring or a heteroaromatic condensed ring containing at least one selected from nitrogen, sulfur, oxygen, Se and Te atoms.

Preferable examples of the heteroaromatic ring include benzimidazole, naphthimidazole, benzothiazole, naphthothiazole, benzoxazole, naphthoxazole, benzoselenazole, benzotellurazole, imidazole, oxazole, pyrazole, triazole, thiazole, thiadiazole, tetrazole, triazine, pyrimidine, pyridazine, pyrazine, pyridine, purine, quinoline and quinazolinone. Heteroaromatic rings which function as strong color sensitizers are also preferable. For example, the heteroaromatic mercapto compound is described as a strong color sensitizer for a photothermographic material for infrared-ray in EP-A-0559228 by Philip Jr. et. al.

The photothermographic material of the invention can be protected from occurrence of fogging, and thus be stable against loss of sensitivity during storage. If required, a mercury (II) salt can be added to an emulsion layer of the photothermographic material of the invention as an antifogging agent. A preferred mercury (II) salt useful for this purpose is mercury acetate and mercury bromide. Other useful mercuric salts are described in U.S. Pat. No. 2,728,663 (by Allen).

Examples of suitable antifogging agents and stabilizing agents which are used singly or in combination with other means include thiazolium salts described in U.S. Pat. No. 2,131,038 (by Staud) and U.S. Pat. No. 2,694,716 (by Allen), azaindenes described in U.S. Pat. No. 2,886,437 (by Piper), triazaindolidines described in U.S. Pat. No. 2,444,605 (by Heimbach), urazoles described in U.S. Pat. No. 3,287,135 (by Anderson), sulfocatechols described in U.S. Pat. No. 3,235,652 (by Kennard), oximes described in GB 623,448 (by Carol et. al.), polyvalent metal salts described in U.S. Pat. No. 2,839,405 (by Jones), thiouronium salts described in U.S. Pat. No. 3,220,839 (by Herz), salts of palladium, platina or gold described in U.S. Pat. No. 2,566,263 (by Trirelli) and U.S. Pat. No. 2,597,915 (by Damshroder), —SO₂CBr₃ compounds described in U.S. Pat. No. 5,594,143 (by Kirk et. al.) and U.S. Pat. No. 5,374,514 (by Kirk et al.), and 2-tribromomethylsulfonyl)quinoline compounds described in U.S. Pat. No. 5,460,938.

A stabilizing agent precursor which releases a stabilizing agent in response to heat during development, can be also used. Examples of the precursor compounds include those described in U.S. Pat. No. 5,158,866 (by Simpson et. al.), U.S. Pat. No. 5,175,081 (by Krepski et. al.), U.S. Pat. No. 5,298,390 (by Sakizadeh et. al.), and U.S. Pat. No. 5,300,420 (by Kenney et. al.).

Further, it was found that benzotriazoles having a substituted sulfonyl group (e.g., alkylsulfonyl benzotriazoles and aryl sulfonyl benzotriazoles) are useful stabilizing agents (in view of, for example, stability after treatment) as described in U.S. Pat. No. 6,171,767 (by Kong et. al.).

Further, other useful antifogging agents/stabilizing agents are described in U.S. Pat. No. 6,083,681 (by Lynch et. al.) in more detail.

The photothermographic material of the invention may contain at least one polyhalogen antifogging agent which contains a polyhalogen substituent such as a dichloro group, a dibromo group, a trichloro group, or a tribromo group. Such antifogging agent may be a composite containing aliphatic compounds, alicyclic compounds, or aromatic compounds having a heterocyclic ring or a carbocyclic ring.

Particularly useful antifogging agent of this kind is a polyhalogen antifogging agent having —SO₂(X′)₃. Herein, X′ represents a halogen atom which may be the same or different from each other.

Examples of other useful antifogging agent include a compound which is represented by following Formula (I) and has a pKa of 8 or less.
R¹—SO₂—C—(R²)R³—(CO)ₘ-(L₁)ₙ-SG Formula (1)

In Formula (I), R¹ represents an aliphatic group or a cyclic group, and R² and R³ each independently represent a hydrogen atom or a bromine atom, and at least one of R² and R³ is bromine. L₁ represents an aliphatic bivalent linking group. m and n each independently represent 0 or 1. SG represents a soluble group having a pKa of 8 or less.

Preferable embodiments of Formula (I) include:
both of m and n are 0, and SG is a carboxyl group (or a salt thereof), a sulfo group (or a salt thereof), a phospho group (or a salt thereof), (—SO₂N⁻COR⁴)(M²)⁺, or (N—SO₂R₄)(M²)⁺;
m is 1, n is 0, SG is a carboxyl group (or a salt thereof), a sulfo group (or a salt thereof), a phospho group (or a salt thereof), or (—N—SO₂R₄)(M²)⁺;
both of m and n are 1, SG is a carboxyl group (or a salt thereof), a sulfo group (or a salt thereof), a phospho group (or a salt thereof), or (—SO₂N⁻COR⁴) (M²)⁺. Herein, R⁴ is an aliphatic group or a cyclic group, and (M²)⁺ is a cation other than a proton.
   Other Additives
   1) Color-Toning Agent

The “color-toning agent” is a compound which improves a silver color tone and increase an optical density of a developed image.

In a black-and-white photothermographic material particularly useful color-toning agent contributes to a formation of pure black color tone in development. Therefore, it is desirable that the “color-toning agent” or a derivative thereof is used, and is contained in the photothermographic material of the invention.

Such compounds are well-konwn in the field of technology of photothermographic materials, and are described in U.S. Pat. No. 3,080,254 (by Grant, Jr.), U.S. Pat. No. 3,847,612 (by Winslow), U.S. Pat. No. 4,123,282 (by Winslow), U.S. Pat. No. 4,082,901 (by Laridon et. al.), U.S. Pat. No. 3,074,809 (by Owen), U.S. Pat. No. 3,446,648 (by Workman), U.S. Pat. No. 3,844,797 (by Willems et. al.), U.S. Pat. No. 3,951,660 (by Hagemann et. al.), U.S. Pat. No. 5,599,647 (by Defieuw et. al.), U.S. Pat. No. 4,220,709 (by de Mauriac et. al.), U.S. Pat. No. 4,451,561 (by Hirabayashi et. al.), U.S. Pat. No. 4,543,309 (by Hirabayashi et. al.), U.S. Pat. No. 3,832,186 (by Masuda et. al.), U.S. Pat. No. 4,201,582 (by White et. al.), and U.S. Pat. No. 3,881,938 (Masuda et. al.), and GB 1,439,478 (by Agfa).

Followings are specific examples of the color-toning agent, which are not for limitation: phthalimide and N-hydroxyphthalimide; cyclic imide (e.g., succinimide); pyrazolin-5-one; quinazolinone; 1-phenylurazole; 3-pheny-2-pyrazolin-5-one; 2,4-thiazolidinedione; naphthalimide (e.g., N-hydroxy-1,8-naphthalimide); a cobalt complex (e.g., hexaaminocobalt(3+)trifluoroacetate); mercaptan (e.g., mercaptotriazoles such as 3-mercapto-1,2,4-tirazole, 3-mercapto-4-phenyl-1,2,4,-triazole, 4-phenyl-1,2,4-triazolidine-3,5-dithione, 4-allyl 3-amine-5-mercapto-1,2,4-triazole, and 4-methyl-5-thioxo-1,2,4-triazolidine-3-one; pyrimides such as 2,4-dimeraptopyrimidine; thiadiazoles such as 2,5-dimercapto-1,3,4-thiadiazole, and 5-methyl-1,3,4-thiadiazolyl-2-thiol; mercaptotetrazoles such as 1-phenyl-5-mercaptotetrazole and 5-acethylamino-1,3,4-thiadiazoline-2-thione; and mercaptoimidazoles such as 1,3-dihydro-1-phenyl-2H-imidazole-2-thione); N-(aminomethyl)allyldicarboxyimides [e.g., (N,N-dimethylaminomethyl)phthalimide and N-(dimethylaminomethyl)naphthalene-2,3-dicarboxyimide]; combinations of blocked pyrazoles; isothiuronium derivatives; a specific bleaching agent for photography [(e.g., a combination of N,N-hexamethylene-bis(1-carbamoyl-3,5-dimethylpyrazole), 1,8-(3,6-diazaoctane)bis(isothiuronium)trifluoroacetate, and 2-(tribromomethylsulfonyl)benzothiazole)]; merocyanine dyes {e.g., 3-ethyl-5[(3-ethyl-2-benzothiazolinylidene)-1-methyl-ehtylidene]-2-thio-2,4-o-azolidinedione}; phthalazine and derivatives thereof [e.g., those described in U.S. Pat. No. 6,146,822 (by Asanuma et. al.)]; phthalazinone, derivatives thereof and metal salts thereof [e.g., 4-(1-naphthyl)phthalazinone, 6-chlorophthalazinone, 5,7-dimethoxyphthazinone, and 2,3-dihydro-1,4-phthalazindione]; combinations of a phthalazine (or a derivative thereof) and at least one phthalic acid derivative (e.g., phthalic acid, 4-methylphthalic acid, 4-nitrophthalic acid, and tetrachlorophthalic anhydride); quinazolinediones; derivatives of benzoxazine or naphthoxazine; rhodium complexes which may function not only as the color-toning agent but also as a halogen source for silver halide formation in situ [e.g., ammonium hexachlororhodate (III), rhodium bromide, rhodium nitrate, and potassium hexachlororhodate (III)]; benzoxadine-2,4-diones (e.g., 1,3-benzoxadine-2,4-dione, 8-methyl-1,3-benzoxadine-2,4-dione, and 6-nitro-1,3-benzoxadine-2,4-dione); pyrimidines and asym-triazines (e.g., 2,4-dihydroxypyrimidine, 2-hydroxy-4-aminopyrimidine, and azauracil); and tetraazapentalene derivatives [e.g., 3,6-dimercapto-1,4-diphenyl-1H,4H-2,3a,5,6a-tetraazapentalene and 1,4-di-(o-chlorophenyl)-3,6-dimercapto-1H,4H-2,3a,5,6a-tetraazapentalene].

In the invention using a non-photosensitive organic silver salt and a silver salt of a nitrogen-containing compound containing an imino group, a particularly useful color-toning agent is a mercapto compound represented by Formula (II).

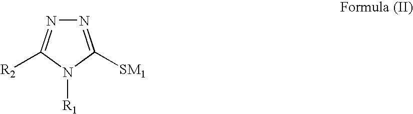

In Formula (II), R₁ and R₂ each independently represent a hydrogen atom, a substituted or unsubstituted alkyl group having 1 to 7 carbon atoms (e.g., a methyl group, an ethyl group, an isopropyl group, a tbutyl group, a n-hexyl group, a hydroxymethyl group and a benzyl group), a substituted or unsubstituted alkenyl group having 2 to 5 carbon atoms (e.g., a ethynyl group, a 1,2-propenyl group, a methallyl group, and a 3-buten-1-yl group), a substituted or unsubstituted cycloalkyl group having 5 to 7 carbon atoms (e.g., a cyclophenyl group, a cyclohexyl group, and a 2,3-dimethylcyclohexyl group), a substituted or unsubstituted aromatic or nonaromatic heterocycle in which a carbon atom, a nitrogen atom, an oxygen atom or a sulfur atom forms a 5- or 6-membered, an aromatic or nonaromatic heterocycle (e.g., a pyridyl group, a furanyl group, a thiazolyl group, and a thienyl group), an amino group or an amide group (e.g., an amino group or an acetamido group), and a substituted or unsubstituted aryl group containing 6 to 10 carbon atoms (e.g., a phenyl group, a tolyl group, a naphthyl group, and a 4-ethoxyphenyl group).

Further, R₁ and R₂ may be a substituted or unsubstituted Y₁-—(CH₂)ₖ—, wherein Y₁ is a substituted or unsubstituted aryl group having 6 to 10 carbon atoms as defined in the above-described R₁ and R₂, or a substituted or unsubstituted aromatic or nonaromatic heterocylic group as defined in the above-described R₁, wherein k is 1 to 3.

Alternatively, R₁ and R₂ form a 5- to 7-membered, substituted or unsubstituted, aromatic or non-aromatic heterocycle having a carbon atom, a nitrogen atom, an oxygen atom or a sulfur atom. Examples of the heterocyle include pyridine, diazinyl, triazinyl, piperidine, morpholine, pyrolidine, pyrazolidine and thiomorphyline.

In addition, R₁ and R₂ may be a divalent linking group which connects two mercaptotrizole groups, and examples thereof include a phenylene group, a methylene group and an ethylene group. R₂ may be a carboxyl group or a salt thereof.

M₁ is a hydrogen or a monovalent cation (e.g., an alkali metal cation, an ammonium ion and a pyridinium ion).

Definition of the mercaptotriazole of Formula (II) includes the following condition.

1) R₁ and R₂ are not hydrogen at the same time.

2) When R₁ is a substituted or unsubstituted phenyl group or benzyl group, R₂ is neither a substituted nor unsubstituted phenyl group or a benzyl group.

3) When R₂ is hydrogen, R₁ is none of an allenyl group having a cyano group or a sulfonic acid group, a 2,2-diphenylethyl group, an α-methylbenzyl group and a phenyl group.

4) When R₁ is a benzyl group or a phenyl group, R₂ is neither a 1,2-dihydroxyethyl group nor a 2-hydroxy-2-propyl group, each of which has a substitutent.

5) When R₁ is hydrogen, R₂ is not a 3-phenylthiopropyl group.

In one embodiment, a photothermographic material is further defined as follows:

6) At least one image-forming layer which is capable of thermally developed has a pH of 7 or lower.

Preferably, R₁ is a methyl group, a t-butyl group, a substituted phenyl group or a benzyl group. More preferably, R₁ is a benzyl group. Further, R₁ may be a divalent linking group which links two mercaptotrizole groups (e.g., a phenylene group, a methylene group and an ethylene group).

Preferably, R₂ is hydrogen, an acetamido group or a hydroxymethyl group. More preferably, R₂ is hydrogen. In addition, R₂ may be a divalent linking group which links two mercaptotrizole groups (e.g., a phenylene group, a methylene group and an ethylene group).

As described above, in one embodiment, at least one image-forming layer which is capable of thermally developed has a pH of 7 or lower. The pH of the layers may be controlled to acidic by adding ascorbic acid as a developing agent. Alternatively, the pH of silver salt dispersion may be controlled before coating, for example, by adding mineral acids such as sulfuric acid and nitric acid, or organic acids such as citric acid.

A pH of at least one image-forming layer of the invention is preferably less than 7, and more preferably less than 6. The pH value can be determined by dropping one drop of a KNO₃ solution into the surface of a sample and using a surface pH electrode. Such an electrode is available from Corning (Corning Co., Ltd. (N.Y.)).

Many of the color-toning agents described herein are a heterocyclic composite. It is well known that there exists a tautomer in the heterocyclic composite. Further, there can also be a ringed tautomer and a substituent tautomer. For example, for 1,2,4-mercaptotriazole which is a preferable color-toning agent, at least 3 types of tautomers can exist (1H-form, 2H-form and 4H-form).

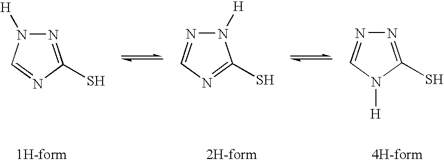

Further, 1,2,4-mercaptotriazole may form a thiol-thione substituent tautomer.

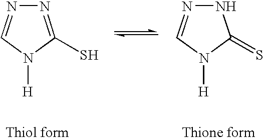

Interchange among these tautomers can rapidly occur. Each tautomer cannot be isolated, but one tautomer may dominantly exist.

In the invention, 1,2,4-mercaptotriazole is represented by the structural formula of 4H-thiol, but this representation is used with recognizing that tautomers such as above-described are included within the scope thereof.

In the invention, the color-toning agent is particularly preferably a mercaptotriazole compound represented by Formula (II). It has been found that a compound which is represented by Formula (II) gives a black image with a high image density.

Specific examples of the representative compounds T-1 to T-59, which are represented by Formula (II), and preferably used in the invention, are shown below.

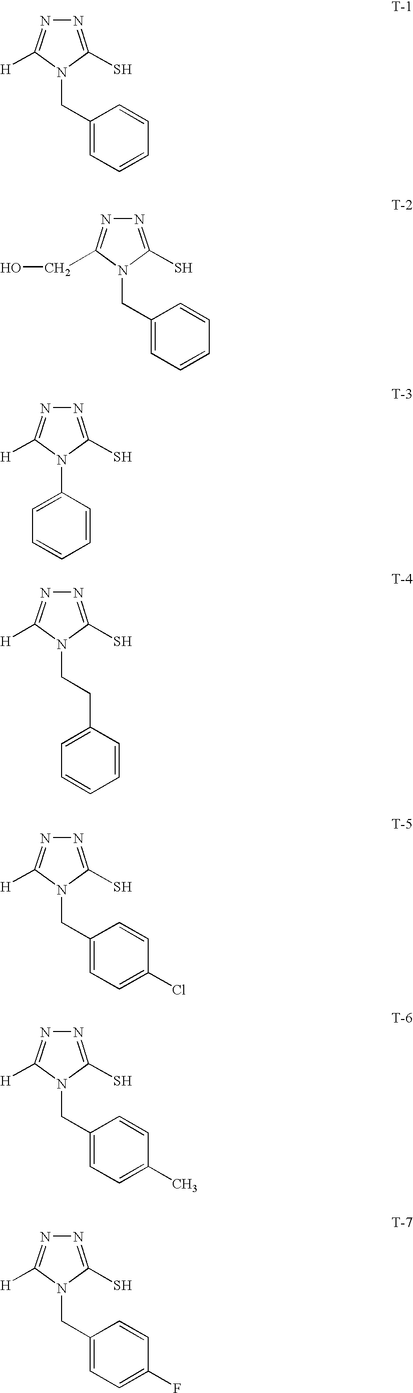

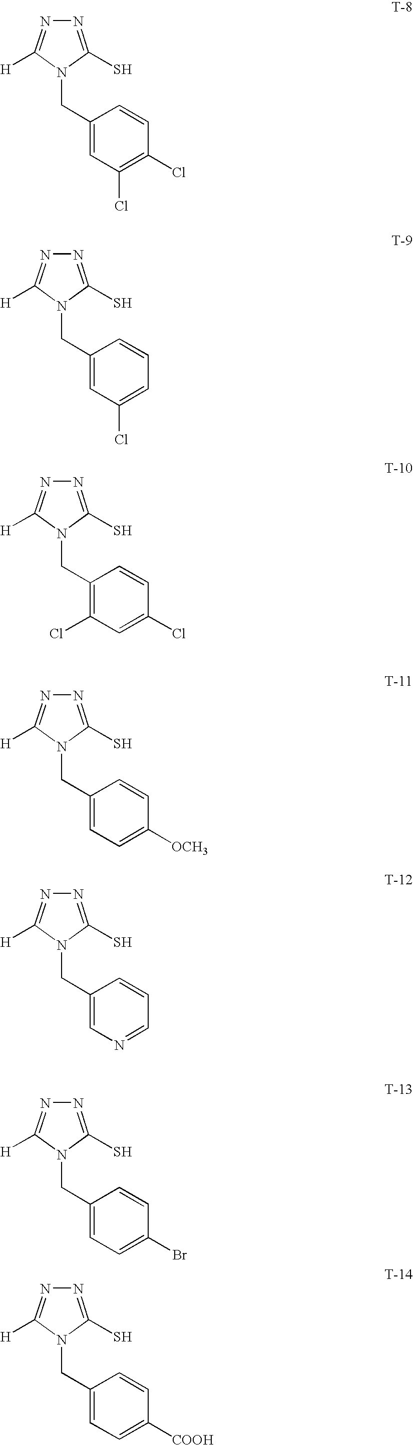

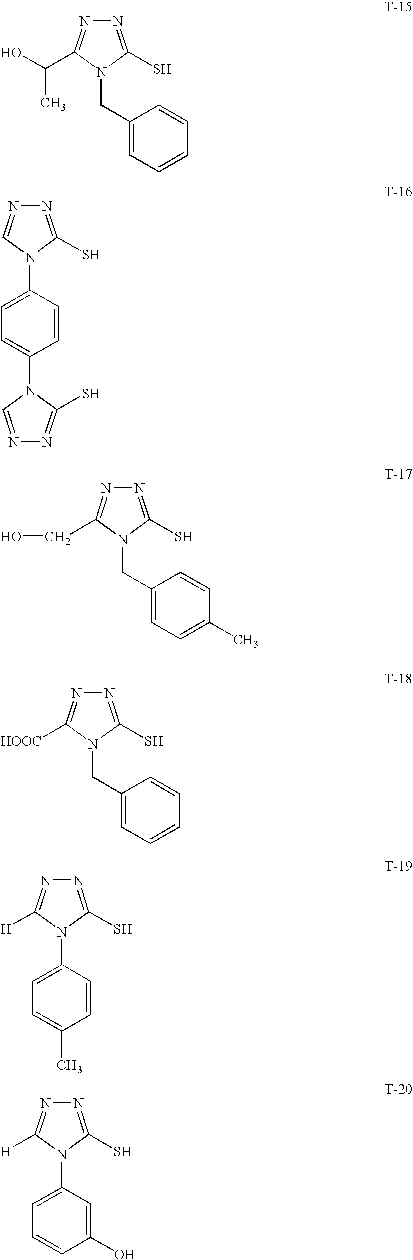

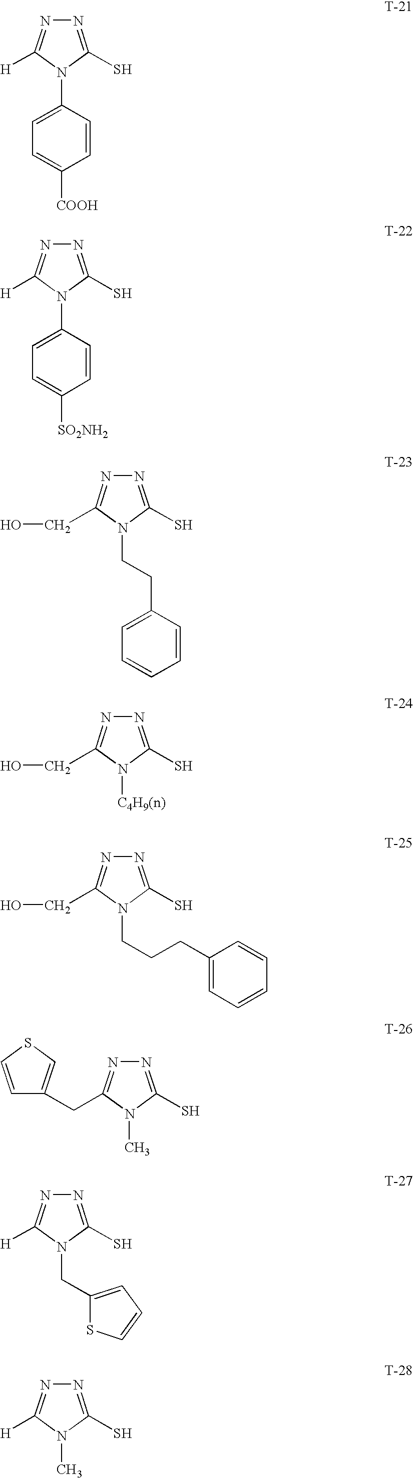

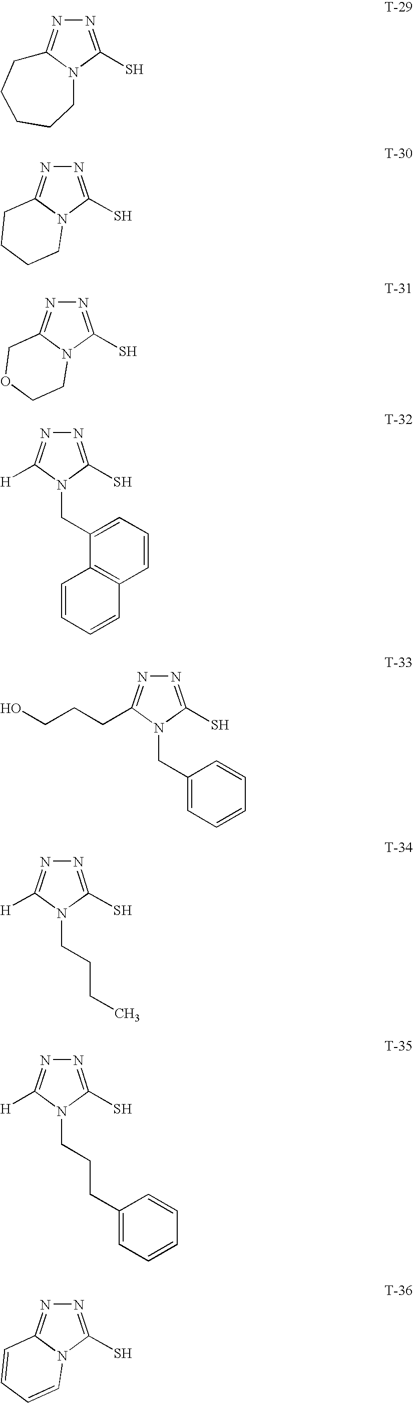

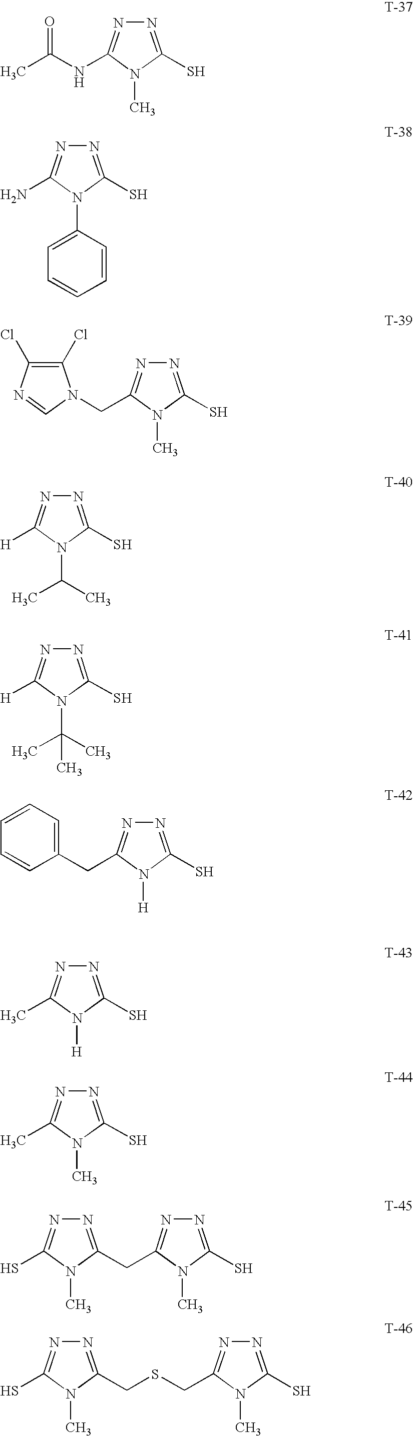

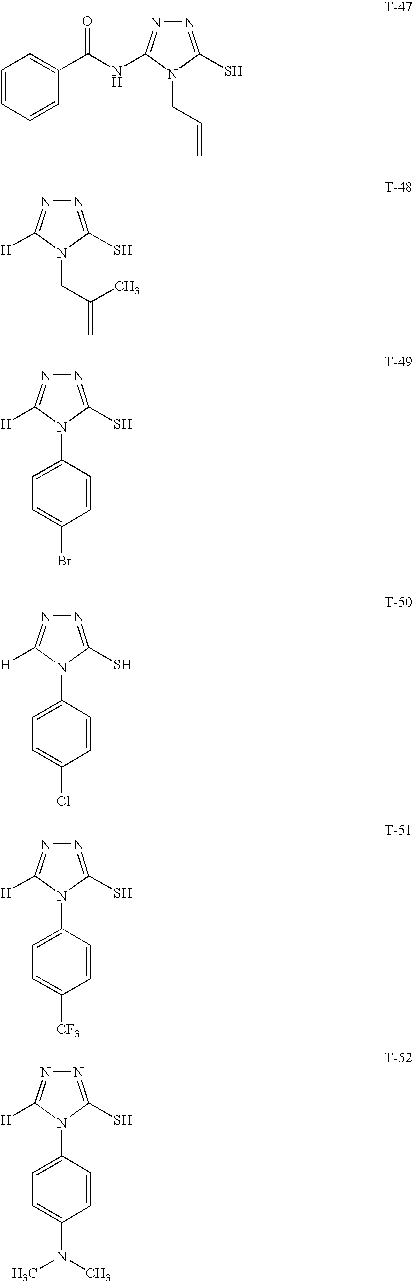

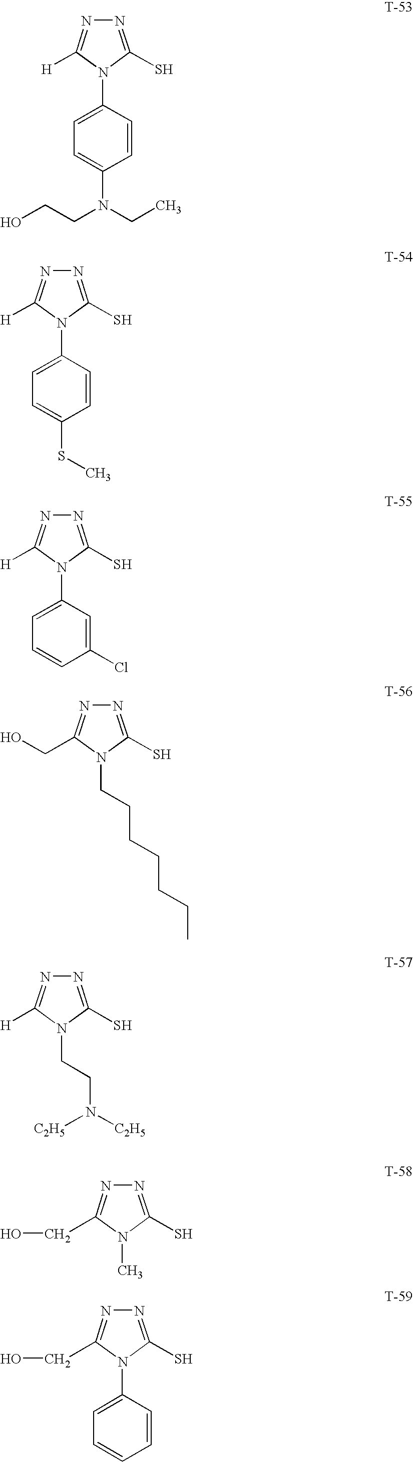

In the invention, T-1, T-2, T-3, T-1, T-12, T-16, T-37, T-41 and T-44 are more preferable. Particularly, T-1, T-2 and T-3 are preferable.

The mercaptotriazole color-toning agent as described herein uses a well-known synthesis method, and thus easily prepared. For example, Compound T-1 can be synthesized according to the description in U.S. Pat. No. 4,628,059 (by Finkelstein et. al.). Methods for synthesizing various mercaptotriaoles are described in U.S. Pat. No. 3,769,411 (by Greenfield et. al.), U.S. Pat. No. 4,183,925 (by Baxter et. al.) and U.S. Pat. No. 6,074,813 (by Asanuma et. al.), DE 1670604 (by Korosi), and Chemical Abstract 1968, 69, 52114j. Some mercaptotriazole compounds are commercially available.

As well known in the technical field, if required, two or more kinds of the mercaptotriazole compounds represented by Formula (II) may be employed, and plural color-toning agents may be located in a same layer of the photothermographic material, or in different layers of the photothermographic material respectively.

Further, phthalazine or a derivative thereof which are described in U.S. Pat. No. 6,146,822 can be used as a color-toning agent. Phthalazine or a derivative thereof can be used in combination with mercaptotriazole compound represented by Formula (II) as described above. Phthalazine or a derivative thereof can be used on any layer of any surface of the photosensitive material, such as a side of a surface on which the image-forming layer is formed and/or a side of a surface on which the back surface is formed.

Further, a conventional color-toning agent can be contained in addition to one or more of the above-described mercaptotriazole compounds. Such a compound is well known in the technologies of a photothermographic material, and examples thereof include those described in U.S. Pat. No. 3,080,254 (by Grant Jr.), U.S. Pat. No. 3,847,612 (by Winslow), U.S. Pat. No. 4,123,282 (by Winslow), U.S. Pat. No. 4,082,901 (by Laridon et. al.), U.S. Pat. No. 3,074,809 (by Owen), U.S. Pat. No. 3,446,648 (by Workman), U.S. Pat. No. 3,844,797 (by Willems et. al.), and U.S. Pat. No. 3,951,660 (by Hagemann et. al.), U.S. Pat. No. 5,599,647 (by Defieuw et. al.), and GB 1,439,478 (by Agfa).

Further, In carrying out the invention, a mixture of a mercaptotriazole compound and an additional color-toning agent (e.g., 3-mercapto-4-benzyl-1,2,4-triazole and phthalazine) is also preferable.

Generally, an amount of one or more of the color-toning agent used is preferably in a range of 0.01 mass % or more and 10 mass % or less, and more preferably 0.1 mass % or more and 10 mass % or less, relative to the total dry amount of the layer which includes the color-toning agent(s).

The color-toning agent may be added to the image-forming layer, or be contained in a layer adjacent to the image-forming layer (e.g., a protective overcoat layer or a “carrier layer” which resides lower than the image-forming layer). If the image-forming layer exists at both sides of a support, the color-toning agent may exist on both sides of the support.

2) Plasticizer and Lubricant

The plasticizer and the lubricant which can be used in the photosensitive layer of the invention are described in JP-A No. 11-65021, paragraph [0117]. Examples of the lubricant further include those described in JP-A No. 11-84573, paragraphs [0061] to [0064] and Japanese Patent Application No. 11-106881, paragraphs [0049] to [0062].

3) Dye and Pigment

The photosensitive layer in the invention may contain various dyes and/or pigments (e.g., C.I. Pigment Blue 60, C.I. Pigment Blue 64, or C.I. Pigment Blue 15:6) in view of improvement of color tone, inhibition of generation of interference fringe at the time of laser exposure, or inhibition of irradiation. Details of the dyes and pigments are described in WO98/36322, JP-A Nos. 10-268465 and 11-338098.

4) Nucleating Promoting Agent

A nucleating promoting agent may be added to the image-forming layer of the invention accompanying with the nucleating agent. Column [0102] in JP-A No. 1165021, and column [0194] to [0195] in JP-A No. 11-223898 include descriptions about the nucleating promoting agent.

An acid formed by hydration of diphosphorus pentaoxide or a salt thereof is preferably used as the nucleating promoting agent. Examples of the acid formed by hydration of diphosphorus pentaoxide or the salt thereof can include, for example, a meta-phosphoric acid (salt), a pyro-phosphoric acid (salt), an ortho-phosphoric acid (salt), a tri-phosphoric acid (salt), a tetra-phosphoric acid (salt), and a hexameta-phosphoric acid (salt). Particularly preferable examples of the acid formed by hydration of diphosphorus pentaoxide or the salt thereof include an ortho-phosphoric acid (salt) and a hexameta-phosphoric acid (salt). Examples of specific salts are sodium ortho-phosphate, sodium dihydrogen ortho-phosphate, sodium hexameta-phosphate and ammonium hexameta-phosphate.

An amount of the acid formed by hydration of the diphosphorus pentaoxide or the salt thereof to be used (namely, a coating amount of the acid or salt per 1 m² of the photosensitive material) may be adjusted to a desired amount corresponding to a performance such as sensitivity or fogging, and is preferably from 0.1 to 500 mg/m², and more preferably 0.5 to 100 mg/m².

Preparation and Coating of Coating Liquid

A temperature for a preparation of the image-forming layer coating liquid in the invention is preferably in a range of 30° C. to 65° C., more preferably in a range of 35° C. or 60° C., and still more preferably in a range of 35° C. to 55° C. Further, a temperature of the image-forming layer coating liquid just after an addition of the polymer latex is preferably kept in a range of 30° C. to 65° C.

2. Construction of the Photothermographic Material

The photothermographic material of the invention may be a one-sided photosensitive material having the image-forming layer on only one side of a support, or a double-sided photosensitive material having the image-forming layers on both sides of the support. In the following, the constitution layers other than the image-forming layer will be explained.

1) Surface Protective Layer

A surface protective layer can be disposed to the photothermographic material in the invention for a purpose of preventing adhesion of the image-forming layer. The surface protective layer may comprise a single layer or plural layers. The surface protective layer is described in columns Nos. 0119 to 0120 of JP-A No. 11-65021 and in JP-A No. 2000-171936.

The binder for the surface protective layer in the invention is preferably gelatin, and it is also preferred to use polyvinyl alcohol (PVA) alone or in combination with gelatin. Examples of utilizable gelatin include inert gelatin (for example, trade name: NITTA GELATIN 750, manufactured by Nitta Gelatin Inc.) and phthalized gelatin (for example, trade name: NITTA GELATIN 801, manufactured by Nitta Gelatin Inc.).

Examples of PVA include those described in column Nos. 0009 to 0020 of JP-A No. 2000-171936, and preferable examples of PVA include a completely saponified product PVA-105, a partially saponified products PVA-205 and PVA-335, and modified polyvinyl alcohol MP-203 (all trade names, manufactured by Kuraray Co.).

A coating amount of the polyvinyl alcohol (per 1 m² of the support) in a protective layer (namely, a coating amount of PVA per each protective layer) is preferably in a range of 0.3 g/m² to 4.0 g/m², and more preferably in a range of 0.3 g/m² to 2.0 g/m².

A total coating amount of the binders including a water-soluble polymer and a latex polymer (per 1 m² of the support) in a surface protective layer (namely, a coating amount of the binders per each surface protective layer) is preferably in a range of 0.3 g/m² to 5.0 g/m², and more preferably in a range of 0.3 g/m² to 2.0 g/m².

The silver halide photosensitive material and the photothermographic material of the invention may have an antihalation layer on a side far from an exposure light source with respect to the photosensitive layer. The antihalation layer is described in JP-A Nos. 11-65021, paragraphs [0123] to [0124], 11-223898, 9-230531, 10-36695, 10-104779, 11-231457, 11-352625 and 11-352626.

The antihalation layer contains an antihalation dye having absorption at an exposure wavelength. When the exposure wavelength is in the wavelength range of infrared light, an infrared ray-absorbing dye may be used as the antihalation dye. In this case, the dye preferably has no absorption in the visible light region.

When a dye having absorption in visible light region is used to prevent halation, it is preferable that the color of the dye does not substantially remain in the material after image formation. For this purpose, a means for causing decolorization by heat of thermal development is preferably used. In particular, it is preferable that a thermally decolorizable dye and a base precursor are contained in the non-photosensitive layer to allow the layer to function as the antihalation layer. Such a technique is described in JP-A No. 11-231457.

The amount of the decolorizable dye is determined according to application of the dye. Generally, the amount is such that an optical density (absorbance) measured at an objective desired wavelength is more than 0.1. The optical density is preferably 0.2 to 2. The amount of the dye to obtain such an optical density is generally about 0.001 g/m² to about 1 g/m².

The optical density after thermal development can be decreased to be 0.1 or lower by decolorizing the dye. Two or more kinds of decolorizable dyes may be used together in a thermally decolorizable recording material or the photothermographic material. Similarly, two or more kinds of base precursors may be used together.

In such a heat decolorization using these decolorizable dye and base precursor, it is preferable to use a material which can decrease a melting point by 3° C. or more when used together with the base precursor and which is described in, for example, JP-A No. 11-352626, such as diphenylsulfone, or 4-chlorophenyl(phenyl)sulfone from the viewpoint of thermal decolorizability.

3) Back Layer

The back layer applicable to the invention is described in JP-A No. 11-65021, paragraphs [0128] to [0130].

The photosensitive material and the photothermographic matrial of the invention may contain a colorant having an absorption maximum in a range of 300 nm to 450 nm in order to improve silver tone and reduce change of image over time. Such a colorant is described in JP-A Nos. 62-210458, 63-104046, 63-103235, 63-208846, 63-306436, 63-314535 and 1-61745, and Japanese Patent Application No. 11-276751. Such a colorant is usually contained in an amount of 0.1 mg/m² to 1 g/m², and is preferably contained in the back layer disposed on the side of the support which side is opposite the side having the photosensitive layer.

4) Support

A transparent support which can be used in the invention is preferably a polyester film which has been heated at a temperature in a range of 130 to 185° C. in order to relax internal strain remaining in the film during biaxial orientation and thereby eliminate heat shrinkage distortion that may occur during thermal development, particularly a polyethylene terephthalate film.

The support of the photothermographic material to be used together with an ultraviolet-luminescent screen is preferably PEN. However, the support is not restricted to the same. PEN is preferably polyethylene-2,6-naphthalate. Polyethylene-2,6-naphthalate in the invention may be any one in which a repeating structural unit is substantially rconstructed by an ethylene-2,6-naphthalenedicarboxylate unit, and includes not only non-copolymerized polyethylene-2,6-naphthalenedicarboxylate but also copolymers in which 10% or less, preferably 5% or less of the number of the repeating structural units are modified by other components, and mixtures and compositions including polyethylene-2,6-naphthalate and any other polymer.

Polyethylene 2,6-naphthalate is synthesized by bonding naphthalene-2,6-dicarboxylic acid or its functional derivative, and ethylene glycol or its functional derivative in the presence of a catalyst under suitable reaction conditions. Polyethylene 2,6-napthalate as referred to herein may be a copolymeri or a mixed polyester obtained by adding at least one kind of a suitable third component (modifier) to a reaction system before completion of polymerization of polyethylene 2,6-naphthalate. The suitable third component is a compound having a divalent ester-forming functional group, for example, dicarboxylic acids such as oxalic acid, adipic acid, phthalic acid, isophthalic acid, terephthalic acid, naphthalene-2,7-dicarboxylic acid, succinic acid or diphenyl ether dicarboxylic acid, or their lower alkyl esters, or oxycarboxylic acids such as p-oxybenzoic acid or p-oxyethoxybenzoic acid, or their lower alkyl esters, or dihydric alcohols, such as propylene glycol or trimethylene glycol. Polyethylene 2,6-naphthalate or its modified polymer may be a polymer whose terminal hydroxyl group(s) and/or carboxyl group(s) is blocked with a monofunctional compound such as benzoic acid, benzoylbenzoic acid or benzyloxybenzoic acid, methoxypolyalkylene glycol or may be a polymer which is modified with an extremely small amount of a trifunctional or tetrafunctional ester-forming compound, such as glycerin or pentaerythritol such that the resultant copolymer is substantially linear.

In the case of a photothermographic material for medical use, the transparent substrate may be colored with a blue dye (e.g., dye-1 described in Examples of JP-A No. 8-240877) or may be colorless.

Specific examples of the substrate are described in JP-A No. 11-65021, paragraph [0134].

An undercoat including a water-soluble polyester described in JP-A No. 11-84574, a styrene-butadiene copolymer described in JP-A No. 10-186565 or a vinylidene chloride copolymer described in JP-A No. 2000-39684 and Japanese Patent Application No. 11-106881, paragraphs [0063] to [0080] is preferably disposed on the substrate.

3. Other Additives

Additives which can be further included in each layer of the photosensitive material of the invention are explained below.

1) Matting Agent

The photosensitive material and the photothermographic material of the invention preferably contains a matting agent in the surface protective layer and the back layer in order to improve the conveying property of the material. The matting agent is described in JP-A No. 11-65021, paragraphs [0126] and [0127].

The coating amount of the matting agent is preferably from 1 mg to 400 mg, and more preferably from 5 mg to 300 mg per m² of the photosensitive material.

The matted degree of the image-forming layer surface may be any value as far as so-called “star defects”, which are missing portions formed in an image area and which cause leak of light, do not occur. However, Bekk smoothness of the surface is preferably from 30 seconds to 2000 seconds, and more preferably from 40 seconds to 1500 seconds. The Bekk smoothness can be easily determined by the publicly-known method for testing smoothness of paper and paperboard by Bekk tester or TAPPI standard method T479, which are incorporated by reference herein.

In the invention, as for the matted degree of the back layer, the Bekk smoothness of the back layer is preferably from 10 seconds to 1200 seconds, more preferably from 20 seconds to 800 seconds, and even more preferably from 40 seconds to 500 seconds.

In the invention, the matting agent is preferably incorporated in an outermost layer, a layer which acts as the outermost layer, a layer close to the outer surface of the photosensitive material, or a layer which acts as a so-called protective layer.

2) Polymer Latex

A polymer latex may be incorporated in the surface protective layer or the back layer in the invention.

The polymer latex is described in “Gosei Jushi Emulsion (Synthetic Resin Emulsion)”, compiled by Taira Okuda and Hiroshi Inagaki, published by Kobunshi Kanko Kai (1978); “Gosei Latex no Oyo (Application of Synthetic Latex)”, compiled by Takaaki Sugimura, Yasuo Kataoka, Souichi Suzuki and Keishi Kasahara, published by Kobunshi Kanko Kai (1993); and Soichi Muroi, “Gosei Latex no Kagaku (Chemistry of Synthetic Latex)”, published by Kobunshi Kanko Kai (1970). Specific examples thereof include a methyl methacrylate (33.5 mass %)/ethyl acrylate (50 mass %)/methacrylic acid (16.5 mass %) copolymer latex, a methyl methacrylate (47.5 mass %)/butadien (47.5 mass %)/itaconic acid (5 mass %) copolymer latex, an ethyl acrylate/methacrylic acid copolymer latex, a methyl methacrylate (58.9 mass %)/2-ethylhexyl acrylate (25.4 mass %)/styrene (8.6 mass %)/2-hydroxyethyl methacrylate (5.1 mass %)/acrylic acid (2.0 mass %) copolymer latex, methyl methacrylate (64.0 mass %)/styrene (9.0 mass %)/butyl acrylate (20.0 mass %)/2-hydroxyethyl methacrylate (5.0 mass %)/acrylic acid (2.0 mass %) copolymer latex.

The content of the polymer latex is preferably 10 mass % to 90 mass %, and more preferably 20 mass % to 80 mass % on the basis of the total amount of all the binders (including a water-soluble polymer and latex polymer) of the surface protective layer or the back layer.

3) Film Surface pH Adjusting Agent

The photothermographic material of the invention preferably has a film surface pH of 7.0 or less, more preferably 6.6 or less before thermal development. Although the lower limit thereof is not particularly limited, it is generally around 3. The pH is most preferably in the range or 4 to 6.2.

An organic acid such as phthalic acid derivatives, a nonvolatile acid such as sulfuric acid, or a volatile base such as ammonia is preferably used to control the film surface pH from the viewpoint of lowering of the film surface pH. In particular, ammonia is preferably used to achieve a low film surface pH, because it evaporates easily and therefore it can be removed before coating or thermal development.

In addition, a combined use of a nonvolatile base such as sodium hydroxide, potassium hydroxide or lithium hydroxide and ammonia is also preferable. A method for measuring the film surface pH is described in JP-A No. 2000-284399, paragraph [0123].

4) Hardening Agent

A hardening agent may be contained in each of the photosensitive layer, the protective layer and the back layer in the invention. The hardening agent is described in T. H. James “THE THEORY OF THE PHOTOGRAPHIC PROCESS FOURTH EDMON” Macmillan Publishing Co., Inc. 1977) pp. 77-87. The hardening agent is preferably chrome alum, 2,4-dichloro-6-hydroxy-s-triazine sodium salt, N,N-ethylenebis(vinylsulfonacetaride), N,N-propylenebis(vinylsulfonacetamide), polyvalent metal ions shown on page 78 of the above document, a polyisocyanate described in U.S. Pat. No. 4,281,060 and JP-A No. 6-208193, an epoxy compound described in U.S. Pat. No. 4,791,042 or a vinylsulfone compound described in JP-A No. 62-89048.

The hardening agent is added as a solution to a coating liquid. When the hargening agent is added to a protecting layer coating liquid, it is added during a period starting from 180 minutes before coating and ending immediately before coating, and preferably during a period starting from 60 minutes to 10 seconds before coating. A mixing method and mixing conditions are not particularly limited so long as the effects of the invention satisfactorily show.

Specific examples of the mixing method include a method of mixing in a tank such that an average residence period, calculated from an adding flow rate and a supplying flow rate to a coater, is allowed to be within a predetermined duration, and a method using a static mixer described, for example, in N. Harnby, M. F. Edwards & A. W. Nienow, (translated by Koji Takahashi), “Liquid Mixing Technology” Chap. 8, The Nikkan Kogyo Shimbun, Ltd. (1989)

5) Surfactant

A surfactant to be usable in the invention is described in JP-A 11-65021, paragraph [0132].

In the invention, a fluorine-containing surfactant is preferably used. Typical examples of the fluorine-containing surfactant include compounds described in JP-A Nos. 10-197985, 2000-19680 and 2000-214554. Further, a polymeric fluorine-containing surfactant described in JP-A No. 9-281636 is also preferably used. In the invention, use of the fluorine-containing surfactant described in Japanese Patent Application No. 2000-206560 is particularly preferable.

6) Antistatic Agent

The photosensitive material and the photothermographic material of the invention may have an antistatic layer including any known metal oxide or an electroconductive polymer. The antistatic layer may also serve as the undercoat layer, the back layer or the surface protective layer, or may be disposed separately from these layers. Techniques described in JP-A Nos. 11-65021, paragraph [0135], 56-143430, 56-143431, 58-62646, 56-120519 and 11-84573, paragraphs [0040] to [0051], U.S. Pat. No. 5,575,957 and JP-A 11-223898, paragraphs [0078] to [0084] may be applied to the antistatic layer.

7) Other Additives

The silver halide photosensitive material and the photothermographic material may further contain an antioxidant, a stabilizer, a plasticizer, an ultraviolet ray absorbent and/or a coating aid. One or more kinds of solvents described in JP-A No. 11-65021, paragraph [0133] may be added to these additives. Various kinds of additives are contained in at least one of the photosensitive layer and the non-photosensitive layer. For these, WO98/36322, EP-A No. 803764A1, JP-A Nos. 10-186567 and 10-186568 can be referred to.

4. Preparation of Photothermographic Material

1) Coating Method

The silver halide photosensitive material and the photothermographic material in the invention may be prepared by any coating method. Specific examples these include extrusion coating, slide coating, curtain coating, dip coating, knife coating, flow coating, and extrusion coating using a hopper as described in U.S. Pat. No. 2,681,294. The extrusion coating or slide coating as described by Stephen F. Kistler, Petert M. Schweizer, “LIQUID FILM COATING” (CHAPMAN & HALL, 1997), pp. 399 to 536 is preferably conducted, and the slide coating is particularly preferably conducted.

An example of the form of a slide coater used in the slide coating is illustrated in FIG. 11b.1 on page 427 of the same document. Further, at least two layers can be simultaneously formed in accordance with any of coating methods described in the same document, pages 399 to 536, U.S. Pat. No. 2,761,791 and British Patent No. 837,095, if necessary.

The organic silver salt-containing layer coating liquid in the invention is preferably a so-called thixotropic fluid. With regard to the technique, JP-A No. 11-52509 can be referred to.

The viscosity of the organic silver salt-containing layer coating liquid in the invention at a shear rate of 0.1 s⁻¹ is preferably from 400 mPa·s to 100,000 mPa·s, and more preferably from 500 mPa·s to 20,000 mPa·s.

Further, the viscosity thereof at a shear rate of 1000 s⁻¹ is preferably from 1 mPa·s to 200 mPa·s, and more preferably from 5 mPa·s to 80 mPa·s.

2) Packaging Material

It is preferable that the photosensitive material and the photothermographic material of the invention are hermetically packed by a packaging material having at least one of a low oxygen permeability and a low moisture permeability in order to prevent photographic properties thereof from being deteriorated at the time of storage before being used, or, when the photosensitive material and the photothermographic material are in roll form, prevent the material from being curled or curly deformed. The oxygen permeability is preferably 50 mL/atm/m²·day or less, more preferably 10 mL/atm/m²·day or less, and still more preferably 1.0 g/atm/m²·day or less at 25° C. The moisture permeability is preferably 10 g/atm/m²·day or less, more preferably 5 g/atm/m²·day or less, and still more preferably 1 g/atm/m²·day or less. Specific examples of the packing material having the low oxygen permeability and/or the moisture permeability include those described in JP-A Nos. 8-254793 and 2000-206653.

3) Other Applicable Techniques

Techniques which can be used in the photothermographic material of the invention are described in, for example, EP-A Nos. 803764A1 and 883022A1, WO98/36322, JP-A Nos. 56-62648, 58-62644, 9-43766, 9-281637, 9-297367, 9-304869, 9-311405, 9-329865, 10-10669, 10-62899, 1069023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, and 11-343420, Japanese Patent Application No. 2000-187298, JP-A Nos. 2001-200414, 2001-234635, 2002-20699, 2001-275471, 2001-275461, 2000-313204, 2001-292844, 2000-324888, 2001-293864, and 2001-348546.

4) Color Image Formation

A multicolor photothermographic material may have a combination of these two layers for each color, or may contain all components in a single layer as described in U.S. Pat. No. 4,708,928.

In the case of multicolor photothermographic materials, each image forming layer is generally disposed between the respective photosensitive layers (emulsion layers), as described in U.S. Pat. No. 4,460,681.

5) Black-and-White Photothermographic Material

The photothermographic material of the invention forms a black-and-white image by a silver image. Regardless of the presence of the color-toning agent, pure black tone is presented.

The average gradation in the invention is preferably 1.8 or more and 4.3 or less, and more preferably 2.0 or more and 4.0 or less. The gradation in the invention is defined as an inclination (tan θ when the angle between the straight line and the horizontal axis is taken as θ) of a straight line connecting two points at the fogging densities and the optical densities of 0.25 and 2.0, respectively on the characteristic curve. The characteristic curve refers to a D-logE curve wherein a common logarithm (logE) of the light exposure amount which is exposure energy is taken as a horizontal axis, and the optical density, in other words the photographic density (D) of the scattered light is taken as a vertical axis, the relationship between both of which is displayed.

In the invention, preferably a coating amount of silver is 2.0 g/m² or less and an optical density after thermal development is 2.5 or more, and more preferably a coating amount of silver is 1.8 g/m² or less and an optical density after thermal development is 2.7 or more.

5. Image Forming Method

5-1. Exposure

1) Laser Exposure

The exposure can be conducted with a He—Ne laser emitting red-to-infrared light, a semiconductor laser emitting red light, an Ar⁺, He—Ne or He—Cd laser emitting blue to green light, or a semiconductor laser emitting blue light. A semiconductor laser emitting red-to-infrared light is preferable, and a peak wavelength of the laser light is in a range of 600 to 900 nm, preferably in a range of 620 to 850 nm.

In recent years, a laser output apparatus of a short wavelength region is attracting particular attention, with development of an integrated module of an SHG (Second Harmonic Generator) element and a semiconductor laser, and of a blue light-emitting semiconductor laser. Since the blue light-emitting semiconductor laser is capable of recording a high-definition image and of achieving an increase in the recording density and stable output with a long service life, the demands for this laser is expected to increase. A peak wavelength of the blue laser light is preferably in a range of 300 to 500 nm, and particularly in a range of 400 to 500 nm.

A laser light which is oscillated in a vertical multi mode by a high frequency superposing method is also preferably used.

2) X-Ray Exposure

The photothermographic material of the invention may form an image by X-ray for purposes such as a medical diagnosis. The image forming method which uses X-ray includes the following steps:
(a) disposing the photothermographic material between a pair of X-ray intensifying screens to obtain an assembly for image formation;
(b) arranging a subject between the assembly and an X-ray source;
(c) irradiating the subject with X-rays having an energy level in a range of 25 kVp to 125 kVp;
(d) removing the photothermographic material from the assembly; and
(e) heating the removed photothermographic material at a temperature in a range of 90° C. to 180° C.

The photothermographic material for use in the assembly according to the invention is preferably such that an image obtained by stepwise exposing the photothermographic material with X-rays followed by thermal development thereof has a characteristic curve that is drawn on a rectangular coordinate in which the coordinate axis unit lengths of optical density (D) and light exposure logarithm (log E) are equal to each other, and in which characteristic curve an average gamma (γ) formed by a point, whose density is the sum of a minimum density (Dmin) and 0.1, and a point, whose density is the sum of the minimum density (Dmin) and 0.5, is from 0.5 to 0.9, and an average gamma (γ) formed by a point, whose density is the sum of the minimum density (Dmin) and 1.2, and a point, whose density is the sum of the minimum density (Dmin) and 1.6 is from 3.2 to 4.0. When the photothermographic material with the characteristic curve is used in an X-ray photographing system in the invention, an X-ray image having excellent photographic properties such as a remarkably extended leg and high gamma at a medium density area can be obtained. Because of the photographic properties, depiction becomes good in a low density region in which an X-ray transmission amount is small such as a mediastinum region or heart shadow, and images of the lung field region, where an X-ray transmission amount is large, have a density which can be easily seen, and contrast becomes good.

The photothermographic material having the above-described preferable characteristic curve can be easily produced by, for example, a method in which each of the image-forming layers on both sides is constructed by two or more layers of silver halide emulsion layers having different sensitivities. In particular, it is preferable to form the image-forming layers by using an emulsion having a high sensitivity in an upper layer and an emulsion having a low sensitivity and contrasty photographic characteristics in a lower layer. When the image-forming layer including such two layers is employed, the ratio of the sensitivity (sensitivity difference) of the silver halide emulsion of the upper layer to that of the lower layer is from 1.5 to 20, and preferably from 2 to 15. The ratio of the amount of the emulsion contained in the upper layer to that in the lower layer differs in accordance with sensitivity difference and covering power of emulsions to be used. Generally, the larger the sensitivity difference, the smaller the percentage of the amount of the emulsion having a high sensitivity. For example, when the sensitivity difference is two and the covering powers of the two emulsions are approximately the same, the ratio of the amount of the emulsion having a high sensitivity to that of the emulsion having a low sensitivity is preferably in the range of 1:20 to 1:50 in terms of silver amount.

For crossover cut (double-sided photosensitive material) and antihalation (single-sided photosensitive material), a dye, or a combination of a dye and a mordant described in line 1 in lower-left column of page 13 to line 9 in lower-left column in page 14 of JP-A No. 2-68539 may be employed.

Next, a fluorescent intensifying screen (radiation intensifying screen) in the invention will be described. The basic structure of the radiation intensifying screen has a support and a fluorescent substance layer disposed on one side of the support. In the fluorescent substance layer, a fluorescent substance is dispersed in a binder. A transparent protective coat is provided on the surface of the fluorescent substance layer opposite to the support (the surface not facing the support) to protect the fluorescent substance layer from chemical degenerations or mechanical impacts.

Preferable examples of the fluorescent substance used in the invention include tungstate fluorescent substance (e.g., CaWO₄, MgWO₄, and CaWO₄:Pb), terbium-activated rare earth oxysulfide fluorescent substance (e.g., Y₂O₂S:Tb, Gd₂O₂S:Tb, La₂O₂S:Tb, (Y,Gd)₂O₂S:Tb, and (Y,Gd)O₂S:Tb,Tm), terbium-activated rare earth phosphate fluorescent substance (e.g., YPO₄:Tb, GdPO₄:Tb, and LaPO₄:Tb), terbium-activated rare earth oxyhalide fluorescent substance (e.g., LaOBr:Tb, LaOBr:Tb,Tm, LaOCl:Tb, LaOCl:Tb,Tm, LaOBr:Tb, GdOBr:Tb, and GdOCl:Tb), thulium-activated rare earth oxyhalide fluorescent substance (e.g., LaOBr:Tm, and LaOCl:Tm), barium sulfate fluorescent substance (e.g., BaSO₄:Pb, BaSO₄:Eu²⁺, and (Ba,Sr)SO₄:Eu²⁺), bivalent europium-activated alkane earth metal phosphate fluorescent substance (e.g., (Ba₂PO₄)₂:Eu²⁺, and (Ba₂PO₄)₂:Eu²⁺), bivalent europium-activated alkaline earth metal fluorohalide fluorescent substance (e.g., BaFCl:Eu²⁺, BaFBr:Eu²⁺, BaFCl:Eu²⁺,Tb, BaFBr:Eu²⁺,Tb, BaF₂BaCl.KCl:Eu²⁺, and (Ba,Mg)F₂.BaCl.KCl:Eu²⁺), iodide fluorescent substance (e.g., CsI:Na, CsI:Tl, NaI, and KI:Tl), sulfide fluorescent substance (e.g., ZnS:Ag(Zn,Cd)S:Ag, (Zn,Cd)S:Cu, and (Zn,Cd)S:Cu,A), hafnium phosphate fluorescent substance (e.g., HfP₂O₇:Cu), YTaO₄, and YTaO₄ into which any activator is incorporated as an emission center. However, the fluorescent substance for use in the invention is not restricted to them, and any fluorescent substance that can emit light in the visible or near ultraviolet region due to irradiation of radiation may be employed.

The fluorescent intensifying screen used in the invention preferably packs the fluorescent substance in a graded grain diameter structure. Particularly, it is preferable that fluorescent substance grains having a large diameter is coated on a side of the screen on which the surface protective layer are formed, and fluorescent substance grains having a small diameter are coated on a side of the screen to which the support faces. A diameter of the fluorescent substance grains having a small diameter is preferably in a range of 0.5 to 2.0 μm, and a diameter of the fluorescent substance grains having a large diameter is preferably in a range of 10 to 30 μm.

As a method for forming an image on the photothermographic material of the invention, a method in which an image is formed by combining the same with a fluorescent substance having a principal peak at 400 nm or less can be preferably employed. A method in which an image is formed by combining the same with a fluorescent substance having a principal peak at 380 nm or less is more preferabale. Either the double-sided photosensitive material or the single-sided photosensitive material may be used as an assembly. As the screen having a principal fluorescent peak at 400 mm or less, screens described in JP-A No. 6-11804 and WO93/01521 are used, however the invention is not restricted to them. As techniques of crossover cut (double-sided photosensitive material) and antihalaton (single-sided photosensitive material), those described in JP-A No. 8-76307 can be used. As an ultraviolet absorbing dye, dyes described in JP-A No. 2001-144030 are particularly preferable.

5-2. Thermal Development

The photothermographic material of the invention may be developed by any method, and usually the photothermographic material imagewise exposed is heated and developed. The development temperature is preferably in a range of 90 80° C. to 250° C., and more preferably in a range of 100° C. to 140° C.

The development time is preferably in a range of 1 to 60 seconds, more preferably in a range of 5 to 30 seconds, and still more preferably in a range of 5 to 20 seconds.

A thermal development method is preferably a method using a plate heater. The thermal development method using the plate heater system is preferably a method described in JP-A No. 11-133572, in which a visible image is obtained by bring a photothermographic material having thereon a latent image into contact with a heating unit at the thermal development zone of a thermal developing apparatus. In the thermal developing apparatus, the heating unit has a plate heater and plural press rollers disposed along one surface of the plate heater, and thermal development is conducted by allowing the photothermographic material to pass through a nip portion formed between the press rollers and the plate heater. It is preferable that the plate heater is divided into two to six portions and the temperature of the top portion is set to be lower than that of the other portions by around 1° C. to 10° C.

Such method is also described in JP-A No. 54-30032, by which it becomes possible to remove moisture and an organic solvent contained in the photothermographic material out of the system and inhibit change in the shape of the support caused by rapid heating of the photothermographic material.

5-3. System

An example of a medical laser imager having a light exposure portion and a heat development portion is FUJI MEDICAL DRY IMAGER FM-DPL and DRYPIX 7000 (both trade names, manufactured by FujiFilm Medical CO., Ltd.). The imager is described in Fuji Medical Review, No. 8, pages 39-55, and techniques described therein can be utilized in the invention. Further, the photothermographic material can be used as a photothermographic material for laser imagers in “AD network”, which has been proposed by Fuji Medical System as a network system that conforms to the DICOM standard.

6. Applications of the Invention

The photothermographic material and photothermographic material including the photographic emulsion having a high silver iodide content of the invention form a black and white image based on a silver image and is preferably used as a photosensitive material for general purposes, a wet-type or photothermographic material for medical diagnosis, or a wet-type or photothermographic material for industrial purposes, a wet-type or photothermographic material for printing, or a wet-type or photothermographic material for COM.

### EXAMPLES

Hereinafter, the invention will be described in detail while referring Examples, however the invention is not restricted to them.

### Example 1

1. Preparation of PET Support

1) Film Formation

PET was made of terephthalic acid and ethylene glycol in an ordinary manner and had an intrinsic viscosity IV of 0.66 (measured in a mixture of phenol and tetrachloroethane at a weight ratio of 6/4 at 25° C.). This was pelletized, and the resultant was dried at 130° C. for 4 hours. The resultant was extruded out from a T-die, and rapidly cooled. Thus, a non-oriented film was prepared.

The film was longitudinally oriented by rolls rotating at different circumferencial speeds at 110° C. so that the longitudinal length thereof after the orientation was 3.3 times as long as the original longitudinal length thereof. Next, the film was laterally oriented by a tenter at 130° C. so that the lateral length thereof after the orientation was 4.5 times as long as the original lateral length thereof. Next, the oriented film was thermally fixed at 240° C. for 20 seconds, and then laterally relaxed by 4% at the same temperature. Next, the chuck portion of the tenter was slitted, and the both edges of the film were knurled, and the film was rolled up at 4 kg/cm². The rolled film having a thickness of 175 μm was obtained.

2) Corona Processing of Surface

Both surfaces of this support were processed at a rate of 20 n/minute at room temperature by using a solid state corona processing machine (trade name: 6 KVA MODEL, manufactured by Pillar Company). From values of current and voltage read at this time, it was found that the support had been processed at 0.375 kV·A·min/m². At this time, the processing frequency was 9.6 kHz, and a gap clearance between an electrode and a dielectric roll was 1.6 mm.

3) Undercoating

(1) Preparation of a Coating Liquid for an Undercoat Layer

| Formulation (1) (for an undercoat layer on the image-forming | | |
|---|---|---|
| layer side) | | |
| Polyester resin (trade name: PESRESIN A-520 (a 30 mass % | 46.8 | g |
| solution) (manufactured by Takamatsu Yushi Co.) | | |
| Copolyester resin dispersed in water (VYLONAL ® | 10.4 | g |
| MD-1200, manufactured by Toyobo Co., Ltd.) | | |
| 1 mass % solution of Polyethylene glycol monononylphenyl | 11.0 | g |
| ether (the average number of the ethylene oxide = 8.5) | | |
| PMMA polymer fine particles (average particle size = 0.4 μm) | 0.91 | g |
| (trade name: MP-1000, manufactured by Soken Chemical Co. | | |
| Ltd.) | | |
| Distilled water | 931 | ml |
| Formulation (2) (for a first layer on the back surface side) | | |
| Styrene-butadiene copolymer latex | 130.8 | g |
| (solid content: 40 mass %, styrene/butadiene weight | | |
| ratio = 68/32) | | |
| 8 mass % aqueous solution of sodium salt of 2,4-Dichloro-6- | 5.2 | g |
| hydroxy-S-triazine | | |
| 1 mass % aqueous solution of Sodium laurylbenzenesulfonate | 10 | ml |
| Polystyrene particle dispersion (the average particle size = | 0.5 | g |
| 2 μm, 20 mass %) | | |
| Distilled water | 854 | ml |
| Formulation (3) (for a second layer on the back surface side) | | |
| SnO₂/SbO (mass ratio = 9/1, the average particle size = | 84 | g |
| 0.5 μm, a 17 mass % dispersion) | | |
| Gelatin | 7.9 | g |
| Hydroxypropyl methylcellulose (a 2 mass % aqueous solution) | 10 | g |
| (trade name: METOLOSE TC-5, manufactured by Shin-etsu | | |
| Chemical Ltd.) | | |
| 1 mass % aqueous solution of Sodium | 10 | ml |
| dodecylbenzenesulfonate | | |
| NaOH (1 mass %) | 7 | g |
| Proxel (manufactured by Avecia Ltd.) | 0.5 | g |
| Distilled water | 881 | ml |

After conducting the above-mentioned corona discharge treatment on both sides of the above-mentioned biaxially oriented polyethylene terephthalate substrate having a thickness of 175 μm, the above-mentioned undercoating formulation (1) was applied on one side (the side on which the image-forming layer is formed) by a wire bar in a wet coating amount of 6.6 ml/m² (per one side) and dried for 5 minutes at 180° C. Then the above mentioned undercoating formulation (2) was applied to the opposite side (the back surface side) by a wire bar in a wet coating amount of 5.7 ml/m² and dried for 5 minutes at 180° C., and the above-mentioned undercoating formulation (3) was applied to the opposite side (the back surface side) by a wire bar in a wet coating amount of 8.4 ml/m² and dried for 6 minutes at 180° C., to thus provide an undercoating substrate.

2. Back Layer

1) Preparation of Back Layer Coating Liquid

Preparation of Dispersion of Solid Fine Particles (a) of Base Precursor

The base precursor-1 in an amount of 2.5 kg, and 300 g of a surfactant (trade name: DEMOL N, manufactured by Kao Corporation), 800 g of diphenyl sulfone, 1.0 g of benzoisothiazolinone sodium salt were mixed with distilled water to give the total amount of 8.0 kg and mixed. The mixed liquid was subjected to beads dispersion using a horizontal sand mill (trade name: UVM-2, manufactured by IMEX Co., Ltd.). Process for dispersion includes feeding the mixed liquid to the UVM-2 packed with zirconia beads having a mean particle diameter of 0.5 mm with a diaphragm pump, followed by the dispersion at the inner pressure of 50 hPa or higher until desired mean particle diameter could be achieved.

The dispersion was continued until the ratio of the optical density at 450 nm and the optical density at 650 nm for the spectral absorption of the dispersion (D₄₅₀/D₆₅₀) became 3.0 upon spectral absorption measurement. Thus resulting dispersion was diluted with distilled water so that the concentration of the base precursor becomes 25% by weight, and filtrated (with a polypropylene filter having a mean fine pore diameter of 3 μm) for eliminating dust to put into practical use.

Preparation of Dispersion of Solid Fine Particles of Dye

6.0 kg of cyanine dye compound-1, 3.0 kg of sodium p-dodecylbenzenesulfonate, 0.6 kg of a surfactant (trade name: DEMOL SNB, manufactured by Kao Corporation), and 0.15 kg of a defoaming agent (trade name: SURFYNOL 104E, manufactured by Nissin Chemical Industry Co., Ltd.) were mixed with distilled water to give a total amount of 60 kg. The mixed solution was subjected to dispersion with 0.5 mm zirconia beads using a horizontal sand mill (trade name: UVM-2, manufactured by IMEX Co., Ltd.).

The dispersion was dispersed until the ratio of the optical density at 650 nm and the optical density at 750 nm for the spectral absorption of the dispersion (D₆₅₀/D₇₅₀) becomes 5.0 or higher upon spectral absorption measurement. Thus resulting dispersion was diluted with distilled water so that the concentration of the cyanine dye becomes 6% by weight, and filtrated with a filter (mean fine pore diameter: 1 μm) for eliminating dust to put into practical use.

Preparation of Coating Liquid for Antihalation Layer

A vessel was kept at 40° C., and 40 g of gelatin, 20 g of monodispersed polymethyl methacrylate fine particles (mean particle size of 8 μm, standard deviation of particle diameter of 0.4), 0.1 g of benzoisothiazolinone and 490 mL of water are added thereto in order to dissolve the gelatin. Further, 2.3 mL of a 1 mol/L aqueous sodium hydroxide solution, 40 g of the dispersion solution of the solid fine particles of the dye, 90 g of the dispersion solution of the solid fine particles (a) of the base precursor, 12 mL of a 3% by weight aqueous solution of sodium polystyrenesulfonate, and 180 g of a 10% by weight solution of SBR latex were mixed thereto. Just prior to coating, 80 mL of a 4% by weight aqueous solution of N,N-ethylenebis(vinylsulfone acetamide) was mixed thereto in order to give a coating liquid for the antihalation layer.

2) Preparation of Coating liquid for Back Surface Protective Layer

A vessel was kept at 40° C., and 40 g of gelatin, 35 mg of benzoisothiazolinone and 840 mL of water were added thereto in order to dissolve the gelatin. Further, 5.8 mL of a 1 mol/L aqueous sodium hydroxide solution, 5 g of a 10% by weight emulsion of liquid paraffin, 5 g of a 10% by weight emulsion of trimethylolpropane trisostearate, 10 mL of a 5% by weight aqueous solution of di(2-ethylhexyl) sodium sulfosuccinate, 20 mL of a 3% by weight aqueous solution of sodium polystyrenesulfonate, a fluorocarbon surfactant (ZONYL® FSN-100, manufactured by Du Pont Co. Ltd.,: the added amount is described in following Table 1), and 32 g of a 19% by weight solution of methyl methacrylate/styrene/butyl acrylate/hydroxyethyl methacrylate/acrylic acid copolymer latex (weight ratio of the copolymerization: 57/8/28/5/2) are mixed thereto. Just prior to the coating, 25 mL of a 4% by weight aqueous solution of N,N-ethylenebis(vinylsulfone acetamide) was mixed thereto in order to give a coating liquid for the back surface protective layer.

Preparation of Coating Liquids-2 to 4 for a Back Surface Protective Layer

Coating liquids-2 to 4 for a back surface protective layer were prepared in the same manner as in the preparation of the coating liquid-1, except that the fluorine-containing surfactant was changed to a surfactant shown in Table 1.

3) Coating of Back Layer

The back surface side of the undercoated support as described above was subjected to simultaneous multilayer coating using the antihalation layer coating liquid and one of the coating liquids-1 to 4 for a back surface protective layer so that the coating liquid for the antihalation layer gives the coating amount of gelatin of 0.52 g/m², and so that the coating liquid for the back surface protective layer gives the coating amount of gelatin of 1.7 g/m², followed by drying to produce a back layer.

3. Image-Forming Layer, Intermediate Layer and Surface Protective Layer

3-1. Preparation of Coating Materials

1) Preparation of Silver Halide Emulsion

Preparation of Photosensitive Silver Halide Emulsion 1

A solution, obtained by adding 3.1 ml of a 1 mass % solution of potassium bromide, 3.5 ml of sulfuric acid having a concentration of 0.5 mol/L and 31.7 g of phthalated gelatin to 1421 ml of distilled water, was maintained at 30° C. under stirring in a stainless steel reaction vessel. Then, a solution A, which was formed by dissolving 22.22 g of silver nitrate in distilled water to give the total amount of 95.4 ml, and a solution B, which was formed by dissolving 15.3 g of potassium bromide and 0.8 g of potassium iodide in distilled water to give the total amount of 97.4 ml, were added to the solution under a constant flow rate over 45 seconds. Then 10 ml of a 3.5 mass % aqueous solution of hydrogen peroxide was added to the solution, to which 10.8 ml of a 10 mass % aqueous solution of benzimidazole was added. Then, a solution C formed by diluting 51.86 g of silver nitrate with distilled water to 317.5 ml and a solution D formed by diluting 44.2 g of potassium bromide and 2.2 g of potassium iodide with distilled water to 400 ml, were added to the solution in the reaction vessel, wherein the whole solution C was added under a constant flow rate over 20 minutes, and the solution D was added by a controlled double jet method at a constant pAg value of 8.1. At 10 minutes after the start of the addition of the solutions C and D, potassium hexachloroiridate (III) was added in an amount of 1×10⁻⁴ mole per 1 mole of silver. Further, at 5 seconds after the completion of the addition of the solution C, an aqueous solution of potassium hexacyanoferrate (II) was added in an amount of 3×10⁻⁴ mole per 1 mole of silver. Then pH value was adjusted to 3.8 with sulfuric acid of a concentration of 0.5 mol/L. Then stirring was terminated and precipitation/desalting/rinsing steps were executed. The pH value was adjusted to 5.9 with sodium hydroxide of a concentration of 1 mol/L, to thus provide a photosensitive silver halide dispersion having a pAg value of 8.0.

The above-mentioned photosensitive silver halide dispersion was maintained at 38° C. under stirring, to which 5 ml of a 0.34 mass % methanol solution of 1,2-benzoisothiazolin-3-one was added. 40 minutes later, the dispersion was heated to 47° C. At 20 minutes after the temperature elevation, sodium benzenethiosulfonate in methanol was added in an amount of 7.6×10⁻⁵ mole per 1 mole of silver. Then after further 5 minutes, a tellurium sensitizer C in methanol was further added in an amount of 2.9×10⁻⁴ mole per 1 mole of silver, and a ripening was executed for 91 minutes. Thereafter, a spectral sensitizing dye A and a sensitizing dye B with a molar ratio of 3:1 in methanol were added in an amount of 1.2×10⁻³ mole per 1 mole of silver in terms of the sum of the amounts of the sensitizing dyes A and B. One minute later, 1.3 ml of a 0.8 mass % methanol solution of N,N′-dihydroxy-N″-diethylmelamine was added. After further 4 minutes, 5-methyl-2-mercaptobenzimidazole in methanol in an amount of 4.8×10⁻³ mole per 1 mole of silver, 1-phenyl-2-heptyl-5-mercapto-1,3,4-triazole in methanol in an amount of 5.4×10⁻³ mole per 1 mole of silver, and 13-methylureidophenyl)-5-mercaptotetrazole in water in an amount of 8.5×10⁻³ mole per 1 mole of silver, were added, to thus prepare a photosensitive silver halide emulsion 1.

Thus prepared photosensitive silver halide emulsion included silver iodobromide grains having an average sphere-corresponding diameter of 0.042 μm and a variation factor of the sphere-corresponding diameter of 20% and uniformly containing iodine in 3.5 mol %. The grain size and the like were determined from the average for 1000 grains, utilizing an electron microscope. The grains had a {100} plane ratio of 80%, as determined by a Kubelka-Munk method.

Preparation of Photosensitive Silver Halide Emulsion 2

A photosensitive silver halide emulsion 2 was prepared in the same manner as the photosensitive silver halide emulsion 1, except that the solution temperature at grain formation was changed from 30° C. to 47° C., that the solution B was prepared by diluting 15.9 g of potassium bromide with distilled water to 97.4 ml, that the solution D was prepared by diluting 45.8 g of potassium bromide with distilled water to 400 ml, that the solution C was added over 30 minutes, and that potassium hexacyanoferrate (II) was not used. The precipitation, desalting, washing with water, and dispersion were executed in the same manner as in the preparation of the photosensitive silver halide emulsion 1. Thereafter the spectral sensitization, chemical sensitization and additions of 5-methyl-2-mercaptobenzimidazole and 1-phenyl-2-heptyl-5-mercapto-1,3,4-triazole were conducted in the same manner as in the silver halide emulsion 1 except that the addition amount of the tellurium sensitizer C was changed to an amount of 1.1×10⁻⁴ mole per 1 mole of silver, that the spectral sensitizing dye A and the spectral sensitizing dye B with a molar ratio of 3:1 in methanol were added in an amount of 7.0×10⁻⁴ mole per 1 mole of silver in terms of the sum of the amounts of the sensitizing dyes A and B, that the addition amount of 1-phenyl-2-heptyl-5-mercapto-1,3,4-triazole was changed to 3.3×10⁻³ mole per 1 mole of silver, and that the addition amount of 1-(3-methylureidophenyl)-5mercaptotetrazole was changed to 4.7×10⁻³ mole per 1 mole of silver, to thus provide a photosensitive silver halide emulsion 2.

The photosensitive silver halide emulsion 2 included pure silver bromide cubic grains having an average sphere-corresponding diameter of 0.080 μm and a variation factor of the sphere-corresponding diameter of 20%.

Preparation of Photosensitive Silver Halide Emulsion 3

A photosensitive silver halide emulsion 3 was prepared in the same manner as the photosensitive silver halide emulsion 1, except that the solution temperature at grain formation was changed from 30° C. to 27° C. The precipitation/desalting/washing with water/dispersion were executed in the same manner as in the preparation of the photosensitive silver halide emulsion 1. A photosensitive silver halide emulsion 3 was obtained in the same manner as that in the case of the emulsion 1, except that the spectral sensitizing dye A and the sensitizing dye B in a molar ratio of 1:1 were added as a solid dispersion (in aqueous gelatin solution) in an amount of 6×10⁻³ mole per 1 mole of silver in terms of the sum of the sensitizing dyes A and B, that the addition amount of the tellurium sensitizer C was changed to 5.2×10⁻⁴ mole per 1 mole of silver, and that bromoauric acid in an amount of 5×10⁻⁴ mole per 1 mole of silver and potassium thiocyanate in an amount of 2×10⁻³ mole per 1 mole of silver were added three minutes after the addition of the tellurium sensitizer.

The photosensitive silver halide emulsion 3 included silver iodobromide grains having an average sphere-corresponding diameter of 0.034 μm and a variation factor of the sphere-corresponding diameter of 20%, uniformly containing 3.5 mol % of iodine.

Preparation of Mixed Emulsion A for Coating Liquid

The photosensitive silver halide emulsion 1 by 70 mass %, the photosensitive silver halide emulsion 2 by 15 mass % and the photosensitive silver halide emulsion 3 by 15 mass % were dissolved, and benzothiaolium iodide in the form of a 1 mass % aqueous solution was added in an amount of 7×10⁻³ mole per 1 mole of silver.

Further, as a compound whose a 1-electron oxidized form, formed by a 1-electron oxidation, is capable of releasing 1 or more electrons, compounds 1, 2 and 3 were added respectively in an amount of 2×10⁻³ mole per 1 mole of silver of the photosensitive silver halide.

Each of the redox compounds 1 and 2 having an adsorptive group and a reducing group was added in an amount of 5×10⁻³ mole per 1 mole of the photosensitive silver halide.

Then water was added so as to obtain a silver halide content corresponding to 38.2 g of silver per 1 kg of the mixed emulsion for the coating liquid, and 13-methylureidophenyl)-5-mercaptotetrazole was added in an amount of 0.34 g per 1 kg of the mixed emulsion for the coating liquid.

2) Preparation of Non-photosensitive Organic Silver Salt Dispersion

Preparation of Non-Photosensitive Organic Silver Salt Dispersion-1

85 g of lime-related gelatin, 25 g of phthalated gelatin, 2 liters of ion-exchange water were added to a reaction vessel, and the mixture was stirred (Solution A). 185 g of benzotriazole, a solution including 1405 ml of ion-exchange water (solution B), and 680 g of 2.5 N sodium hydroxide were prepared. The solution in the reaction vessel was adjusted to pAg 7.25 and pH 8.0 by addition of the solution B and a 2.5 M sodium hydroxide solution, if necessary, and it was maintained at 36° C.

A solution (C) comprising 228.5 g of silver nitrate and 1222 ml of ion-exchange water was added at an accelerated flow rate (a flow rate=16(1+0.002 t²) ml/min, and t represents time in minutes) to the reaction vessel, the solution B was added simultaneously while maintaining the pAg of 7.25. At the time of completion of the addition of the solution C, the process was finished, and a solution D comprising 80 g of phthalated gelatin and 700 ml of ion-exchange water was added at 40° C. The obtained reaction solution was stirred and adjusted to a pH of 2.5 by addition of 2 M sulfuric acid to aggregate a silver salt emulsion. The solution was twice washed with 5 liters of ion-exchange water, adjusted to pH 6.0 and pAg 7.0 by addition of a 2.5 M sodium hydroxide solution and a solution B, and then re-dispersed. The obtained silver salt dispersion contained the fine crystals of benzotriazole silver.

Preparation of Non-Photosensitive Organic Silver Salt Dispersion-2

49.49 g of 1-phenyl-5-mercaptotetrazole was added to a 2 mass % of gelatin solution comprising 1200 mL of water and 900 mL of methanol. The mixture was kept warmed at 35° C., to which 700 mL of an aqueous solution comprising 39 g of silver nitrate was added. Then, when starting addition of an aqueous silver nitrate solution, simultaneously 120 mL of an aqueous 2 N sodium hydroxide solution was added once in a portion. The pH of the reaction solution was 2.6 after completing addition of the silver nitrate. The pH of the solution comprising the silver salt was adjusted for precipitation to remove the excessive salts, and then the pH was adjusted to 8.1 to obtain a dispersion.

3) Preparation of Hydrogen Bonding Compound Dispersion

10 kg of water was added to 10 kg of hydrogen bonding compound-1 (tri(4-t-butylphenyl)phosphineoxide) and 16 kg of a 10 mass % aqueous solution of modified polyvinyl alcohol (trade name: POVAL MP203, manufactured by Kuraray Co., Ltd.,), and thoroughly mixed to give a slurry. This slurry was fed with a diaphragm pump, and was subjected to dispersion with a horizontal sand mill (trade name; UVM-2, manufactured by IMEX Co., Ltd.) packed with zirconia beads having a mean particle diameter of 0.5 mm for 4 hours. Thereafter, 0.2 g of a benzoisothiazolinone sodium salt and water were added thereto, thereby adjusting the concentration of the hydrogen bonding compound to be 25% by weight. This dispersion is warmed at 40° C. for one hour, followed by a subsequent heat treatment at 80° C. for one hour to obtain hydrogen bonding compound-1 dispersion. Particles of the hydrogen bonding compound included in the resulting hydrogen bonding compound dispersion had a median diameter of 0.45 μm, and a maximum particle diameter of 1.3 μm or less. The resultant hydrogen bonding compound dispersion was subjected to filtration with a polypropylene filter having a pore size of 3.0 μm to remove foreign substances such as dust, and stored.

4) Preparation of Development Accelerator-1 Dispersion

10 kg of water was added to 10 kg of development accelerator-1 and 20 kg of a 10% by weight aqueous solution of modified polyvinyl alcohol (trade name: POVAL MP203, manufactured by Kuraray Co., Ltd.,), and thoroughly mixed to give a slurry. This slurry was fed with a diaphragm pump, and was subjected to dispersion with a horizontal sand mill (trade name: UVM-2, manufactured by IMEX Co., Ltd.) packed with zirconia beads having a mean particle diameter of 0.5 mm for 3 hours and 30 minuets. Thereafter, 0.2 g of a benzoisothiazolinone sodium salt and water were added thereto, thereby adjusting the concentration of the development accelerator to be 20% by weight. Accordingly, development accelerator-1 dispersion was obtained. Particles of the development accelerator included in the resulting development accelerator dispersion had a median diameter of 0.48 μm, and a maximum particle diameter of 1.4 μm or less. The resultant development accelerator dispersion was subjected to filtration with a polypropylene filter having a pore size of 3.0 μm to remove foreign substances such as dust, and stored.

Each of solid dispersions of development accelerator-2 and color toning agent-1 was dispersed in the same manner as that of the development accelerator-1, and respectively resulted in 20 mass % and 15 mass % dispersion liquid.

5) Preparation of Binder Solution

Preparation of Binder Solution-1 (Binder of the Invention)

Water and gelatin powders were mixed to a desired concentration for using gelatin as a binder, and allowed to stand for 1 hour in order to swell gelatin, and the temperature was adjusted to 40° C. to obtain a gelatin solution.

5) Preparation of Binder Solution-2 (Comparative Binder)

SRB latex was prepared in the following process.

A polymerization tank of a gas monomer reaction apparatus (trade name: TAS-2J, manufactured by Taiatsu Techno Corporation), was charged with 287 g of distilled water, 7.73 g of a surfactant (trade name: PIONIN A43-S, manufactured by Takemoto Oil & Fat Co., Ltd.,: solid matter content thereof is 48.5 mass %), 14.06 mL of 1 mol/L sodium hydroxide, 0.15 g of tetrasodium salt of ethylenediamine tetraacetate, 255 g of styrene, 11.25 g of acrylic acid, and 3.0 g of tert-dodecyl mercaptan, followed by sealing of the reaction vessel and stirring at a stirring rate of 200 rpm. Degassing was conducted with a vacuum pump, followed by repeating nitrogen gas replacement several times. Thereto 108.75 g of 1,3-butadiene was injected, and the inner temperature was elevated to 60° C. Further, a solution of 1.875 g of ammonium persulfate dissolved in 50 mL of water was added thereto, and the mixture was stirred for 5 hours as it stood. The temperature was further elevated to 90° C., followed by stirring for 3 hours. After completing the reaction, the inner temperature was lowered to reach to the room temperature, and thereafter the mixture was treated by adding 1 mol/L sodium hydroxide and ammonium hydroxide to give the molar ratio of Na⁺ ion: NH₄⁺ ion being 1:5.3, and thus, the pH of the mixture was adjusted to 8.4. Thereafter, filtration with a polypropylene filter having the pore size of 1.0 μm was conducted to remove unintended substances such as dust followed by storage. Accordingly, SBR latex was obtained in an amount of 774.7 g. Upon the measurement of halogen ion by ion chromatography, concentration of chloride ion was revealed to be 3 ppm. As a result of the measurement of the concentration of the chelating agent by high performance liquid chromatography, it was revealed to be 145 ppm.

The aforementioned latex had a mean particle diameter of 90 nm, Tg of 17° C., solid matter concentration of 44% by weight, the equilibrium moisture content at 25° C. and 60% RH of 0.6% by weight, ionic conductance of 4.80 mS/cm (measurement of the ionic conductance performed using a conductivity meter (trade name: CM-30S, manufactured by Toa Electronics Ltd.) for the latex stock solution (44% by weight) at 25° C.) and pH of 8.4. The solution of the SRB latex was named as binder solution-2.

The above mentioned binder solutions 1 and 2 can be mixed in a suitable ratio and used. The mixing ratio was shown in Table 1.

6) Preparation of Pigment-1 Dispersion

64 g of C.I. Pigment Blue 60, 6.4 g of a surfactant (trade name: DEMOL N, manufactured by Kao Corp.) and 250 g of water were added and mixed well to obtain a slurry. The slurry was put in a vessel together with 800 g of zirconia beads having an average diameter of 0.5 mm, and then dispersed for 25 hours by a disperser (trade name: 1/4G sand grinder mill, manufactured by Imex Co.), to which water was added to give a concentration of the pigment of 5 mass %, thereby obtaining a pigment-1 dispersion. The pigment particles contained in thus obtained pigment dispersion had an average particle size of 0.21 μm.

7) Preparation of Various Solutions

Preparation of Reducing Agent Solution

A 20 mass % aqueous solution of ascorbic acid was prepared.

Preparation of Color-Toning Agent Solution

Dispersions of compounds No. T-59 and T-3 were prepared as color-toning agent dispersion as follows.

4 g of a triazole compound T-59 (5-hydroxymethyl-4-benzyl-1,2,4-triazole-3-thiol) and 18 ml of a 10 mass % solution of polyvinylpyrrolidone in ion-exchange water were sufficiently mixed to obtain a slurry. The slurry was fed by a diaphragm pump, then dispersed for 3 hours by a horizontal sand mill (trade name: UVM-2, manufactured by Imex Co.) filled with zirconia beads of an average diameter of 0.5 mm. To this dispersion, 15 g of 30 mass % of lime-treated gelatin was added, and the mixture was heated to 50° C. to obtain a dispersion of mercaptotriazole T-59 fine particles.

A dispersion of a triazole compound No. T-3 (4-benzyl-1,2,4-triazole-3-thiol) was similarly prepared.

Preparation of Mercapto Compound Solution

7 g of a mercapto compound-1 (1-(3-sulfophenyl)-5-mercaptotetrazole sodium salt) was dissolved in 993 g of water to obtain a 0.7 mass % aqueous solution.

20 g of a mercapto compound-2 (1-(3-methylureidophenyl)-5-mercaptotetrazole) was dissolved in 980 g of water to obtain a 2.0 mass % aqueous solution.

Preparation of Aqueous Thermal Solvent Solution

Preparation of Aqueous Thermal Solvent Solution-1

A 5 mass % aqueous solution of 1,3-dimethylurea was prepared.

Preparation of Aqueous Thermal Solvent Solution-2

A 10 mass % aqueous solution of succinimide was prepared.

3-2. Preparation of Coating Liquid

1) Preparation of Coating Liquid for Image-Forming Layer

Preparation of Coating Liquid-1 for Image-Forming Layer

To 1000 g of the above obtained non-photosensitive organic silver salt dispersion-1, the binder solution-1, the pigment-1 dispersion, the hydrogen bonding compound-1 dispersion, the development accelerator-1 dispersion, the development accelerator-2 dispersion, the color tone controller-1 dispersion, the reducing agent solution, the color-toning agent solution-1, the color-toning agent solution-2, the aqueous mercapto compound solution, the aqueous thermal solvent solution-1, the aqueous thermal solvent solution-2 were sequentially added, to which the silver halide mixed emulsion A was added in an amount of 0.22 mole per 1 mole of the non-photosensitive organic silver salt and mixed well immediately before coating, and thus obtained coating liquid-1 for the image-forming layer was directly supplied to a coating die. Each of the addition amounts was adjusted to the amount as described below.

Coating Liquids-2 to 4 for the Image-Forming Layer

Coating liquids-2 to 4 for the image-forming layer were prepared in the same manner as the coating liquid-1 for the image-forming layer, except that the non-photosensitive organic silver salt dispersion-2 was used instead of the non-photosensitive organic silver salt dispersion-1, and that any one of the binder solution-2 and a mixture thereof was used instead of the binder solution-1.

2) Preparation of Coating Liquid for Intermediate Layer

772 g of a 10 mass % aqueous solution of polyvinyl alcohol (trade name: PVA-205, manufactured by Kuraray Co.), 5.3 g of the pigment-1 dispersion, 226 g of a 27.5 mass % latex solution of methyl methacrylate/styrene/butyl acrylate/hydroxyethyl methacrylate/acrylic acid copolymer (copolymerizing weight ratio: 64/9/20/5/2), 2 ml of a 5 mass % aqueous solution of dioctyl sodium sulfosuccinate (trade name: AEROSOL OT, manufactured by American Cyanamide Inc.), 10.5 ml of a 20 mass % aqueous solution of diammonium phthalate and water to give the total amount of 880 g were mixed and then the pH was adjusted to 7.5 with NaOH to obtain an intermediate layer coating liquid, which was supplied to a coating die at such a rate that the coated amount became 10 ml/m².

3) Preparation of Coating Liquid for First Layer of Surface Protective Layer

64 g of inert gelatin was dissolved in water, and 80 g of a 27.5 mass % latex solution of methyl methacrylate/styrene/butyl acrylate/hydroxyethyl methacrylate/acrylic acid copolymer (copolymerizing weight ratio: 64/9/20/5/2), 23 ml of a 10 mass % methanol solution of phthalic acid, 23 ml of a 10 mass % aqueous solution of 4-methylphthalic acid, 28 ml of 0.5 mol/L sulfuric acid, 5 ml of a 5 mass % aqueous solution of dioctyl sodium sulfosuccinate (trade name: AEROSOL OT, manufactured by American Cyanamide Inc.), 0.5 g of phenoxyethanol, 0.1 g of benzoisothiazolinone and water to give the total amount of 750 g were mixed to obtain a coating liquid, and to the solution was added 26 ml of a 4 mass % solution of chrome alum, which was mixed by a static mixer immediately before coating and supplied to a coating die at such a rate that the coated amount became 18.6 ml/m².

4) Preparation of Coating Liquid for Second Layer of Surface Protective Layer

Preparation of Coating Liquid-1 for Second Layer of Surface Protective Layer

80 g of inert gelatin was dissolved in water, and 102 g of a 27.5 mass % latex solution of methyl methacrylate/styrene/butyl acrylate/hydroxyethyl methacrylate/acrylic acid copolymer (copolymerizing weight ratio: 64/9/20/5/2), a fluorine-containing surfactant (ZONYL® FSN-100; the amount thereof is shown in Table 1), 23 ml of a 5 mass % methanol solution of dioctyl sodium sulfosuccinate (trade name: AEROSOL OT, manufactured by American Cyanamide Inc.), 4 g of polymethyl methacrylate fine particles (average particle size: 0.7 μm), 21 g of polymethyl methacrylate fine particles (average particle size: 4.5 μm), 1.6 g of 4-methyl phthalic acid, 4.8 g of phthalic acid, 44 ml of 0.5 mol/L sulfuric acid, 10 mg of benzoisothiazolinone and water to give the total amount of 650 g were mixed, and to the mixture was added a 445 ml of an aqueous solution comprising a 4 mass % solution of chromium alum and 0.67 mass % phthalic acid, which was mixed by a static mixer immediately before coating to obtain a coating liquid for the second surface protective layer, and the solution was supplied to a coating die at such a rate that the coated amount became 8.3 ml/m².

Preparation of Coating Liquids-2 to 4 for Second Layer of Surface Protective Layer

Coating liquids-2 to 4 for the second layer of the surface protective layer were prepared in the same manner as the coating liquid-1 for the second layer of the surface protective layer, except that instead of a fluorine-containing surfactant (ZONYL® FSN-100), the surfactants shown in Table 1 were used.

3-3. Coating

Simultaneous multi-layer coating was sequentially performed with any of the coating liquids-1 to 4 for the image-forming layer, the coating liquid for the intermediate layer, the coating liquid for the first layer of the surface protective layer and the coating liquids-1 to 4 for the second layer of the surface protective layer.

The coating amount (g/m²) of each compound in the image-forming layer was as follows.

| | |
|---|---|
| Non-photosensitive organic silver salt (as Ag) | 1.4 |
| Binder (described in Table 1) | 3.0 |
| Pigment (C.I. Pigment Blue 60) | 0.036 |
| Color-toning agent-1 (mercaptotriazole T-59 as described above) | 0.05 |
| Color-toning agent-2 (mercaptotriazole T-3 as described above) | 0.05 |
| Ascorbic acid | 1.1 |
| Hydrogen bonding compound-1 | 0.15 |
| Development accelerator-1 | 0.019 |
| Development accelerator-2 | 0.016 |
| Color tone controlling agent-1 | 0.006 |
| Antifogging agent | 0.10 |
| Mercapto compound-1 | 0.001 |
| Mercapto compound-2 | 0.003 |
| Thermal solvent-1: 1,3-dimethylurea | 0.24 |
| Thermal solvent-2: succinimide | 0.08 |
| Silver halide (as Ag) | 0.31 |

4. Evaluation of Performance
4-1. Preparation

An obtained sample was cut into a half size (43 cm×35 cm), packed in the following packaging material in an environment of 25° C. and 50% RH, and then stored at a normal temperature for 2 weeks.

Packaging Material

The packaging material used in the evaluation had a laminate structure of: PET (10 μm)/PE (12 μm)/aluminum foil (9 μm)/Ny (15 μm)/polyethylene containing 3 mass % of carbon (50 μm), and had properties of:
Oxygen permeation rate: 0.02 ml/atm·m²·25° C.·day;
Moisture permeation rate: 0.10 g/atm·m² ·25° C.·day.
   Exposure and Thermal Development

Photothermographic Materials-1 to 15 were exposed by a dry laser imager equipped with a 660 nm semiconductor laser having a maximum output of 50 mW (IIIB) (trade name: DRYPIX7000, manufactured by Fuji Medical Co.) and subjected to a thermal development (for 24 seconds in total with three panels set at 107° C.-121° C.-121° C.), and the obtained image was evaluated with a densitometer.

4-2. Evaluation of Photography Performance

Evaluation of Sensitivity

The development property of the photothermographic material was evaluated as sensitivity. The sensitivity was measured as follows.

The obtained image was evaluated with a Macbeth densitometer for density, and then a characteristic curve of density corresponding to the logarithmic values of light exposure amounts was prepared. The sensitivity was a reciprocal of a light exposure amount providing a density of Dₘᵢₙ+2.0, and was represented by a relative value to the sensitivity 100 of the photothermographic material-1.

Evaluation of Image Graininess

Light exposure amount was controlled to have a density of 1.2, and thus a half solid sample was obtained. This sample is evaluated by visual observation, and a graininess of B or more is required for practical use.

A: Five persons among the 5 persons do not observe irregularity of the cobweb particles.

B: One person among the 5 persons observes irregularity of the particles.

C: Three persons among the 5 persons observe irregularity of the particles.

D: Five persons among the 5 persons observe irregularity of the particles.

Evaluation of Adhesiveness

Using the remaining samples used in the evaluation of the above mentioned photographic performances, the samples which were not treated with the thermal development were evaluated for their adhesiveness. Using the samples maintained in an environment of 25° C. and 75% RH, two samples of 5 cm square were subject to 400 g of a load by contacting the image-forming layer side with the back surface side, and after standing at 40° C. for 5 days, the adhesiveness was observed.

A: Not adhered.

B: Some portions are slightly adhered.

C: 30% or more of the total samples were adhered.

In view of practical use of adhesion, it is required that the adhesiveness grades A.

4-3. Results of Evaluation.

The obtained results are shown in Table 1.

TABLE 1

| | Back surface | | | | | Second Surface | | | | | |
|---|---|---|---|---|---|---|---|---|---|---|---|
| | protective layer | | Image-forming layer | | | Protective Layer | | | | | |
| Photo- | Coat- | | Coat- | Non- | | Coat- | | | | | |
| thermo- | ing | | ing | photosensitive | | ing | | | | Ad- | |
| graphic | liquid | | liquid | Organic Silver | | liquid | | | Graini- | hesive- | |
| Material | No. | Surfactant | No. | Salt | Binder | No. | Surfactant | Sensitivity | ness | ness | Others |
| 1 | 1 | FSN-100 | 1 | 1 | Gelatin | 1 | FSN-100 | 100 | C | D | Comparative Ex. |
| | | (0.020 g/m²) | | | (100 mass %) | | (0.020 g/m²) | | | | |
| 2 | 2 | F-17 | 1 | 1 | Gelatin | 2 | F-17 | 99 | A | B | Present Invention |
| | | (0.005 g/m²) | | | (100 mass %) | | (0.005 g/m²) | | | | |
| 3 | 3 | None | 1 | 1 | Gelatin | 2 | F-17 | 100 | A | B | Present Invention |
| | | | | | (100 mass %) | | (0.005 g/m²) | | | | |
| 4 | 2 | F-17 | 1 | 1 | Gelatin | 3 | F-6 | 101 | A | B | Present Invention |
| | | (0.005 g/m²) | | | (100 mass %) | | (0.008 g/m²) | | | | |
| 5 | 2 | FSN-100 | 1 | 1 | Gelatin | 3 | F-6 | 101 | A | B | Present Invention |
| | | (0.020 g/m²) | | | (100 mass %) | | (0.008 g/m²) | | | | |
| 6 | 1 | FSN-100 | 2 | 2 | Gelatin | 1 | FSN-100 | 95 | C | D | Comparative Ex. |
| | | (0.020 g/m²) | | | (100 mass %) | | (0.020 g/m²) | | | | |
| 7 | 2 | F-17 | 2 | 2 | Gelatin | 2 | F-17 | 95 | A | B | Present Invention |
| | | (0.005 g/m²) | | | (100 mass %) | | (0.005 g/m²) | | | | |
| 8 | 4 | F-6 | 1 | 1 | Gelatin | 3 | F-6 | 100 | A | B | Present Invention |
| | | (0.008 g/m²) | | | (100 mass %) | | (0.008 g/m²) | | | | |
| 9 | 2 | F-17 | 1 | 1 | Gelatin | 4 | None | 99 | C | B | Present Invention |
| | | (0.005 g/m²) | | | (100 mass %) | | | | | | |
| 10 | 2 | F-17 | 3 | 1 | SBR | 2 | F-17 | 110 | C | D | Comparative Ex. |
| | | (0.005 g/m²) | | | | | (0.005 g/m²) | | | | |
| 11 | 2 | F-17 | 4 | 1 | Gelatin:SBR = 40:60 | 2 | F-17 | 105 | C | C | Comparative Ex. |
| | | (0.005 g/m²) | | | | | (0.005 g/m²) | | | | |
| 12 | 2 | F-17 | 4 | 1 | Gelatin:SBR = 60:40 | 2 | F-17 | 103 | B | B | Present Invention |
| | | (0.005 g/m²) | | | | | (0.005 g/m²) | | | | |

FSN-100: R_{f}CH₂CH₂CH₂O(CH₂CH₂O)ₓH (in which, R_{f} represents CF₃CF₂(CF₂CF₂)ₙ, and n represents an integer of 2 to 4)

As shown in the results in Table 1, it was found that when the non-photosensitive organic silver salt is a silver salt of a nitrogen-containing heterocyclic compound or a silver salt of a mercapto compound, a hydrophilic polymer constitutes 50 mass % or more of the binders of the image-forming layer, and a fluorine compound having at least 2 carbon atoms and at most 12 fluorinated alkyl groups are contained, there can be provided a black-and-white photothermographic material having high development property, excellent image graininess and low adhesiveness between sensitive materials. In particular, it was found that the fluorine compound may be preferably contained in the same side as the image-forming layer.

In the following, the chemical structures of the compounds employed in the examples of the invention are shown. 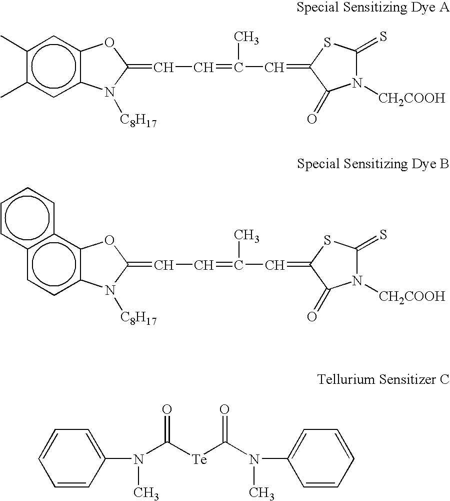
Compound 1, in 1-electron oxidized form, formed by 1-electron oxidation, is capable or releasing 1 or more electrons 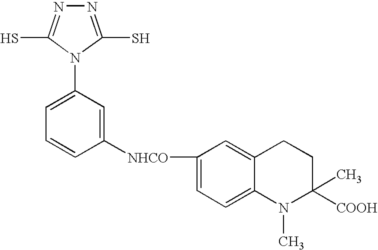
Compound 2, in 1-electron oxidized form, formed by 1-electron oxidation, is capable of releasing 1 or more electrons 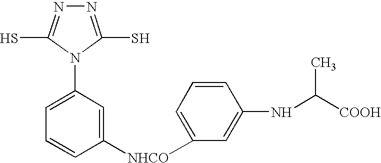
Compound 3, in 1-electron oxidized form, formed by 1-electron oxidation, is capable of releasing 1 or more electrons 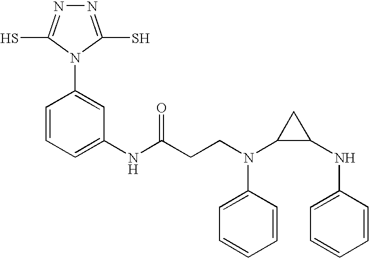
Adsorptive Redox Compound 1 having an adsorptive group and a reducing group 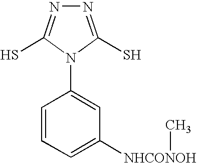
Adsorptive Redox Compound 2 having an adsorptive group and a reducing group

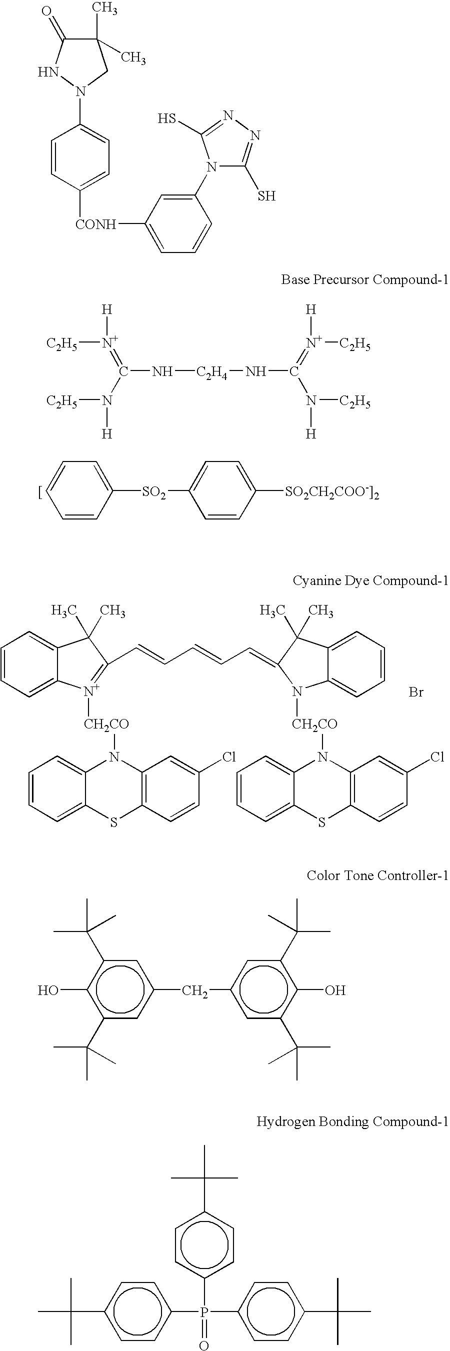

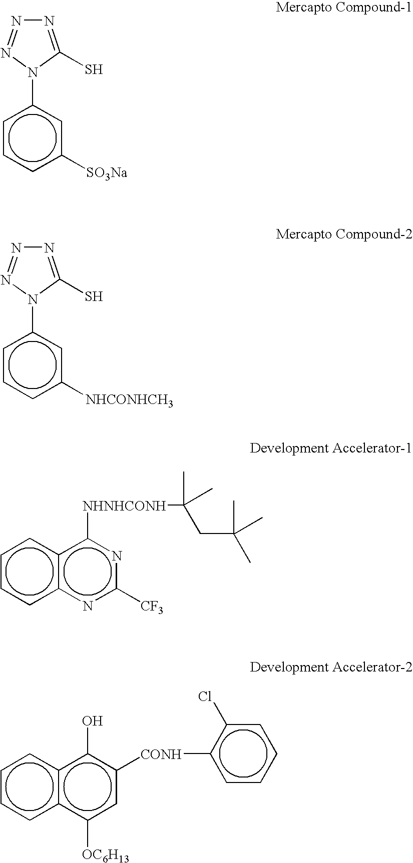

1. A black-and-white photothermographic material comprising a support and an image-forming layer containing a photosensitive silver halide, a non-photosensitive organic silver salt, a reducing agent for silver ions, and a binder on one side of the support,
wherein a hydrophilic binder constitutes 50 mass % or more of the binder,
the non-photosensitive organic silver salt contains at least one kind selected from the group consisting of a silver salt of a nitrogen-containing heterocyclic compound and a silver salt of a mercapto compound; and
the photothermographic material further comprises a fluorine compound having a fluorinated alkyl group with at least 2 carbon atoms and at most 12 fluorine atoms.

2. The black-and-white photothermographic material of claim 1, wherein the fluorinated alkyl group is represented by Formula (A):
-Rc-Re—W Formula (A)
wherein Rc resents an alkylene group having 1 to 4 carbon atoms; Re represents a perfluoroalkylene group having 2 to 6 carbon atoms; and W represents a hydrogen atom, a fluorine atom or an alkyl group.

3. The black-and-white photothermographic material of claim 2, wherein the fluorine compound has two or more fluorinated alkyl groups represented by formula (A).

4. The black-and-white photothermographic material of claim 1, wherein the nitrogen-containing heterocyclic compound is an azole.

5. The black-and-white photothermographic material of claim 2, wherein the nitrogen-containing heterocyclic compound is an azole.

6. The black-and-white photothermographic material of claim 4, wherein the azole is at least one kind of compound selected from the group consisting of triazole, tetrazole and derivatives thereof.

7. The black-and-white photothermographic material of claim 5, wherein the azole is at least one kind of compound selected from the group consisting of triazole, tetrazole and derivatives thereof.

8. The black-and-white photothermographic material of claim 6, wherein the triazole is at least one kind of compound selected from the group consisting of benzotriazole and a derivative thereof.

9. The black-and-white photothermographic material of claim 7, wherein the triazole is at least one kind of compound selected from the group consisting of benzotriazole and a derivative thereof.

10. The black-and-white photothermographic material of claim 6, wherein the tetrazole is at least one kind of compound selected from the group consisting of aryltetrazole and a derivative thereof.

11. The black-and-white photothermographic material of claim 7, wherein the tetrazole is at least one kind of compound selected from the group consisting of aryltetrazole and a derivative thereof.

12. The black-and-white photothermographic material of claim 1, wherein the mercapto compound is an aliphatic mercapto compound or a heterocyclic mercapto compound.

13. The black-and-white photothermographic material of claim 2, wherein the mercapto compound is an aliphatic mercapto compound or a heterocyclic mercapto compound.

14. The black-and-white photothermographic material of claim 12, wherein the aliphatic group of the aliphatic mercapto compound is an alkyl group having 10 to 23 carbon atoms.

15. The black-and-white photothermographic material of claim 13, wherein the aliphatic group of the aliphatic mercapto compound is an alkyl group having 10 to 23 carbon atoms.

16. The black-and-white photothermographic material of claim 1, wherein the reducing agent for silver ions is at least one kind of compound selected from the group consisting of ascorbic acid and a derivative thereof.

17. The black-and-white photothermographic material of claim 2, wherein the reducing agent for silver ions is at least one kind of compounds selected from the group consisting of ascorbic acid and a derivative thereof.

18. The black-and-white photothermographic material of claim 1, wherein the hydrophilic binder contains at least one kind of compound selected from the group consisting of a gelatin and a derivative thereof.

19. The black-and-white photothermographic material of claim 2, wherein the hydrophilic binder contains at least one kind of compound selected from the group consisting of a gelatin and a derivative thereof.
